(19) United States
(12) Patent Application Publication
(10) Pub. No.: US 2016/0047587 A1
(43) Pub. Date: Feb. 18, 2016

(54) REFRIGERATOR, CAMERA DEVICE, REFRIGERATOR DOOR POCKET, AND REFRIGERATOR HOLDER

(71) Applicants: KABUSHIKI KAISHA TOSHIBA, Tokyo (JP); TOSHIBA HOME APPLIANCES CORPORATION, Tokyo (JP)

(72) Inventors: Hironori SASAKI, Minato-ku, Tokyo (JP); Kazuhiro FURUTA, Minato-ku, Tokyo (JP); Yuuki MARUTANI, Minato-ku, Tokyo (JP); Kota WATANABE, Minato-ku, Tokyo (JP); Hirokazu IZAWA, Minato-ku, Tokyo (JP)

(21) Appl. No.: 14/776,728

(22) PCT Filed: Mar. 11, 2014
(86) PCT No.: PCT/JP2014/056325

§ 371 Date: Sep. 14, 2015

(30) Foreign Application Priority Data
Mar. 12, 2013 (JP) 2013-049073
Jul. 16, 2013 (JP) 2013-147562
Oct. 31, 2013 (JP) 2013-226970
Feb. 28, 2014 (JP) 2014-038459

(51) Int. Cl. F25D 17/04; H04N 7/18; H04N 5/225; B05B 1/02

(52) U.S. Cl. CPC F25D 17/042; B05B 1/02; H04N 7/183; H04N 5/2252; H04N 5/2257; F25D 2317/0413; H04N 2005/2255

(57) ABSTRACT

A refrigerator provided with an image capturing unit configured to capture an image of an interior of the refrigerator; a mist generator unit configured to spray; a spray port configured to feed the mist sprayed from the mist generator unit to the interior of the refrigerator. The image capturing unit is provided at a location not confronting the spray port.

### CROSS REFERENCE TO RELATED APPLICATIONS

This application is a U.S. National Stage Application of International Application No. PCT/JP2014/056325 filed Mar. 11, 2014, which claims priority from Japanese Patent Application No. 2013-049073 filed Mar. 12, 2013, Japanese Patent Application No. 2013-147562 filed Jul. 16, 2013, Japanese Patent Application No. 2013-226970 filed Oct. 31, 2013 and Japanese Patent Application No. 2014-038459 filed Feb. 28, 2014. The entirety of all the above-listed applications are incorporated herein by reference.

### TECHNICAL FIELD

Embodiments of the present invention relates to a refrigerator, camera device, a refrigerator door pocket, and a refrigerator holder.

### BACKGROUND

Systems configured to manage food by capturing images of food stored in a refrigerator have been proposed (See for example, patent document 1).

However, some users wish to check the status inside the refrigerator from remote locations such as outdoors with ease.

### PRIOR ART DOCUMENTS

### Patent Document

Patent Document 1: JP 2012-226748 A

### SUMMARY OF THE INVENTION

### Problems to be Overcoming by the Invention

The problem to be overcome by the present invention is providing a refrigerator, camera device, a refrigerator door pocket, and a refrigerator holder allowing the interior of the refrigerator, etc. to be checked with ease from a remote location.

### Means for Overcoming the Problems

A refrigerator of one embodiment is provided with an image capturing unit configured to capture an image of an interior of the refrigerator; a mist generator unit configured to generate mist to be fed to the interior of the refrigerator; and a spray port configured to feed the mist generated by the mist generator unit to the interior of the refrigerator. The image capturing unit is provided at a location not confronting the spray port.

A camera device of one embodiment for capturing an image of an interior of the refrigerator is provided with an image capturing unit configured to capture an image of the interior of the refrigerator; a camera-side communication unit configured to communicate with an external device; and a control unit configured to be capable of operating in synchronism with a mist generator unit being provided at the refrigerator and being configured to generate mist to be fed to the interior of the refrigerator.

A refrigerator door pocket of one embodiment provided at a door of a refrigerator is provided with a receiving portion configured for mounting an image capturing unit configured to capture an image of an interior of the refrigerator, the receiving portion configured to receive the image capturing unit so that the image capturing unit is disposed in a location not confronting a spray port for feeding mist to the interior of the refrigeration chamber.

A refrigerator holder of one embodiment provided in an interior of the refrigerator is provided with a holding portion configured to hold an image capturing unit configured to capture an image of an interior of the refrigerator, the holding portion configured to hold the image capturing unit so that the image capturing unit is disposed in a location not confronting spray port for feeding mist to the interior of the refrigeration chamber.

### BRIEF DESCRIPTIONS OF THE DRAWINGS

FIG. 1 briefly illustrates a home appliance network system employing a refrigerator of a first embodiment.

FIG. 2 schematically illustrates the refrigerator of the first embodiment.

FIG. 3 schematically illustrates how an image capturing camera of the first embodiment is attached.

FIG. 4 schematically illustrates the structure of the refrigerator of the first embodiment.

FIG. 5 schematically illustrates the status inside the refrigerator of the first embodiment.

FIG. 6 indicates the process flow of an image capturing process executed by the refrigerator of the first embodiment.

FIG. 7 illustrates one example of an image captured by the image capturing camera of the first embodiment.

FIGS. 8A-8C schematically illustrate change in the status of dew condensate on the image capturing camera of the first embodiment.

FIG. 9 illustrates the sequence of image capturing carried out by the image capturing camera of the first embodiment.

FIG. 10 indicates the process flow a terminal-side process carried out by a communication terminal of the first embodiment.

FIG. 11 illustrates how an image is displayed on the communication terminal of the first embodiment (part 1).

FIG. 12 illustrates how an image is displayed on the communication terminal of the first embodiment (part 2).

FIGS. 13A-13B schematically illustrate a camera device mounted on a refrigerator door pocket of a second embodiment.

FIG. 14 schematically illustrates the refrigerator door pocket of the second embodiment attached to a refrigerator.

FIG. 15 schematically illustrates an exterior look of the camera device of the second embodiment.

FIG. 16 schematically illustrates an exterior look of the camera device of the second embodiment and the layout of parts provided therein.

FIG. 17 schematically illustrates the camera device of the second embodiment being attached to the refrigerator door pocket.

FIG. 18 schematically illustrates the location in which a refrigerator holder of the second embodiment is attached.

FIGS. 19A-19B schematically illustrate the refrigerator holder of the second embodiment.

FIG. 20 schematically illustrates the refrigerator holder of the second embodiment being attached.

FIG. 21 schematically illustrates an electrical configuration of the camera device of the second embodiment.

FIGS. 22A-22C schematically illustrates how detection is performed by a detection portion of the camera device of the second embodiment.

FIG. 23 illustrates an example of a timing of image capturing by the camera device of the second embodiment.

FIGS. 24A-24C illustrate an example of an image of a fridge interior captured by the camera device of the second embodiment.

FIG. 25 provides an overview of a home appliance network system of the second embodiment.

FIGS. 26A-26B schematically illustrate how an image capturing camera of a modified embodiment is attached.

FIG. 27 schematically illustrates the structures of a refrigerator of a modified embodiment.

FIG. 28 illustrates one example of how an image is displayed on a communication terminal of a modified embodiment.

FIGS. 29A-29B illustrate one example of a mounting portion of a modified embodiment.

FIG. 30 is a vertical cross-sectional view of a refrigerator of a third embodiment.

FIG. 31 illustrates the peripheral structures of a mist generator device and a humidifier device of the third embodiment.

FIG. 32 illustrates the structure of the mist generator device of the third embodiment.

FIG. 33 schematically illustrates an electrical configuration of a refrigerator and a camera device of the third embodiment.

FIG. 34 illustrates the timing in which a refrigerating chamber-side image capturing camera, a mist generator device, and a humidifier device of a third embodiment are driven (Part 1).

FIG. 35 illustrates the timing in which a damper, a vegetable chamber-side image capturing camera, a mist generator device, and a humidifier device of the third embodiment are driven.

FIG. 36 illustrates the timing in which a refrigerating chamber-side image capturing camera, a mist generator device, and a humidifier device of the third embodiment are driven (Part 2).

FIG. 37 illustrates the timing in which the refrigerating chamber-side image capturing camera, a mist generator device, and a humidifier device of the third embodiment are driven (Part 3).

FIG. 38 is a vertical cross-sectional view of a refrigerator of a fourth embodiment.

FIG. 39 is a vertical cross-sectional view of a refrigerator of a fifth embodiment.

FIG. 40 schematically illustrates the structures of a sixth embodiment.

FIG. 41 illustrates the timing in which a refrigerating chamber-side image capturing camera, a mist generator device, and a humidifier device of the sixth embodiment are driven.

FIG. 42 illustrates the timing in which a refrigerating chamber-side image capturing camera, a mist generator device, and a humidifier device of a seventh embodiment are driven.

FIG. 43 illustrates the peripheral structures of a mist generator device and a humidifier device of an eighth embodiment.

FIG. 44 illustrates the timing in which a refrigerating chamber-side image capturing camera, a mist generator device, and a humidifier device of an eighth embodiment are driven.

FIG. 45 illustrates the timing in which a refrigerating chamber-side image capturing camera, a mist generator device, and a humidifier device of a ninth embodiment are driven.

FIG. 46 illustrates the timing in which a refrigerating chamber-side image capturing camera, a mist generator device, and a humidifier device of a tenth embodiment are driven.

FIG. 47 illustrates the timing in which a refrigerating chamber-side image capturing camera, a mist generator device, and a humidifier device of an eleventh embodiment are driven (part 1).

FIG. 48 illustrates the timing in which a refrigerating chamber-side image capturing camera, a mist generator device, and a humidifier device of the eleventh embodiment are driven (part 2).

FIG. 49 illustrates the timing in which a refrigerating chamber-side image capturing camera, a mist generator device, and a humidifier device of the eleventh embodiment are driven (part 3).

### EMBODIMENTS OF THE INVENTION

A refrigerator, a camera device, a refrigerator door pocket, a communication terminal, a home appliance network system, and an in-fridge image displaying program will be described through the embodiments given below. Elements that are substantially identical across the embodiments are represented by identical reference symbols and are not described in detail.

### First Embodiment

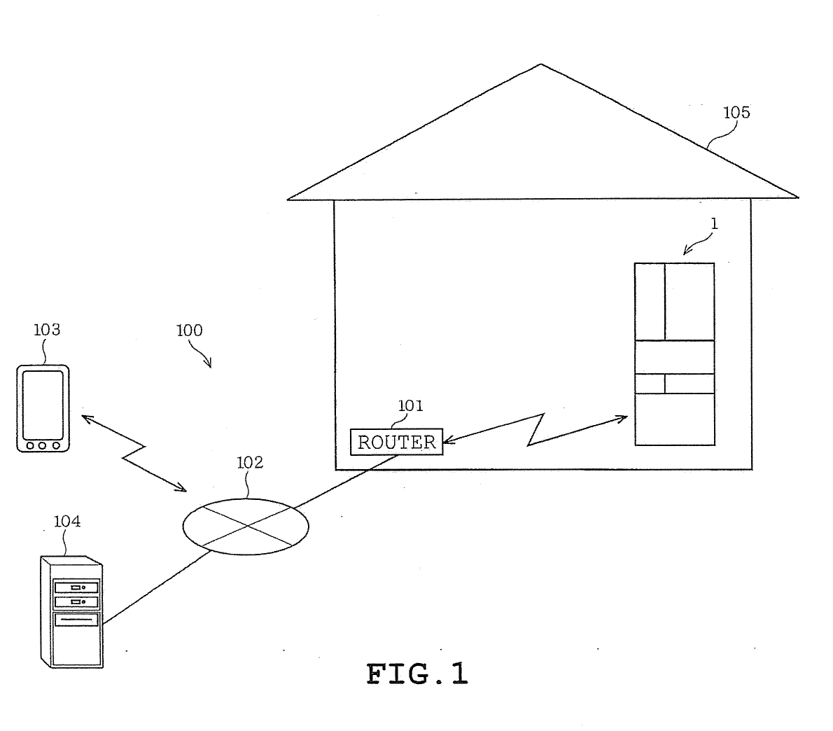

A first embodiment will be described hereinafter with reference to FIGS. 1 to 12.

In the present embodiment illustrated in FIG. 1, a home appliance network system 100 employs a refrigerator 1. The refrigerator 1 is connected communicably with an external communication line 102 via a router 101. The router 101 serves as the so-called wireless access point and is connected communicably with the refrigerator 1 by a wireless communication method. The refrigerator 1 exchanges various information with a communication terminal 103 and a server 104 (both being an example of an external device) connected to the communication line 102. In the home appliance network system 100 of the present embodiment, the image information, capturing images of the interior of the refrigerator 1, is stored to the server 104 and the communication terminal 103 is configured to retrieve the in-fridge images from the server 104. The image information is information (data) given in the form of images that depict the fridge interior. The image information may come in any data format as long as it can be transmitted via a communication unit and ultimately allows the fridge interior to be visualized. Examples of the image information includes: an image data (still image, moving image) of known formats such as a bit map format and JPEG/MPEG format; compressed/encrypted data; and data converted by image processing as in the second embodiment. Examples of the communication terminal 103 envisaged in the present embodiment include the so-called smart phone (highly functional mobile phone) which may be carried outside a residence 105, a tablet PC (Personal Computer), and a television connected to the home appliance network system 100.

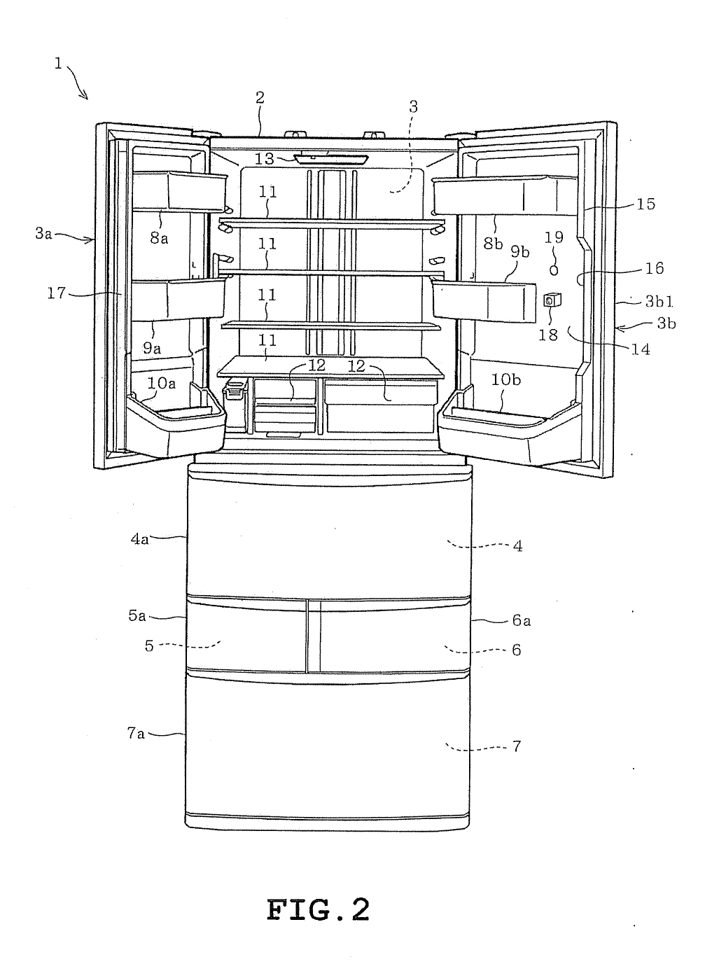

As illustrated in FIG. 2, the refrigerator 1 is provided with storage chambers for storing food namely, a refrigeration chamber 3, a vegetable chamber 4, an ice maker chamber 5, an upper freezer chamber 6, and a lower freezer chamber 7 in the listed sequence from the upper side of a fridge body 2. The compartment of the refrigeration chamber 3 and the vegetable chamber and the compartment of the ice maker chamber 5 and the upper freezer chamber 6 are divided by a thermally insulative partition wall. The refrigeration chamber 3 is double doored and is opened/closed by a left-side door 3a and a right-side door 3b. The vegetable chamber 4, the ice maker chamber 5, the upper freezer chamber 6, and the lower freezer chamber 7 are opened/closed by drawer-type doors 4a, 5a, 6a, and 7a.

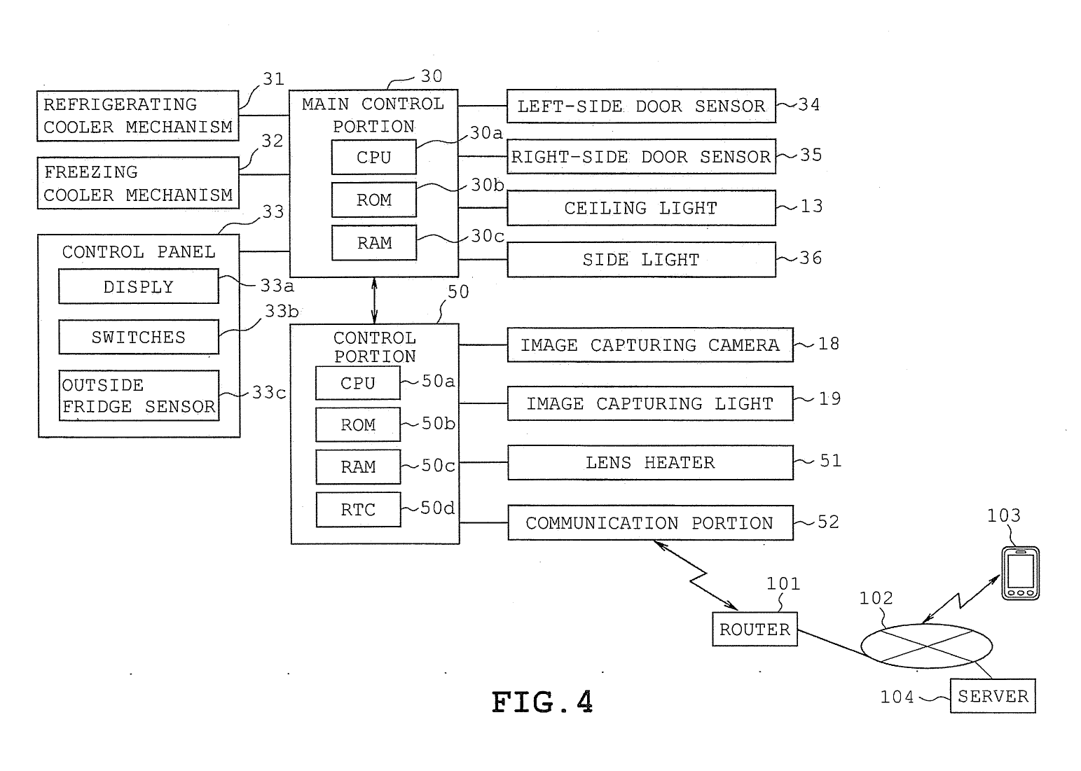

Each of the doors are provided with a sensor for detecting the opened/closed state (See FIG. 4. However, FIG. 4 only illustrates a left-side door sensor 34 for the left-side door 3a and a right-side door sensor 35 for the right-side door 3b). The structure of the refrigerator 1 illustrated in FIG. 2 is only an example and thus, the location of the storage chambers may be rearranged or the upper freezer chamber 6 may be configured as a switchover chamber which may be switched to be used for refrigeration or for freezing purposes.

The left-side door 3a of the refrigeration chamber 3 is provided with a door pocket 8a, a door pocket 9a, and a door pocket 10a in the listed sequence from the upper side thereof. The right-side door 3b is provided with a door pocket 8b, a door pocket 9b, and a door pocket 10b in the listed sequence from the upper side thereof. The refrigeration chamber 3 contains plural shelves 11 formed by a transparent material such as glass and is provided with a special purpose chamber 12 such as an egg container chamber and a chiller chamber in the lowermost compartment. A ceiling light 13 serving as a lighting unit is provided in the upper portion of the refrigeration chamber 3. A side light 36 (see FIG. 4) is further provided in the side surface of the refrigeration chamber 3. The ceiling light 13 is provided for lighting the upper portion of the fridge interior and the side surface light 36 is provided for lighting the central portion and the lower portion of the fridge interior, and thus are provided for lighting specific portions of the fridge interior.

The front surface of the left-side door 3a and the right-side door 3b of the refrigeration chamber 3 are covered by a glass plate 3b1 formed of an insulative glass and the interior of the left-side door 3a and the right-side door 3b are packed with a fill material such as urethane serving as a thermal insulation material. As known, an inner plate 14 made of a nonmetallic resin and a vertical plate 15 are provided on the inner side of the left-side door 3a and the right-side door 3b. That is, the front surface side of the left-side door 3a and the right-side door 3b are configured by the glass plate 3b1 being a nonmetallic material allowing permeation of electric waves. The door pockets 8 to 10 are provided on the inner plate 14. The vertical plate 15 has a recess portion 16 formed thereto so as to be located near a mid portion thereof as viewed in the vertical direction and near an opening end side of the right-side door 3b as viewed in the lateral direction (more specifically, near the location where a later described image capturing camera 18 is provided). The recess portion 16 is provided so as not to block the sight of the image capturing camera 18. Further, the left-side door 3a is provided with a revolving vertical partition 17 provided so as to fill the clearance from the right-side door 3b. Door 4a, etc. of the vegetable chamber 4 has its front surface covered by glass plate and its interior packed with urethane serving as a thermal insulation material as was the case for the right-side door 3b.

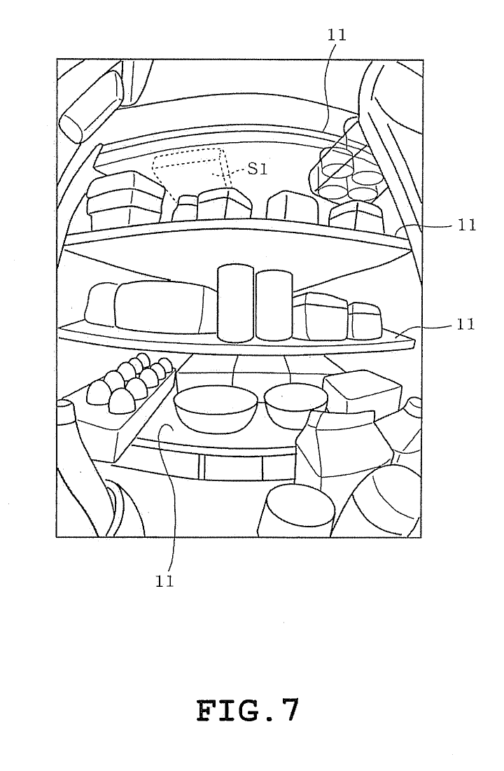

As illustrated in FIG. 2, the image capturing camera 18 and an image capturing light 19 are provided on the inner plate 14 of the right-side door 3b (on the door which is not vertically partitioned). That is, in the present embodiment, the inner plate 14 serves as one example of a receiving portion. The image capturing camera 18 is provided with an image capturing element such as a CCD or CMOS and is configured to capture in-fridge images from the door side. The image capturing camera 18 is provided with a wide-angle lens having a view angle of approximately 120 degrees. The image capturing camera 18 is provided at a location adjacent to a mid-level door pocket 9b and closer to the left-side door 3a as compared to the door pocket 9b. That is, the image capturing camera 18 is provided near the vertical center of the refrigeration chamber 3 and near the lateral center of the refrigeration chamber 3. Thus, when the right-side door 3b is closed, the view of the image capturing camera 18 is capable of capturing images of substantially the entirety of the interior of the refrigeration chamber 3 as illustrated in the later described FIG. 7 and at least some of the door pockets 8 to 10. By comparison, web cameras in general have a view angle of approximately 55 degrees.

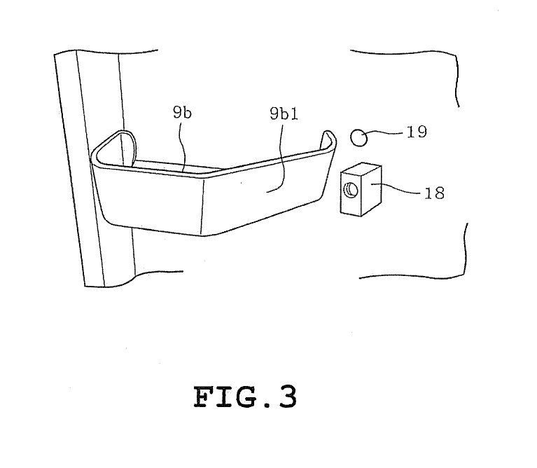

The door pocket 9b located adjacent to the image capturing camera 18 is shaped so that one side proximal to the image capturing camera 18 is sloped as illustrated in FIG. 3. That is, a notch 9b1 is formed in the door pocket 9b, which is normally shaped to exhibit a square (rectangular) storage portion, to secure a view for the image capturing camera 18 employing a wide-angle lens. FIG. 3, etc. schematically illustrate the image capturing camera 18 and thus, differs from the actual size and shape of the image capturing camera 18. The image capturing camera 18, being secured to the refrigerator 1 in the present embodiment, may be configured to be removable from the refrigerator 1 (so as to be mounted as an optional accessory after purchasing the refrigerator 1 for example) as described in the later described second embodiment.

For example, the image capturing light 19 may be provided above the image capturing camera 18. That is, the image capturing light 19 is disposed so that its lighting direction is oriented in the same direction as the view of the image capturing camera 18 so that the light illuminated by the image capturing camera does not directly enter the image capturing camera 18 (so as not to be in confrontation). In other words, the image capturing light 19 is disposed in a location which is difficult to provide back light to the image capturing camera 18 or which does not provide back light to the image capturing camera 18. The image capturing camera 18 is one example of an image capturing unit recited in the claims and the image capturing light 19 is one example of a lighting unit recited in the claims.

The refrigerator 1 is controlled by a main control portion 30 as illustrated in FIG. 4. The main control portion 30 is configured by a microcomputer provided with components such as a CPU 30a, a ROM 30b, and a RAM 30c and controls the entire refrigerator 1 by executing a computer program stored for example in the ROM 30b, etc.

The main control portion 30 is connected to a refrigerating cooler mechanism 31 and freezing cooler mechanism 32 configured by a known refrigeration cycle, etc.; a control panel 33 used for inputting settings and operations to the refrigerator 1; the left-side door sensor 34; the right-side door sensor 35; the ceiling light 13; the side light, and the like. The refrigerator 1 is also provided with an in-fridge sensor, etc. not shown for detecting the temperature of the refrigeration chamber 3, the lower freezer chamber 7, and the like.

The control panel 33 is provided with a display 33a, switches 33b, and outside fridge sensor 33c. The display 33a presents various information such as the operational status of the refrigerator 1. The switches 33b input settings and operations made by the user to the refrigerator 1. The switches 33b include a go-out switch for switching the operating mode of the refrigerator 1 when the user goes outdoor. The go-out switch may have options such as “power save”, “leave home”, etc. that, when selected, perform the relevant power save modes. That is, since the refrigerator 1 will not be used when the user goes outdoor, the refrigerator 1 makes a transition to the power save mode to reduce power consumption.

For example, when the “power save” option is selected, the refrigerator 1 makes minor adjustments in the in-fridge temperature so as not to affect the environment of food preservation, while also controlling the operational status of a heater for preventing dew condensation to make a transition to a power save mode in which power consumption is reduced by approximately 10% from the normal operation mode. Alternatively, when the “leave home” option is selected, the refrigerator 1 reduces the number of times of automatic ice making to make a transition to a power save mode in which power consumption is reduced from the normal operation mode. More specifically, the refrigerator 1 reduces the frequency of automatic ice making to once every 8 hours for example to reduce power consumption by approximately 20% from the normal operation mode.

The “power save” switch and the “leave home” switch provided in the refrigerator 1 serve as the go-out switch in the present embodiment. Alternatively, a dedicated go-out switch may be provided instead.

The outside fridge sensor 33c is formed of a temperature sensor, a humidity sensor, or the like and acquires information of the environment outside the refrigerator. The outside fridge sensor 33c is one example of an outside environment acquiring unit recited in the claims.

The main control portion 30 controls the operational status of the refrigerator 1 based on the environment inside the refrigerator acquired by the in-fridge sensor as well as the environment outside the refrigerator acquired by the outside fridge sensor 33c and based on the settings made from the control panel 33. Further, the main control portion 30 acquires the opened/closed status of the doors through the left-side door sensor 34 and the right-side door sensor 35. The main control portion 30 is connected communicably with the control portion 50 and is capable of transmitting the opened/closed status of the doors to the control portion 50 and receive instructions for illuminating the ceiling light 13, the side light 36, etc. from the control portion 50, etc.

The control portion 50 is configured by a microcomputer provided with a CPU 50a, a ROM 50b, a RAM 50c, and a real time clock (hereinafter referred to as RTC 50d) for acquiring time. The control portion 50 is connected to the image capturing camera 18, the image capturing light 19, a lens heater 51, and a communication portion 52.

The control portion 50 controls the timing and the environment in which the images of the fridge interior are captured by the image capturing camera 18 by executing a computer program stored in the ROM 50b for example. More specifically, the control portion 50 controls the timing of image capturing based on the opened/closed status of the doors received from the main control portion 30 and controls the environment of image capturing, i.e. the lighting status of the ceiling light 13, the image capturing light 19, etc. serving as the light source required in image capturing. The control portion 50 is one example of a control unit recited in the claims.

A description is given hereinafter on the timing of image capturing. When capturing images of the fridge interior, it is required to drive the image capturing camera 18 and illuminate the image capturing light 19, etc. That is, capturing images of the fridge interior requires power consumption. Thus, unnecessary power is consumed when image capturing is constantly enabled. The refrigerator 1 is configured to reduce power consumption by controlling the timing in which images of the fridge interior are captured and by controlling the environment of image capturing (i.e. illumination of the image capturing light 19) only when required so as to be synchronized with the controlled timing of image capturing.

The timing for capturing images of the fridge interior are preset to the following image capturing conditions 1 to 5 for example. When either of the conditions is met, the control portion 50 determines that a timing has arrived to capture an image of the fridge interior.

Image capturing condition 1: The timing in which either of the doors of the refrigeration chamber 3 is closed after being opened. That is, the timing in which the status of in-fridge food storage may have changed.

Image capturing condition 2: The timing in which either of the doors of the refrigeration chamber 3 is opened. That is, the timing in which there is a possibility that the status of in-fridge food storage may thereafter change.
Image capturing condition 3: The timing in which instructions have been received from external devices such as a communication terminal
Image capturing condition 4: When the go-out switch has been operated. Image may be captured at the timing when the go-out switch has been operated or at the timing when a predetermined standby time has elapsed after the go-out switch has been operated. Either of the timings can be preset as desired.
Image capturing condition 5: The timing when a predetermined time has elapsed after the door has been closed after being opened. (The present embodiment employs the timing in which a delayed image capturing time has elapsed which is a time period expected to be required to remove dew condensate from the wide angle lens of the image capturing camera 18). That is, the timing in which dew condensate is removed from the wide angle lens. The delayed image capturing time may be a fixed value or may be varied depending upon the temperature, humidity, etc. outside the refrigerator acquired by the outside fridge sensor 33c.
Image capturing condition 6: The timing in which dew condensate is removed by the lens heater 51 from the wide angle lens of the image capturing camera 18 after the door has been closed after being opened. That is, the timing in which dew condensate is removed from the wide angle lens.

It is possible to employ either one of the image capturing conditions or a combination of the image capturing conditions if the conditions do not contradict with one another. The present embodiment employs condition 1, 3, 4, and 5.

The communication portion 52 is configured to communicate with the router 101 through wireless communication such as the so-called wireless LAN, Bluetooth (Registered Trademark), etc. More specifically, the communication portion 52 uploads the captured images of the fridge interior to the server 104 via the router 101 and the communication line 102. The communication portion 52 may employ a wired communication.

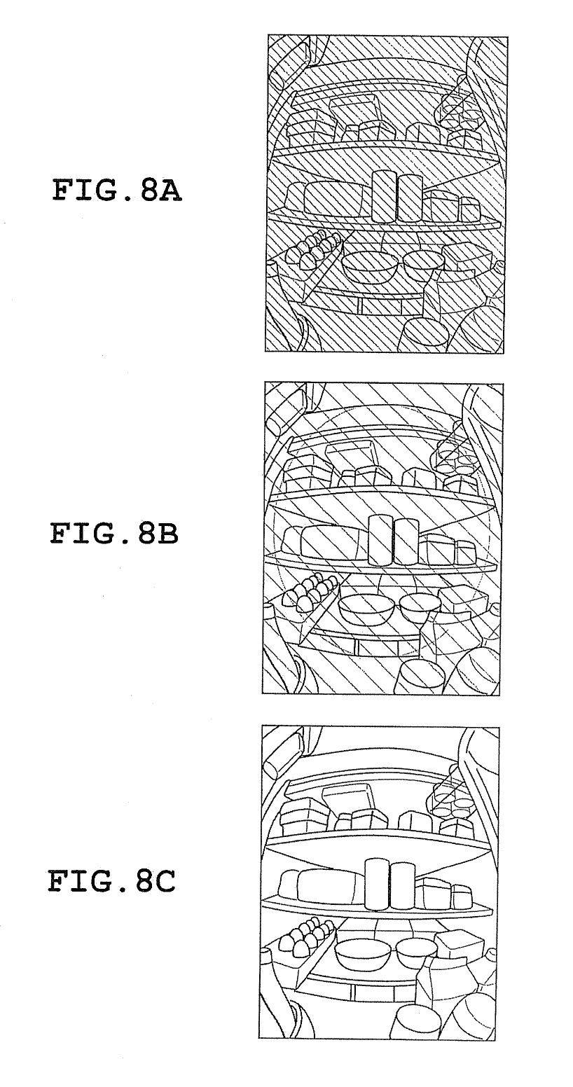

The lens heater 51 (one example of a removing unit) removes dew condensate from the lens surface as illustrated in the later described FIGS. 8A-8C by heating the wide angle lens of the image capturing camera 18. The lens heater 51 may be configured by an exothermic member that generates heat by energizing an electrically heated wire, etc. The lens heater 51 may also be configured by the heat produced by the microcomputer of the control portion 50 or by a heat conducting member that transmits the heat produced by the microcomputer. When utilizing the heat produced by the microcomputer, the microcomputer may be relieved from the power save mode. A fan, etc. may be employed as the removing unit. More specifically, a fan may be driven to blow cool air onto the lens surface and image capturing may be carried out after a predetermined time has lapsed which is expected to be sufficient for removing dew condensate. Any configuration may be employed as long as dew condensate can be removed from the lens surface.

The communication terminal 103 acquires and displays images of the fridge interior stored in the server 104 by accessing the server 104. In the present embodiment, the communication terminal 103 acquires images stored in the server 104 instead of acquiring images directly from the refrigerator 1.

The server 104 is configured by a computer system and stores multiple images uploaded thereto in chronological order. The server 104 is further configured to associate the communication terminal with a specific refrigerator 1 and provides images of the relevant refrigerator 1 to the communication terminal requesting image acquisition.

Next, a description is given on the operation of the above described configuration. The processes described below, being executed by cooperation of the main control portion 30 and the control portion 50, are described with the refrigerator 1 being the subject of process execution for simplicity.

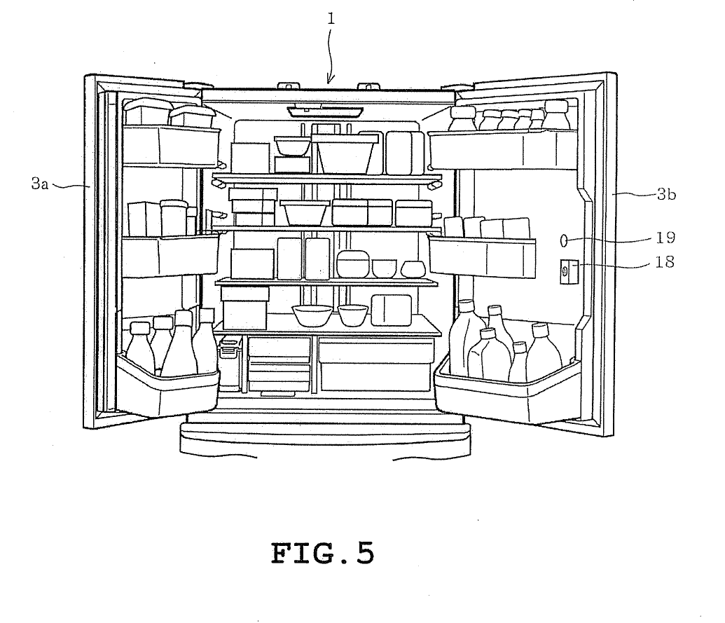

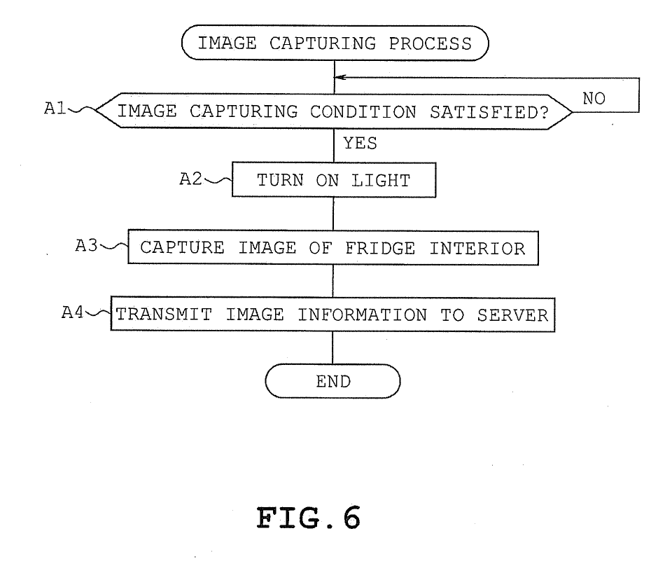

As illustrated in FIG. 5, various foods are stored in the refrigeration chamber 3 of the refrigerator 1. The refrigerator 1 executes the image capturing process indicated in FIG. 6 in which a determination is made as to whether or not conditions have been met for capturing images of the fridge interior by the image capturing camera 18 (A1). If either of the conditions has been met (A1: YES), that is, when it has been determined that the timing has arrived to perform image capturing, the light (image capturing light 19) is illuminated (A2) to capture images of the fridge interior (A3). The image of the fridge interior, one example of which is illustrated in FIG. 7, is captured in the above described manner.

In FIG. 7, an image of substantially the entirety of the refrigeration chamber 3 interior is captured since the above described wide-angle lens is used in the image capturing of the fridge interior. An image of various types of food placed on each shelf 11 and various types of food stored in each door pocket is visibly captured. Since the shelves 11 are made of a transparent material, the image of food 51 placed on the uppermost shelf 11 is captured so as to be visible through the shelf 11.

Further, since the image is captured by illuminating image capturing light 19, the image of food is visibly captured without being back lit. In a comparative embodiment not illustrated in which the image of the fridge interior is captured with the ceiling light 13 illuminated, the light coming from the ceiling light 13 results in a back light and the visibility of food 51 and food placed on the second level shelf 11 becomes poor. That is, the refrigerator 1 controls the environment for enabling image capturing of the fridge interior by illuminating the image capturing light 19 which does not create a back light to the image capturing camera 18.

The refrigerator 1 transmits the image information of the captured image to the server 104 (A4). At this instance, the time stamp of the captured image is transmitted to the server 104 at the same time. As a result, the server 104 stores (accumulates) multiple images of the fridge interior in the chronological order.

When the door of the refrigeration chamber 3 is opened, the image capturing camera 18 as well as its wide-angle lens, provided on the inner plate 14 of the right-side door 3b, becomes exposed to the environment of the fridge exterior. The exposure occurs not only when the right-side door 3b is opened but also when the left-side door 3a is opened. Thus, the lens surface may fog by dew condensate as illustrated in FIG. 8A immediately after the door is closed though caused by the environment of the fridge exterior. FIGS. 8A-8C schematically illustrates the dew condensate on the lens surface by hatching where FIG. 8A illustrates the bedewed state (immediately after the door is closed), FIG. 8B illustrates the dew condensate being gradually removed (over some time after the door is closed), and FIG. 8C illustrates the dew condensate removed (after the delayed image capturing time has elapsed).

When the image of fridge interior is captured immediately after the door is closed, visibility may be poor because of dew condensate. In such case, the refrigerator 1 may employ condition 5 described above and further capture the image of the fridge interior at the timing when the delayed image capturing time has elapsed after the door once opened has been closed. That is, when condition 5 is met (A1: YES), light is illuminated (A2), image of the fridge interior is captured (A3), and the image information of the captured image is transmitted to the server 104 (A4).

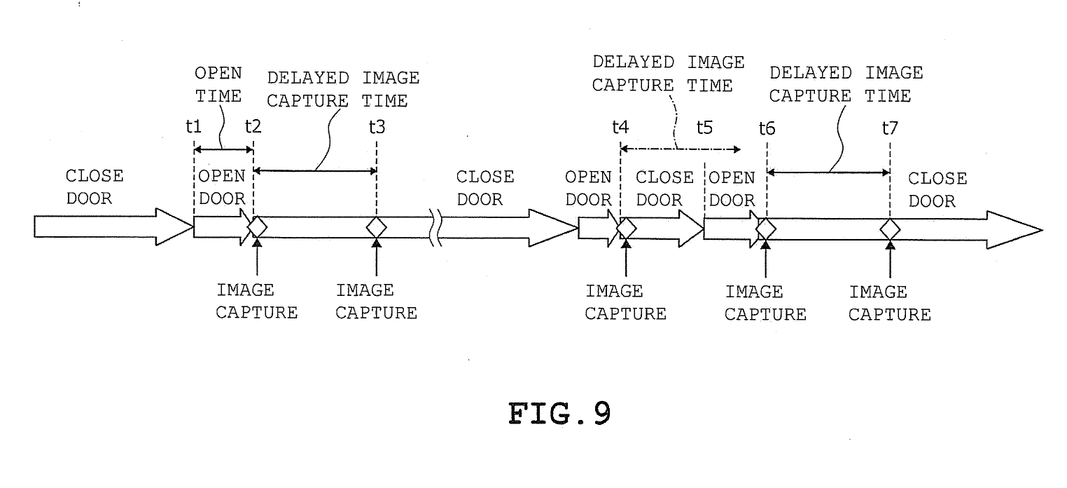

To described more specifically with reference to FIG. 9, the closed door is opened at time T2 and closed at T1. Image is captured at time T1 and at time t3, which is the timing after the delayed image capturing time has elapsed, image is captured again. After image is captured after door is closed at time t4, if the door is reopened at time t5 which precedes the lapse of the delayed image capturing time, image is captured at time t6 when the door is closed and image is captured again at time t7, which is the timing after the delayed image capturing time has elapsed. It is thus, possible to capture images with dew condensate of the wide-angle lens removed, that is, images with visibility of the fridge interior.

When image information is transmitted to the server 104, the control portion 50 is placed in a standby state. In the standby state, the control portion 50 may make a transition to a power save mode such as the so-called sleep mode (in which the ice making function may be stopped for example), or conduction of power to the control portion 50 including the image capturing camera 18 may be blocked to reduce power consumption to zero. Once opening of the door, etc. has been detected via the door sensor for example, instructions may be outputted to the control portion 50 from the main control portion 30 to make a transition to the normal mode.

As a result, it is possible to reduce total power consumption of the refrigerator 1.

The images stored in the server 104 can be displayed on the communication terminal 103. The communication terminal 103

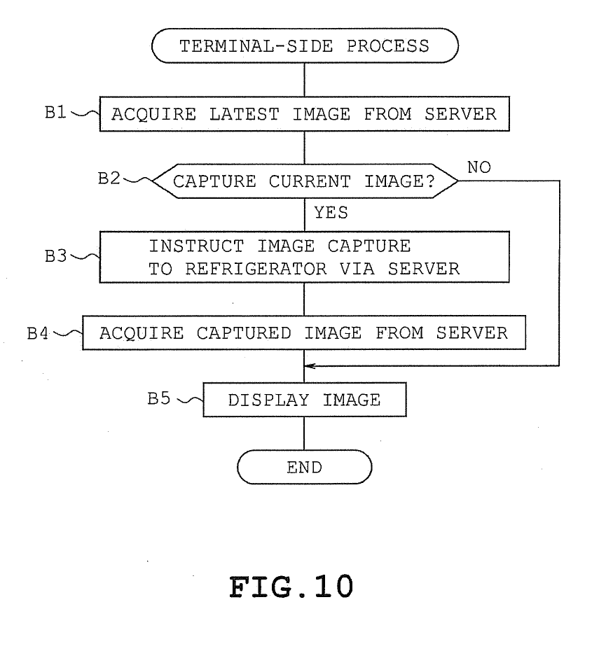

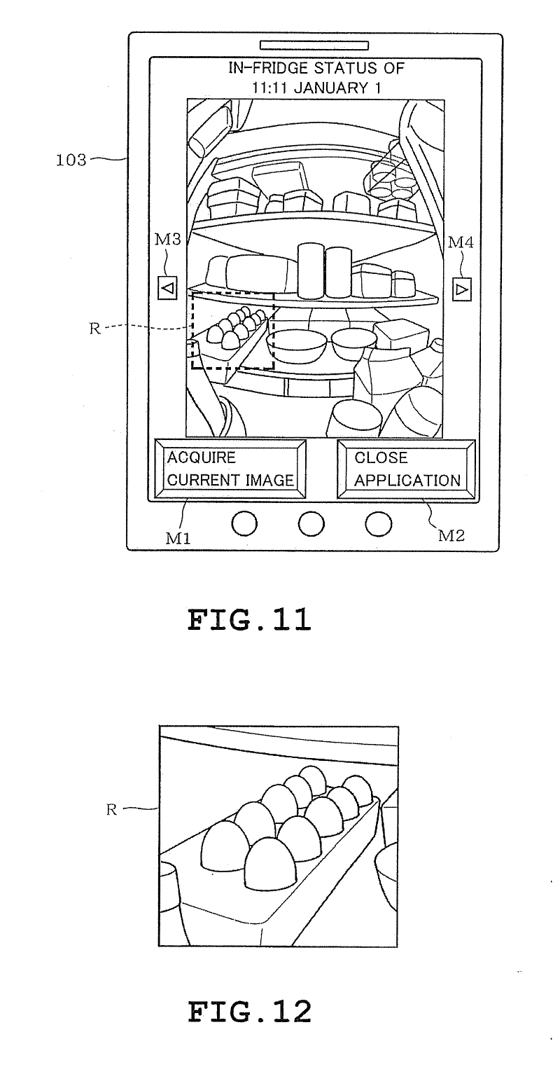

acquires the latest image (or the image information) from the server 104 (B1) when an application for image acquisition is invoked and the terminal-side process (fridge interior image displaying program) indicated in FIG. 10 is executed. As a result, images of the fridge interior are displayed, with the time in which the images were captured, on the screen of the communication terminal 103 as illustrated in FIG. 11. The screen of the communication terminal 103 is provided with a touch panel.

The screen is provided with button M1 for acquiring the current image, button M2 for terminating the application, button M3 for displaying images preceding the currently displayed image, button M4 for displaying newer images succeeding the currently displayed image, etc. Further, the communication terminal 103 is capable of enlarging the desired portion of the displayed image. For example, region R illustrated in FIG. 11 may be enlarged as illustrated in FIG. 12 to allow the user to be aware of the remaining number of eggs.

Further, when the user touches the button M1 of the communication terminal 103, that is, when an operation for acquiring the latest image is inputted (B2: YES), the communication terminal 103 transmits instructions for capturing images of the fridge interior to the refrigerator 1 (B3), acquires the image from the server 104 (B4), and displays the acquired image (B5). After step B3, the image of the fridge interior is captured in the refrigerator 1 side given that the condition 3 has been met in FIG. 6. The image information of the captured image is thereafter transmitted to the server 104.

The home appliance network system 100 allows the status inside the refrigerator 1 to be checked from a remote location since the refrigerator 1 transmits image information of the captured image of the fridge interior to the server 104, the server 104 stores the image, and the communication terminal 103 displays the image acquired from the server 104.

The present embodiment described above provides the following effects.

The refrigerator 1 is provided with the image capturing camera 18 configured to capture images of the interior of storage chambers for storing food such as the refrigeration chamber 3 and the communication portion 52 configured to transmit image information of images of the fridge interior captured by the image capturing camera 18 to external devices. It is thus, possible to acquire images of the fridge interior through external devices such as the communication terminal 103. As a result, it is possible to readily check the status inside the refrigerator from a remote location.

In the present embodiment, the images of the fridge interior are stored in the server 104. Thus, there is no need to provide a storage unit for storing the images in the refrigerator 1 side, thereby suppressing manufacturing cost. A storage portion may alternatively be provided in the refrigerator 1 so that the images are stored in the refrigerator 1 side.

The control portion 50 is placed in a standby state after image information is transmitted to the server 104. That is, power consumption of the control portion 50 side (including the image capturing camera 18) is reduced or cutoff to zero when image capturing is not ongoing. It is thus, possible to suppress total electricity consumption of the refrigerator 1.

The control portion 50 is configured to control the timing in which the images of the fridge interior are captured by the image capturing camera 18 and to control the image capturing environment such as illumination of lights for capturing images of the fridge interior so as to be synchronized with the controlled timing of image capturing. A light source is required in capturing the images of the fridge interior. Unnecessary power will be consumed if the image capturing is constantly enabled. However, by controlling the image capturing environment to illuminate the image capturing light 19, etc. only when the image capturing is carried out so as to be synchronized with the timing of image capturing, it is possible to reduce unnecessary power consumption. A night vision camera (such as an infrared camera), etc. capable of image capturing without a light source may be used to perform image capturing without illumination of light. Alternatively, light maybe illuminated continuously.

The refrigerator 1 captures an image of the fridge interior by the image capturing camera 18 at the timing after the door of the refrigeration chamber 3 has been closed. When images are captured even when the status of storage of the refrigerator has not been changed, unnecessary images will accumulate at the expense of unnecessary increase of power consumption. Thus, in the present embodiment, the refrigerator captures an image of the fridge interior at the timing after the door once opened has been closed. As a result, when encountering a state in which the status of food storage in the refrigerator may be changed (the state when the door is opened), the image of the fridge interior is captured when the status of storage has been settled (after the door is closed). It is thus, possible to suppress unnecessary image capturing and increase of power consumption.

Further, the refrigerator 1 captures an image of the fridge interior at the timing after the door has been closed and after the delayed image capturing time required to remove dew condensate from the wide-angle lens of the image capturing camera 18 has elapsed. During the summer time for example when the temperature as well as the humidity are high, dew condensate may result on the lens surface of the image capturing camera when the door is closed after once being exposed to exterior environment when the door was opened, since the temperature inside the refrigerator 3 is low. Hence, image of the fridge interior is captured again at the timing in which the delayed image capturing time, expected to be sufficient to remove the dew condensate, has elapsed. It is thus, possible to capture clear images with a fogless lens surface. As a result, it is possible to check the status inside the refrigerator even more reliably.

The delayed image capturing time may be specified based on the environment outside the refrigerator acquired by the outside fridge sensor 33c such as temperature and humidity. As a result, dew condensate can be expected not to occur (or occur in small amount) when temperature and/or humidity is low, etc. It is thus, possible to reduce the delayed image capturing time and thereby reduce power consumption. More specifically, when the control portion 50 is arranged to standby until the lapse of the delayed image capturing time for example, shorter standby time will result in less power consumption.

Further, dew condensate on the wide-angle lens of the image capturing camera 18 may be removed by a removing unit such as the lens heater 51. In such case, the refrigerator 1 captures an image of the fridge interior at the timing after the dew condensate has been removed from the lens surface by the lens heater 51. The use of the lens heater 51 further allows the delayed image capturing time to be shorted and consequently allows power consumption to be further reduced. A heat conducting member that transmits heat produced by the control portion 50 may be used as the lens heater 51. As a result, it is possible to remove dew condensate from the lens surface without consuming extra power. It also possible to reduce power consumption by shortened delayed image capturing time when a fan is used as the removing unit.

The refrigerator 1 captures image of the fridge interior for example at the timing when instructions to capture image of the fridge interior is received from the communication terminal 103. For example, when the user is at a remote location, the status of storage may change if the user's family takes food out of the refrigerator 1. It is possible to check the latest, i.e. the current status inside the refrigerator 1 by capturing the image of the fridge interior at the point of receiving user instructions.

The refrigerator 1 captures image of the fridge interior when the go-out switch has been operated. It is thus, possible to check the status inside the refrigerator 1 after going outdoors. In case the user living alone goes out, the status of storage of the refrigerator 1 is not expected to change from the moment the user leaves his/her residence. It is thus, possible to deem the image captured at the time of operating the go-out switch to be the latest image of the fridge interior.

Though not employed in the present embodiment, condition 2 may be employed to capture the image of the fridge interior when there is a possibility that the status of food storage may change. It is thus, possible to acquire image of the fridge interior which is close to the latest image. In such case, the view of the image capturing camera 18 may blur due to instability while the right-side door 3b is open. However, it is possible to reduce the image blur by capturing the image at the moment when the right-side door 3b is opened and by the illuminance provided by in-fridge lighting illuminated when the door is opened.

When capturing image of the fridge interior by the image capturing camera 18, the refrigerator 1 controls (organizes) the image capturing environment by illuminating the image capturing light 19 for lighting the fridge interior. It is thus, possible to secure source of light even when the door is closed and thereby allow image of the fridge interior to be visibly captured.

Among the lighting units such as the ceiling light 13, the image capturing light 19, and the side light 36 provided in the fridge interior, the refrigerator 1 illuminates the image capturing light 19 for lighting a specific location (in this case, the image capturing location, in particular). When capturing images using the image capturing camera 18, light may directly enter the view of the image capturing camera 18 to create a back light depending upon the relative positioning of the image capturing camera 18 and the lighting units provided in the fridge interior. In such case, the lighting unit, such as the image capturing light 19, for lighting a specific location which does not create a back light during image capturing may be illuminated for example instead of illuminating all of the lighting units. As a result, it is possible to capture images with improved clarity. More specifically, when a lighting unit is provided in the rear surface side so as to confront the image capturing camera 18 for example, at least the lighting unit creating the greatest degree of back light may be unlit while illuminating other lighting units (such as the ceiling light 13).

Because the image capturing light 19 is not disposed at a location to confront the image capturing camera 18 and is oriented in the direction in which the view of the image capturing camera 18 is oriented. Thus, light coming from the image capturing light 19 does not create a back light. As a result, it is possible to check the status of the fridge interior in detail.

The image capturing light 19 requires some amount of distance in order to establish a view for capturing an image of the fridge interior. Since the image capturing camera 18 is provided on the door of the refrigeration chamber 3, it is possible to secure sufficient distance between the image capturing camera 18 and food stored on the shelves 11, etc. and establish a large view.

Because the image capturing camera 18 is provided on the inner plate 14 of the right-side door 3b, it is possible to capture an image of the fridge interior even when the door is closed.

Since the image capturing camera 18 is provided near the vertical center and near the lateral center of the refrigeration chamber 3 while also employing a wide-angle lens, the image capturing camera 18 is capable of capturing the image of substantially the entirety of the refrigeration chamber 3 interior as viewed from the vicinity of the central portion of the fridge interior (which is close to the view available to the user when the user normally looks into the refrigerator 1). Because the shelves 11 are made of a transparent material, it is possible to visibly capture an image of food placed on the uppermost shelf 11 through the shelves 11.

The door pocket 9b located adjacent to the image capturing camera 18 is shaped so that one side proximal to the image capturing camera 18 extends in a direction to avoid the image capturing camera 18. It is thus, possible to secure sufficient lateral view in the image capturing camera 18 employing a wide-angle lens. Because the image capturing camera 18 is provided in a location adjacent to the door pocket 9b, the vertical view is not blocked by the door pocket 9b.

Because the image capturing camera 18 is disposed at a location capable of capturing an image of at least some of the door pockets 8 to 10, it is possible to capture an image of food stored in door pockets 8 to 10 to allow food stored in the fridge interior to be checked more elaborately. The door pocket 9b of the present embodiment disposed adjacent to the image capturing camera 18 need not be visible (image need not be captured for the same). The above described locationing of the image capturing camera 18 offers similar effects when applied to a removable camera later described in a second embodiment.

The communication terminal 103 is provided with a display portion configured to display images and is capable of acquiring images of the fridge interior captured by the above described refrigerator 1 and displaying the same on the display portion. It is thus, possible to check the status of the fridge interior from a remote location such as outdoors.

The home appliance network system 100 provided with the refrigerator 1, the communication terminal 103, and the server 104, provided with the storage unit for storing images of the fridge interior captured by the refrigerator 1. The communication terminal 103 establishes connection with the server 104 via the communication line 102 and acquires and displays images of the fridge interior stored in the server 104. It is thus, possible to check the status of the fridge interior from a remote location for example from outdoors. Since the images are stored in the server 104, a large volume storage portion need not be provided in the refrigerator 1 side, thereby preventing increase in the cost of the refrigerator 1. Since the communication terminal 103 acquires images from the server 104, it is not required to keep the control portion 50 of the refrigerator 1 in a communicable state. It is thus, possible to inhibit increase of power consumption in the refrigerator 1 side.

It is further possible to check the fridge interior from a remote location by executing the in-fridge image displaying program from the communication terminal 103. The in-fridge image displaying program executes the image acquiring process (steps B1 and B4 of FIG. 10) for acquiring image information of the storage chamber interior captured by the image capturing camera 18, the display process (step B5 of FIG. 10) for displaying image information acquired in the image acquiring process, and an image capturing process (step B2 and B3) for capturing images of the fridge interior through the image capturing camera serving as the image capturing unit by outputting instructions for capturing images of the fridge interior.

### Second Embodiment

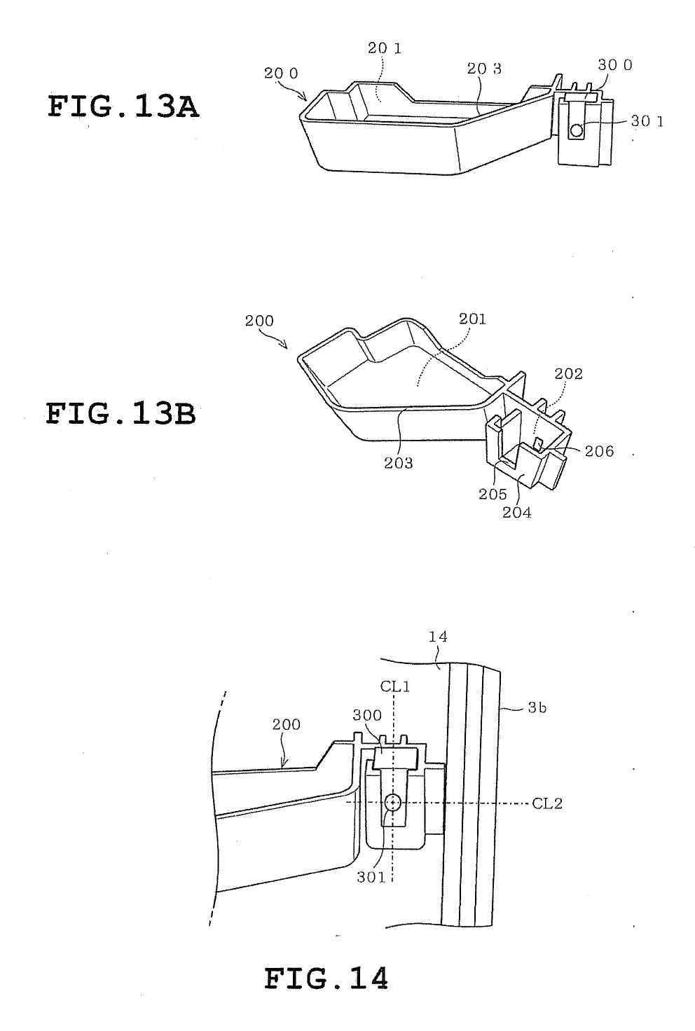

A description will be given hereinafter on a second embodiment with reference to FIGS. 13A to 25. Since the configuration of the refrigerator 1 is substantially identical to the configuration of the first embodiment, a description will be given with reference to FIG. 2, etc. as well.

As illustrated in FIGS. 13A and 13B, a door pocket 200 (one example of a refrigerator door pocket) of the present embodiment is provided with a storing portion 201 for storing items and a holding portion 202 for holding a camera device 300. The door pocket 200 functions as a refrigerator door pocket and a refrigerator holder recited in the claims. The holder 200 may be considered as one example of a receiving portion for mounting the image capturing unit. From the standpoint of the storage portion 201, the door pocket 200 may be described as being provided adjacent to the camera device 300 (i.e. the image capturing unit) held by the holding portion 202.

The storing portion 201 is provided with a wall 203 disposed in the holding portion 202 side which extends obliquely away from the holding portion 202. That is, the door pocket 200 is formed into a shape extending along the outer edge of the view of the camera device 300 so as not to block its view when the camera device 300 is held by (attached to) the holding portion 202.

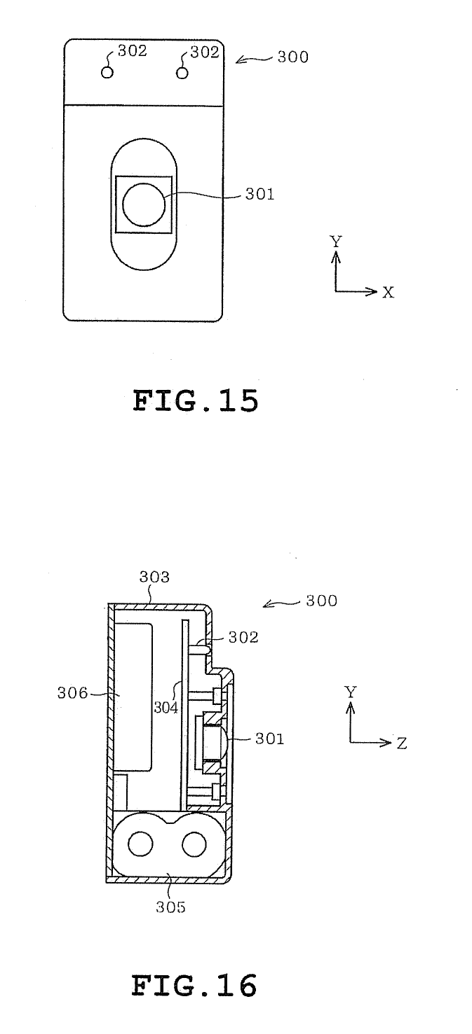

The upper side (the upper side as viewed in FIG. 13A) of the holding portion 202 of the present embodiment is shaped like an open box and the camera device 300 is taken in and out (attached/detached) from the upper side opening. Further, a wall 204 provided in the front surface side of the holding portion 202 (that is, the side facing the fridge interior) has a notch 205 formed at a location where a lens 301 and an image capturing lamp 302 (See FIG. 15, etc. examples of a camera side light unit and lighting unit) are located when the camera device 300 is held. Thus, the view of the camera device 300 is unblocked and reflection of lighting is prevented.

Further, the holding portion 202 is provided with a magnet 206. The magnet 206 is arranged so that one side of the magnet 206 facing the back side of the camera device 300 is the N pole or the S pole. The polarity of the magnet 206 will be detailed when describing the structure of the camera device 300.

The door pocket 200 is mounted on the inner plate 14 of the right-side door 3b as illustrated in FIG. 14. Thus, the view of the camera device 300 faces the fridge interior (refrigeration chamber 3) when the right-side door 3b is closed. The camera device 300 is held by the holding portion 202 so that the center of the lens 301 is located on the intersection of line CL1 running through the lateral center of the refrigeration chamber 3 and line CL2 running through the vertical center of the refrigeration chamber 3. That is, the camera device 300 disposed in this state has a view centering on the central portion of the refrigeration chamber 3. More specifically, the door pocket 200 is configured so that the bottom portion of the holding portion 202 is slightly lower than the bottom portion of the storing portion 201 in consideration of the location where the door pocket 200 is mounted and the shape of the camera device 300 so that the central portion of the lens 301 is located at the optimal position.

As illustrated in FIGS. 15 and 16, the camera device 300 is provided with the lens 301 and the image capturing lamp 302 which are exposed on a surface of body 303 formed into a generally cuboid shape. The surfaces of the lens 301 and the image capturing lamp 302 may be covered by a cover, etc. instead of being exposed in a naked state. A wide-angle lens is employed in the present embodiment as well.

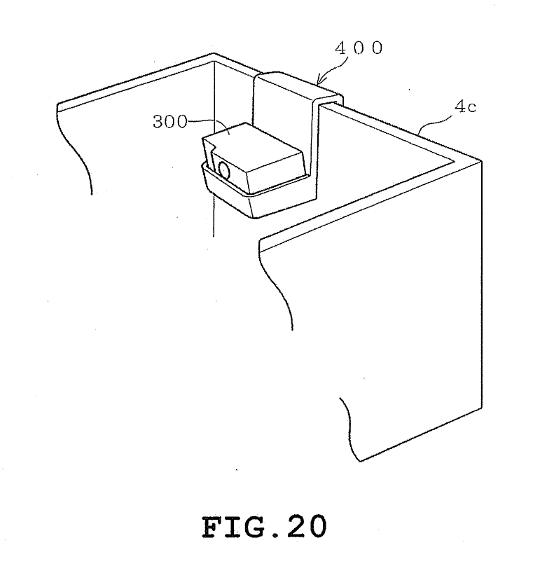

A description will be given hereinafter with an assumption that one side (the right side in FIG. 16) of the camera device 300 in which lens 301 and the image capturing lamp 302 are provided is the front surface and the opposite side is the rear surface. Further, as illustrated in FIGS. 13A-13B, the orientation in which the lens 301 and the image capturing lamp 302 are disposed along the up and down direction of the refrigerator 1 is referred to as the vertical orientation and the orientation in which the lens 301 and the image capturing lamp 302 are disposed along the left and right direction of the refrigerator 1 as illustrated in the later described FIG. 20 is referred to as the landscape orientation.

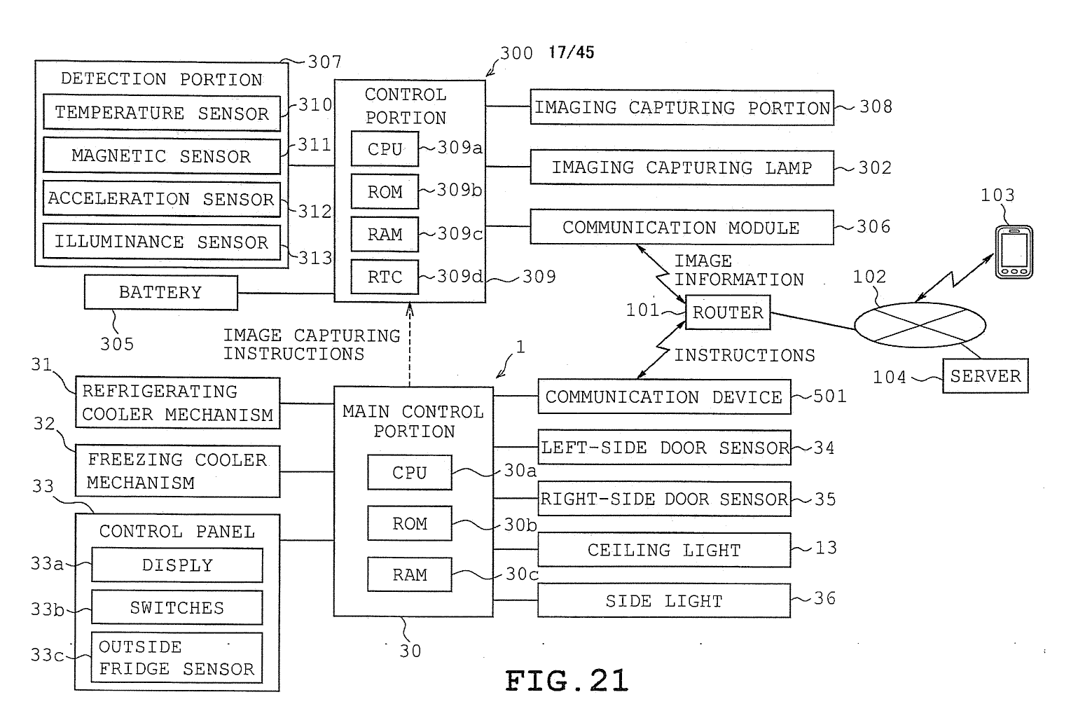

As illustrated in FIG. 16, the camera device 300 contains a control substrate 304, a battery 305, a communication module 306, and a detecting portion 307 inside the body 303. The control substrate 304 is provided with: an image capturing portion 308 (see FIG. 21) including the lens 301, an image capturing element not illustrated, etc.; the image capturing lamps 302, two in the present embodiment; and a control portion 309 (see FIG. 21) for controlling the foregoing components. The image capturing element is a known image capturing element such as a CCD, CMOS, or the like, which, in this example, exhibits a rectangular shape. In the present embodiment, the lengthwise direction of the image capturing element is oriented in the up and down direction (that is, the vertical direction of the body). Thus, when capturing images of the refrigeration chamber 3 formed in a vertically elongated shape, the image capturing element can, in general, be oriented along the vertically elongated shape by orienting the camera device 300 in the vertical direction. When capturing an image of the vegetable chamber 4 formed in a laterally elongated shape as later described, the image capturing element can be oriented along the laterally elongated shape by orienting the camera device 300 in the landscape direction. Further, an LED is employed as the image capturing lamp 302 in the present embodiment. Though not illustrated, the camera device 300 is also provided with a power switch.

The battery 305 is configured by a lithium battery which supplies electric power to the control portion 309, the communication module 306, the detection portion 307, and the like. The battery 305 is located on the lowermost portion of the body 303 and occupies substantially the entire area extending in the front and rear direction (the left and right direction as viewed in FIG. 16). The balance of the mounted camera device 300 is somewhat established by disposing the battery 305, being relatively heavy among the components stored in the body 303, in such location. By placing the gravitational center at the lower portion (when oriented in the vertical direction) of the camera device 300, the camera device 300 is prevented from falling out of the door pocket 200, etc. by the centrifugal force, oscillation, etc. exerted by the opening and closing of the door, when the camera device 300 is placed in the door pocket 200 of the right-side door 3b. By using the lithium battery, excellent discharge properties can be achieved even in a relatively cool place such as the interior of the refrigerator 1.

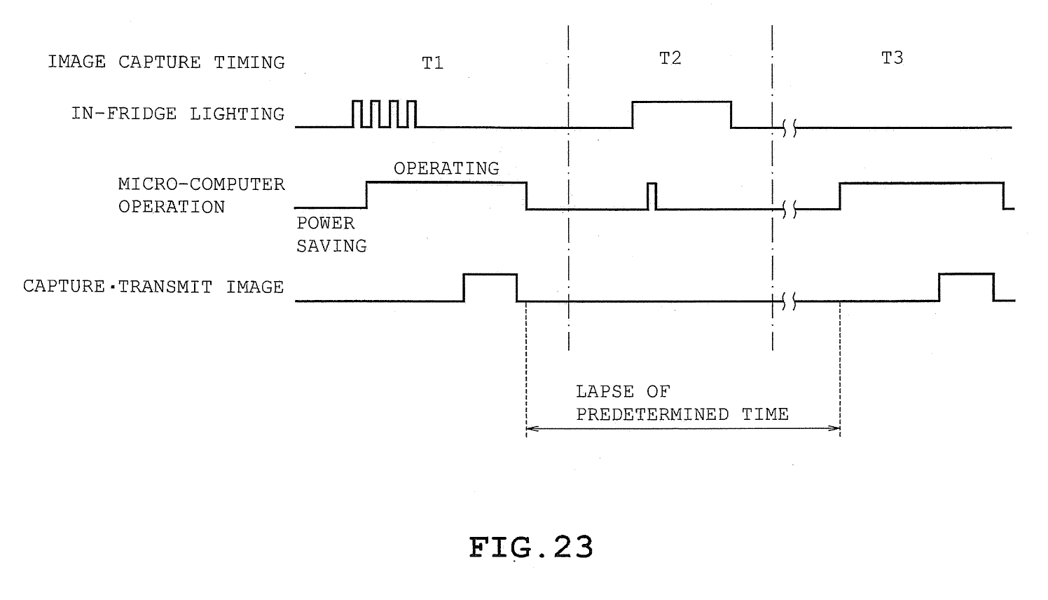

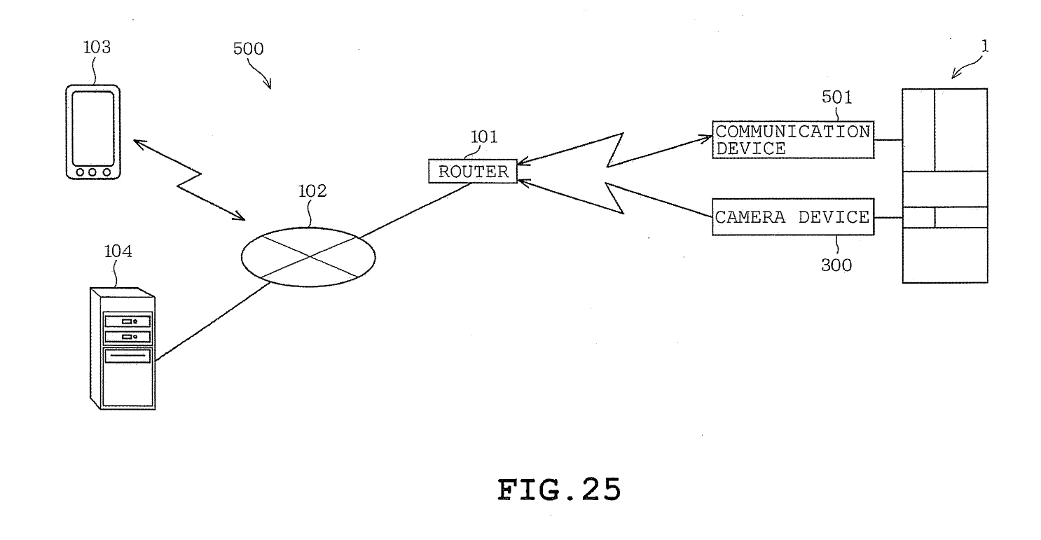

As illustrated in FIG. 25, the home appliance network system 500 of the present embodiment is provided with another communication device 501 in the refrigerator 1 side which is different from the communication module 306 of the camera device 300. The communication device 501 allows the refrigerator 1 to receive image capturing instructions from external devices. The communication device 501 is mounted on the refrigerator 1 and the camera device 300 is disposed inside the refrigeration chamber 3. The communication device 501 serves as a fridge-side communication unit configured to receive instructions for capturing an image of the fridge interior (hereinafter also referred to as image capturing instructions) from external devices. In the present embodiment, the communication device 501 is configured as an adapter for wireless communication and is detachably attached to the refrigerator 1. Thus, it is possible for the user to set up the communication device 501 as an optional accessory after purchasing the refrigerator 1. The communication device 501 is capable of communicating with the main control portion 30 of the refrigerator 1 as illustrated in FIG. 21 through wireless communication method or wired communication method. As later described in detail, the refrigerator 1 is sends image capturing instructions (see FIG. 23 which indicates a light flickering signal in the present embodiment) to the camera device 300 when receiving an image capturing instructions.

The communication module 306 of the camera device 300 is configured to be communicable with the router 101 and transmits image information to the communication terminal 103 and the server 104. The communication module 306 serves as a camera-side communication unit configured to transmit image information of the fridge interior captured by the camera device 300 to external devices such as the communication terminal 103 and the server 104 (see FIG. 1). The communication module 306 is provided along the wall in the rear surface side (outermost edge side) of the body 303 of the camera device 300. The antenna not shown installed in the communication module 306 is disposed so that other components, etc. do not intervene the body 303 and the antenna. As a result, transmission of electronic waves to and from the antenna is inhibited from being interrupted (communication failure is inhibited). Further, the communication module 306 is disposed in the vertical direction with respect to the battery 305 so that the antenna and the battery 305 do not confront each other.

The front surface of the right-side door 3b of the refrigerator 1 is formed of a glass material as described above. Thus, electric waves for wireless communication outputted from the camera device 300 disposed in the fridge interior is allowed to permeate more easily through the door as compared to metal plate, or the like. Further, the camera device 300 is disposed in the holding portion 202 (that is, the opening end side of the right-side door 3b) of the door pocket 200. Thus, especially in a double door configuration as is the case in the present embodiment, it is possible to let out the electric waves from the clearances between the doors. Further, by disposing the camera device 300 in the holding portion 202, it becomes easier to propagate the electric waves coming from the camera device 300 even when the front surface of the door is made of metal material, etc. for example. Because urethane is filled inside the door, there is a small possibility of the electric waves being blocked.

A vacuum thermal insulation material may be used instead of urethane or with urethane to serve as a thermal insulation material of the refrigerator 1. The vacuum insulation material is formed into a thin rectangular plate by wrapping a core material with glass fiber, etc. with a film formed by adhering (laminating) a metal foil (aluminum foil for example) on a film made of synthetic resin for example. The vacuum thermal insulation material is used inside the body and the doors of the refrigerator 1; however, when the camera device 300 is disposed in the door pocket 200, the vacuum insulation material may be provided for example so as to avoid the portion corresponding to the holding portion 202 so as to facilitate propagation of electric waves.

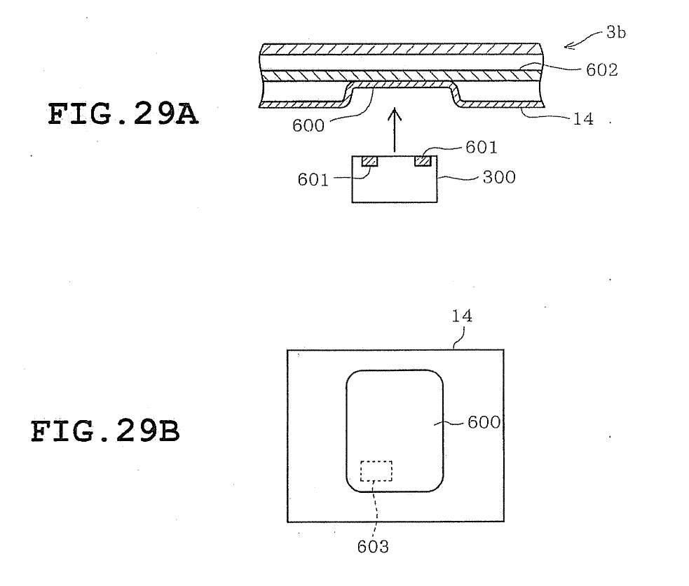

For example, the vacuum thermal insulation material may be provided in the right-side door 3b so as to avoid the projected surface (especially the portion of the communication module) of the camera device 300; whereas in the left-side door 3a and door 7a of the lower freezer 7 in which the camera device 300 is not provided, their entire surface may be provided with the vacuum thermal insulation material and thereby facilitate propagation of electric wave without degrading the thermal insulativity of the refrigerator 1. The glass plate 3b1 described above may be reinforced or a metal material for mounting the camera device 300 may be provided on the door using a magnet as illustrated in FIGS. 29A-29B later described. It is possible to facilitate propagation of electric waves by disposing them in appropriate locations as was the case with the vacuum thermal insulation material.

The structure for facilitating the propagation of electric waves from the fridge interior is especially useful in a configuration in which the communication module 306 is provided in the camera device 300 disposed inside the refrigerator 1 and the captured image information is transmitted directly to external devices from the camera device 300 (that is, in a configuration in which the camera device 300 transmits image information without the intervention of the communication device 501 of the refrigerator 1) as is the case in the present embodiment.

Next, a description will be given on the polarity of the magnet 206 described above.

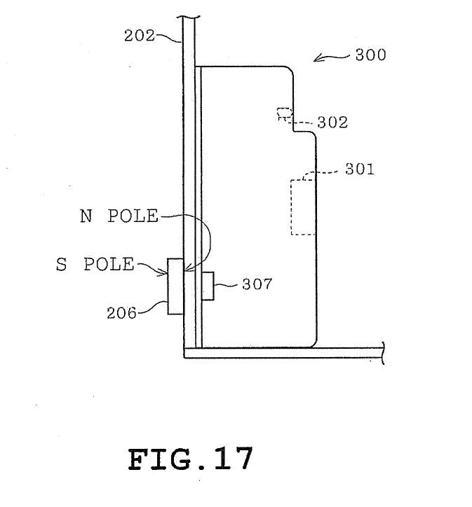

As illustrated in FIG. 17, the magnet 206 is provided in a location of the holding portion 202 corresponding to the detecting portion 307 in the rear surface of the camera device 300. Thus, when the camera device 300 is held by the holding portion 202, the detecting portion 307 confronts the magnet 206 and is placed in close proximity of the magnet 206. In such case, the magnet 206 is disposed so that the N pole side of the magnet 206 faces the camera device 300. Thus, the detecting portion 307 detects the strength of magnetic field produced by the N pole.

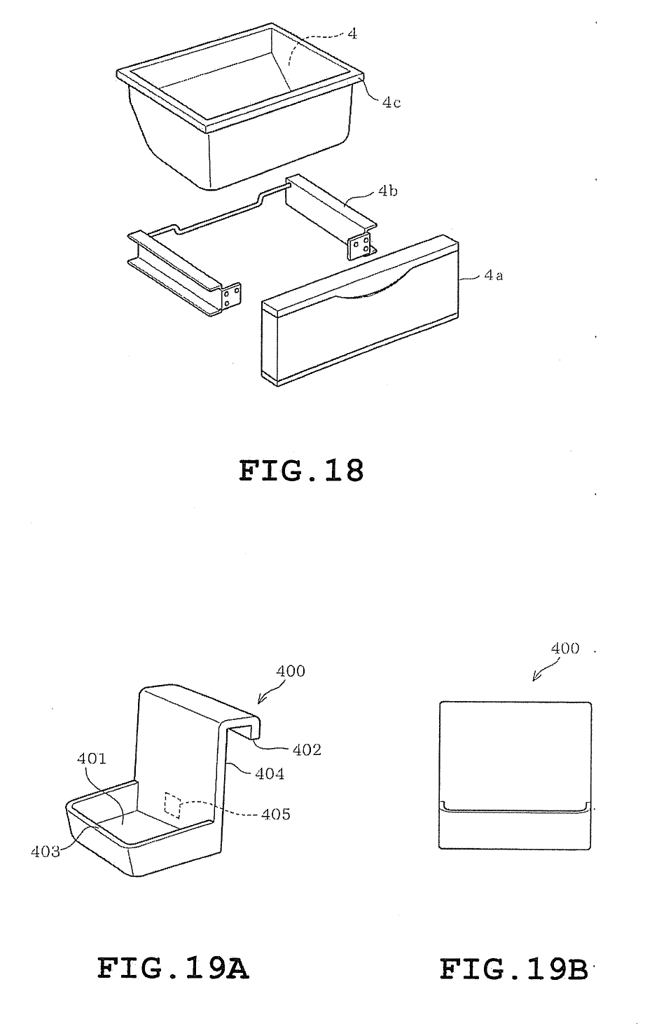

The polarity of the magnet 206 is oriented in the above described manner because the camera device 300 is also designed to be placed in other locations besides the refrigeration chamber 3 such as the vegetable chamber 4. As illustrated in FIG. 18, the vegetable chamber 4 is structured so that a rail member 4b is mounted on the door 4a and a vegetable chamber box 4c is mounted on the rail member 4b. A refrigerator holder 400 illustrated in FIG. 19 is employed in the present embodiment in order to capture an image of the above described vegetable chamber 4 using the camera device 300. The refrigerator holder 400 is provided with a holding portion 401 configured to hold the camera device 300, an engagement portion 402 configured for mounting the holding portion 401 on the vegetable chamber box 4c. The holding portion 401 is formed in a shape to allow the camera device 300 to be held in a landscape orientation and is provided with a front wall 403 located in the front surface side thereof that is formed in a height that does not block the view of the lens 301.

A magnet 405 is provided in a location of a rear wall 404 of the holding portion 401 corresponding to the rear surface of the camera device 300. The magnet 405 is disposed so that the S pole side of the magnet 405 faces the camera device 300. Thus,

when the refrigerator holder 400 is mounted on the vegetable chamber 4 as illustrated in FIG. 20 and the camera device 300 is held by the holding portion 401, the camera device 300 is held in the landscape orientation and the detecting portion 307 confronts the magnet 405 as was the case illustrated in FIG. 17.

The detecting portion 307 detects the strength of magnetic field produced by the S pole.

As described above, the polarities of the sides of the magnet 206 and magnet 405 confronting the camera device 300 are opposite of one another. Thus, the detecting portion 307 of the camera device 300 detects different magnetic field levels when the camera device 300 is installed in the refrigeration chamber 3 and in the vegetable chamber 4. Stated differently, the camera device 300 is capable of detecting the storage chamber in which it is placed. Further, the camera device 300 is capable of judging whether the refrigerator 1 in which it is placed is eligible for its operation through detection of magnetism. That is, the magnet 206 and the magnet 405 serves as one example of a detection subject unit recited in the claims.

Next, a description will be given on the electrical configuration of the camera device 300.

As illustrated in FIG. 21, the camera device 300 is provided with a control portion 309. The control portion 309 is configured by a microcomputer including components such as a CPU 309a, ROM 309b, RAM 309c, RTC 309d, etc. and serves as one example of the camera-side control unit responsible for overall control of the camera device 300. More specifically, the control portion 309 executes a control of the timing of image capturing carried out by the image capturing portion 308 provided with the lens 301, the image capturing element, etc.; a control for preparing image capturing environment using the image capturing lamp 302 (illumination control) at the time of image capturing; a control for transmission of image information, receiving a later described instructions, etc. carried out by the communication module 306; and a control for judging and identifying the installation status by the detecting portion 307. In the present embodiment, the control portion 309 is also configured to execute image processing in which the captured image is corrected, etc.

First a description will be given on the control of judgment and identification of installation status executed by the detecting portion 307. The detecting portion 307 is provided with a temperature sensor 310, a magnetic sensor 311, an acceleration sensor 312, and an illuminance sensor 313. The control portion 309 judges which of the storage chambers the camera device 300 is installed by detecting the outside temperature using the temperature sensor 310. A description will be given hereinafter on how the judgment is made in more detail.

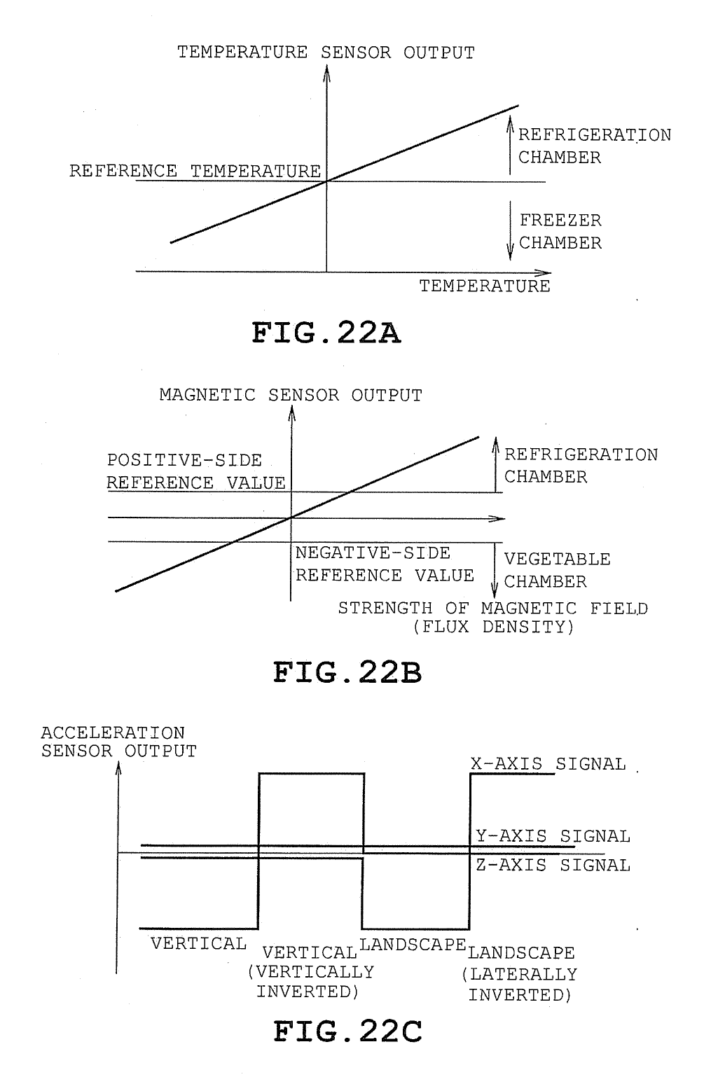

The temperature sensor 310 detects the temperature of the place in which the camera device 300 is installed. The temperature sensor 310 increases its output in proportion to the increase in the temperature as illustrated in FIG. 22A. Generally, there is approximately 11 to 19 degrees Celsius of difference between the temperature of the refrigeration chamber 3 and the temperature of the lower freezer 7. Thus, a reference temperature serving as a reference may be specified and if the detected temperature is greater than the reference temperature, a judgment is made that the place of installation is the refrigeration chamber 3, whereas if the detected temperature is less than the reference temperature, a judgment is made that the place of installation is the lower freezer 7. When a judgment is made that the place of installation is the lower freezer 7, there is a risk of failure, etc. thus, the image capturing lamp 302 may be illuminated or an audio output unit such as a buzzer may be provided to output a sound alert that the place of installation is an unintended place or such alert may be transmitted to the refrigerator 1 side through the communication module 306 and presented to the user through the touch panel 33, etc. of the refrigerator 1. The camera device 300 determines its place of installation based on the temperature detected by the temperature sensor 310.

The magnetic sensor 311 detects the magnetic fields produced by the magnet 206 and magnet 405 as described above. As illustrated in FIG. 22B, the magnetic sensor 311 varies its output to the positive side (in case of N pole) and to the negative side (in case of S pole) depending upon whether the magnetic field is produced from the N pole or the S pole. That is, when the output of the magnetic sensor 311 is positive (not 0), it is possible to detect that the camera device 300 has been installed in a location confronting the magnet 206 provided in the door pocket 200 of the refrigeration chamber 3, meaning that it is possible to detect that the camera device 300 has been installed inside the refrigeration chamber 3.

When there is temperature difference between the refrigeration chamber 3 and the vegetable chamber 4, a judgment may be made as to whether the place of installation is the refrigeration chamber 3 or the vegetable chamber 4 based on the output of the temperature sensor 310. In either case, it is possible to detect that the camera device 300 has been installed in the storage chamber based on the output of the temperature sensor 310.

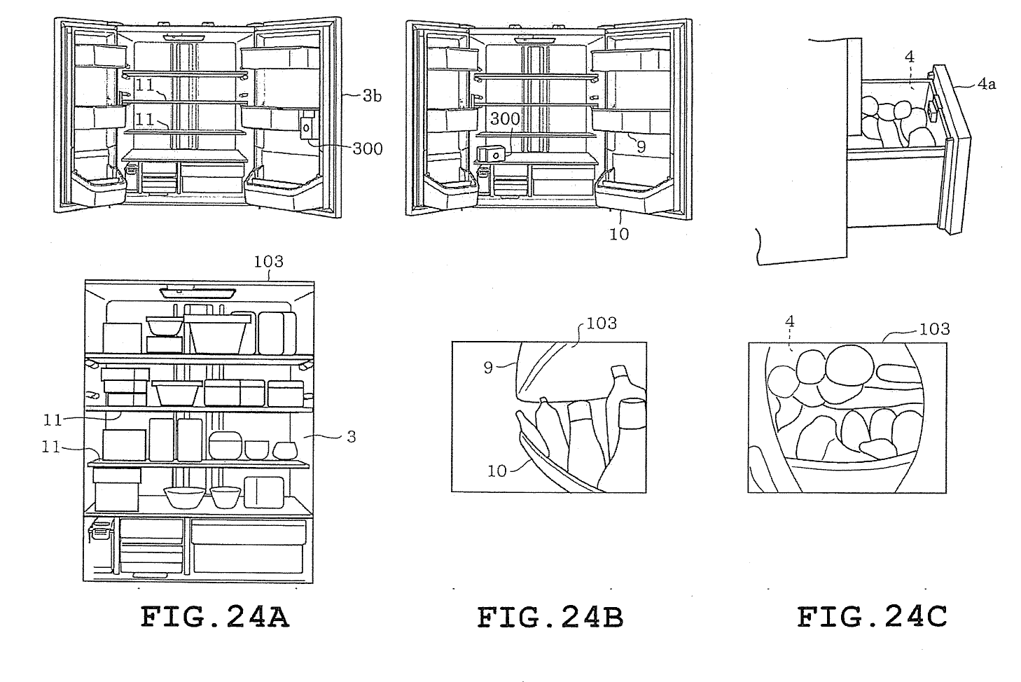

When the output of the magnetic sensor 311 is negative (not 0), it is possible to detect that the camera device 300 has been installed in a location confronting the magnet 405, meaning that it is possible to detect that the camera device 300 has been installed inside the vegetable chamber 4. In the present embodiment, the possibility of installing the camera device 300 on the shelf 11, etc. for example (see FIG. 24B) is taken into consideration. When the output of the magnetic sensor 311 is greater than the positive reference value, a judgment is made that the place of installation of the camera device 300 is the refrigeration chamber 3. When the output of the magnetic sensor 311 is less than the negative reference value, a judgment is made that the place of installation of the camera device 300 is the vegetable chamber 4. When the output of the magnetic sensor 311 is close to zero, a judgment is made that the place of installation of the camera device 300 is the shelf 11, etc. which is not provided with a magnet. The judgment of the temperature sensor 310 may be combined to judge whether or not the camera device 300 is stored in the storage chamber.

The acceleration sensor 312 is configured to detect the acceleration (gravitational acceleration) applied to the camera device 300. The acceleration sensor 312 serves as the so-called triaxial sensor configured to detect the acceleration of the three axes namely, the X axis, the Y axis, and the Z axis (see FIGS. 15 and 16). Thus, as illustrated in FIG. 22C, the output varies when the camera device 300 is oriented in the vertical direction, oriented in the vertical direction (reversed in the up and down direction), oriented in the landscape direction, and oriented in the landscape direction (reversed in the left and right direction). It is thus, possible to detect the orientation of the installed camera device 300. The detected orientation of the camera device 300 is used in the later described image processing or may be used in the judging the place of installation of the camera device 300.

Next, a description will be given on the timing of image capturing. The process flow of image capturing is substantially the same as FIG. 6 of the first embodiment and thus a description will be given with reference to FIG. 6 as well.

The camera device 300 judges whether a predetermined time period has elapsed or instructions have been received from an external device; that is, a judgment is made as to whether or not image capturing conditions have been met (A1). The camera device 300 judges whether or not the predetermined time period has elapsed by measuring time using RTC 309d and whether or not instructions have been received based on the illuminance detected by the illuminance sensor 313.

The illuminance sensor 313 configuring the detecting portion 307 detects the illuminance of the place where the camera device 300 has been installed. In the present embodiment, the illuminance sensor 313 informs the control portion 309 when detecting an illuminance approximating the illuminance of the in-fridge lighting being turned on. Further, the refrigerator 1 of the present embodiment, in which the camera device 300 is installed, flickers the in-fridge lighting such as the ceiling light 13 according to a predetermined flickering pattern when receiving instructions for image capturing from an external device. The image capturing instructions is issued in the similar manner as steps B2 to B4 of the terminal-side process indicated in FIG. 10 of the first embodiment when issued for example by the communication terminal 103.

The flickering pattern informs the image capturing timing to the camera device 300, being detachably attached to the refrigerator 1, and is preset. That is, the refrigerator 1 alerts the image capturing instructions to the camera device 300 by flickering the in-fridge lighting. This is realized by providing the configuration to judge whether or not the refrigerator 1 is eligible for image capturing operation (that is, whether or not the refrigerator is capable of flickering the in-fridge lighting) and the configuration to cause the camera device 300 to identify whether or not the refrigerator is eligible for image capturing operation as described above. That is, the in-fridge lighting being capable of flickering is an indication that the refrigerator 1 is eligible for operation of the camera device 300.

The camera device 300 is normally placed in a power save mode known as a sleep mode, etc. as indicated by period T2 in FIG. 23 during which period the illumination sensor is in operation. The refrigerator 1 flickers the in-fridge lighting according to a predetermined flickering pattern when receiving instructions from an external device as described above. The illumination of the in-fridge lighting causes the illuminance sensor 313 to report (input of interruption signal, etc.) to the control portion 309 to place the control portion 309 in an operating state. That is, a judgment is made that the image capturing conditions have been met when the in-fridge illumination has flickered in a predetermined flickering pattern. The flickering pattern may be of any pattern which may be specified by the ON/OFF period and the times of repeating such period, etc.

When judging that the image capturing conditions have been met (A1: YES), the camera device 300 illuminates the image capturing lamp 302 (A2), captures the image of the fridge-interior (A3), and transmits the image information to the server 104, etc. (A4).

The refrigerator 1 may illuminate the in-fridge lighting even in the absence of instructions. For example, the in-fridge lighting is illuminated in a non-flickering pattern (in a continuous illumination) when the door has been opened by the user as in period T1 indicated in FIG. 23. In this case, the camera device 300 is temporarily placed in an operating mode since the in-fridge lighting has been illuminated. However, the camera device 300 is returned to the standby mode since the predetermined flickering pattern is not followed, that is, the image capturing conditions have not been met.

When a predetermined period has elapsed, for example when a preset image-capturing time interval has elapsed as indicated by period T3 in FIG. 23, from the previous (period T2) image capturing, the camera device 300 makes a judgment that the image capturing conditions have been met (A1: YES), is placed in the operating mode, illuminates the image capturing lamp 302 (A2), captures the image of the fridge-interior at that point in time (A3), and transmits the image information (A4).

As described above, the camera device 300 captures an image of the fridge interior based on whether the predetermined period has elapsed and whether instructions have been given by an external component (presence of user's intent). The user is allowed to check the status of the fridge interior as illustrated in FIGS. 24A to 24C depending upon the place where the camera device 300 has been installed. Multiple camera devices 300 may be provided; for example, one in the refrigeration chamber 3 and one in the vegetable chamber 4.

In the present embodiment, the camera device 300 does not merely capture images of the fridge interior but also executes image processing such as image conversion.

The camera device 300 may be oriented in the vertical direction or the landscape direction as described above in which case the image is rotated by 90 degrees (or 270 degrees). Thus, the camera device 300 executes image conversion before the images are transmitted to the server 104. As a result, images with uniform vertical orientations looking like the view available when the user directly checks the refrigerator 1 can be displayed on the communication terminal 103 even when the camera device 300 is oriented differently as illustrated in FIGS. 24A and 24B or 24C.

Further, because the lens 301 is a wide-angle lens, the central portion of the captured image may be distorted as illustrated in FIG. 7 of the first embodiment. Thus, the camera device 300 is configured to correct the distortion by image processing. More specifically, an image processing is carried out so that the ratios of the central portion and upper and lower edge of the image match. As a result, it is possible to display images having little distortions as illustrated in FIG. 24A. The orientation of the image and the orientation of the camera device 300 may be transmitted as image information and image processing may be executed at the server 104 or the communication terminal 103. It is possible to reduce power consumption of the camera device 300 by executing the image processing at the external device side. Such arrangement is meaningful for the camera device 300 which does not possess means for supplying power from external sources.

The present embodiment described above provides the following effects in addition to (or instead of) the effects of the first embodiment. Some users wish to check the interior of the refrigerator 1 from remote locations such as outdoors. It is possible to check the fridge interior by acquiring images of the fridge interior using the communication terminal 103 from outdoors since the image capturing portion 308 (image capturing unit) for capturing images of the fridge interior and the communication module 306 (communication unit) for transmitting image information of the fridge interior acquired using the image capturing portion 308 to external devices such as the server 104 are provided in the refrigerator 1.

When capturing images of the fridge interior, repeating unnecessary image capturing will increase power consumption, cause battery shortages, and storage of unnecessary (redundant images) to the server 104. It is possible to reduce such concerns by controlling the timing in which the in-fridge images are captured by the control portion 309 of the camera device 300.

More specifically, there is a possibility that the user's family may take out food from the refrigerator 1, etc. when predetermined time period has elapsed. It is thus, possible to prevent unnecessary image capturing from being repeated by capturing images of the fridge interior at the timing when the predetermined period has elapsed, that is, when there is a possibility that the status of food storage may have changed.

Further, capturing an image of the fridge interior at the timing when instructions from the user have been received will allow the user to be updated with the latest storage status. Thus, by refraining from capturing images at the timing when a predetermined time period has elapsed, stated differently, by capturing images only when instructed by the user will eliminate unnecessary image capturing and thereby further reduces power consumption. As described earlier, image may be acquired when the storage status has changed by incorporating the image capturing conditions of the first embodiment.

Some users may not need to check the status inside the refrigerator 1. The camera device 300 provided with the image capturing portion 308 for capturing images of the fridge interior and the communication module 306 for transmitting image information of the fridge interior captured by the image capturing portion 308 to external devices such as the sever 104 is configured to be detachably attached to the refrigerator 1. Thus, users who do not need to check the status inside the refrigerator 1 may remove the camera device 300. Further, users who did not feel the need to check the status inside refrigerator 1 when purchasing the refrigerator 1 but has later felt such need will be able to check the status inside the refrigerator 1 by simply adding the camera device 300.

Because the communication device 501 is also configured to be detachably attached, users who do not need to check the status of the fridge interior may remove the same as was the case in the camera device 300 to reduce power consumption while also allowing the user to add the same at a later time.

A light source is required for image capturing. Because the image capturing lamp 302 (camera-side lighting unit) for illuminating the fridge interior is provided to the camera device 300, it is possible to capture the image of the fridge interior by the camera device 300 alone. Needless to say, the fridge interior may be illuminated through cooperation with the refrigerator 1.

Image capturing of the fridge interior may not be successful as it may be difficult to obtain a clear view depending upon where the camera device 300 is installed. It is thus, important to find a suitable place for image capturing. It is possible to install the camera device 300 in a location where the image of the entire refrigeration chamber 3 can be captured for example by providing a receiving portion (examples of which are holding portion 202 of the door pocket 200 and holding portion 401 of the refrigerator holder 400 in the embodiments) for mounting the camera device 300 to the refrigerator 1.

If it is not possible to flicker the in-fridge lighting as described above, it will not be possible to issue image capturing instructions from external components. By implementing a configuration in which magnetisms of the magnet 206 and the magnet 405 are detected by detecting portion 307, that is, by providing a detection subject unit for detecting that the refrigerator 1 is eligible for image capturing (image capturing is permitted) using the camera device 300, it is possible to reduce such concerns.

The communication module 306 may be configured to communicate with the refrigerator 1 side so that the communication module 306 serves as the detecting unit (in which case the communication device 501 serves as the detection subject unit). The communication module 306 may be used as an identifying unit for identifying whether or not the camera device 300 has been designed for use in the refrigerator 1 (for example designed to capture images by flickering the in-fridge lighting).

In the embodiment described above, the camera device 300 is driven by the battery 305 (meaning that when installed to the refrigerator 1, the camera device 300 is driven without power supply from external components). It is thus, preferable to reduce electricity consumption as much as possible. It is possible to reduce electricity consumption originating from wireless communication by making the communication module 306 communicate with the communication device 501 as compared to the electricity consumption resulting from the wireless communication between the communication module 306 and external components.

When configured to receive instructions from external devices, the communication unit needs to operate continuously to standby for the instructions. However, by configuring the communication device 501 to receive the instructions, it is no longer necessary to maintain the continuous operation of the communication module 306 and thereby extend the battery life.

The communication device 501 may be configured to receive supply of power from the refrigerator 1 side by wire communication such as USB. As a result, unnecessary supply of power need not be provided in the absence of the communication device 501 and when the communication device 501 is provided it may for example be arranged to operate continuously.

When the camera device 300 is configured to be detachably attachable, it may be more convenient when a wireless communication is employed. However, when instructions are received by the communication device 501, such instructions need to be somehow transmitted to the camera device 300. Thus, the illumination sensor 313 is provided to the camera device 300 so that the image capturing instructions are transmitted indirectly to the camera device 300 by flickering the in-fridge lighting. It is thus, possible to notify image capturing timing to the camera device 300 employing wireless communication. Since such arrangement only requires the camera device 300 side to keep the illuminance sensor 313 in an operating state, it is possible to reduce power consumption compared to keeping the communication module 306 in an operating state.

The front surface of the right-side door 3b in which the camera device 300 is provided is formed of a nonmetallic material. It is thus, possible to facilitate propagation of electric waves to the fridge exterior even when the camera device 300 as well as the communication module 306 are disposed inside the refrigeration chamber 3 tightly closed by the right-side door 3b. The same is true when the camera device 300 is disposed at the vegetable chamber 4.

For example, the refrigeration chamber 3 is generally elongated in the vertical direction and the vegetable chamber 4 is generally elongated in lateral direction. Thus, when there are multiple storage chambers, the view of the camera device 300 is preferably switched depending upon the storage chamber. The user may feel uncomfortable when the image is oriented sideways. Thus, it is preferable to provide images with uniform vertical orientations looking like the view available when the user checks the refrigerator 1 in person. Thus, the magnet 206 and the magnet 405 are provided he sides of the magnet 206 and magnet 405 confronting the camera device 300 are opposite of one another. As a result, it is possible to learn where the camera device 300 is installed (the mounting positions predetermined by the manufacturer, etc. which correspond to the holding portion 202 or the holding portion 401) and thereby allowing the orientation of the camera device 300 to be judged in such locations of installation. The holding portion 202 and the holding portion 401 are formed so that the camera device 300 is oriented vertically when installed in the refrigeration chamber 3 and oriented in the landscape direction when installed in the vegetable chamber in the present embodiment so that camera device 300 is installed in different orientations depending upon the storage chamber. As a result, appropriate view can be obtained depending upon the storage chamber and proper judgments can be made as to the direction in which the images need to be rotated in the image processing.

It is possible to: determine the orientation of the camera device 300 based on the orientation of the acceleration detected by the acceleration sensor 312, and determine where the camera device 300 is installed depending upon the temperature detected by the temperature sensor 310.

The camera device 300 may malfunction, etc. when inadvertently installed in the freezer. However, the possibility of malfunctioning, etc. can be reduced by detecting the temperature through the temperature sensor 310 or by allowing an alert to be issued as is the case in the present embodiment.

Capturing an image of the fridge interior using the camera device 300 requires the camera device 300 to face the front side of the fridge interior with some amount of distance in order to establish a view. However, the mounting position in the front side in the refrigerator 1 is limited by the door. Thus, in order to secure as much distance as possible, the camera device 300 may be mounted on the inner plate 14 of the door. However, the door pocket may block the view in such case. The door pocket 200 of the present embodiment is formed so that the wall 203 avoids the holding portion 202 (receiving portion) and thus, will not block the view of the camera device 300.

Further, because there are suitable places for capturing images of the fridge interior, it is desirable to notify such places to the user. By providing the holding portion 202 (the receiving portion for mounting the camera device 300) for holding the camera device 300 such as the door pocket 200, it is possible to noticeably indicate such places to the user. The holding portion 202 is formed so that when the camera device 300 is held by the holding portion 202, the view of the camera device 300 is located at the center of the refrigeration chamber. It is thus, possible to capture the image of substantially the entirety of the fridge interior. The center of the refrigeration chamber is established when the camera device 300 is installed in the holding portion 202. Thus, when correcting image distortion in the image processing, the center position of the subject of correction coincides with the center position of the image. As a result, equal amount of correction can be applied centering on such center position in correcting the distortion, thereby reducing the computation load in the image processing.

The door pocket 200 is provided with the magnet 206 serving as the target of detection of the magnetic sensor 311. It is thus, possible to allow the camera device 300 to identify the place of its installation.

The refrigerator 1 is provided with the vegetable chamber 4, etc. However, the vegetable chamber 4 is not provided with a door pocket and is formed in the shape of a box. Thus, the camera device 300 may become covered by vegetables, etc. stored therein when simply installed in the vegetable chamber 4. Thus, the camera device 300 may be installed in the vegetable chamber 4 by using a refrigerator holder 400 provided with a holding portion 401 for holding the camera device 300. The holding portion 401 is provided with an engagement portion 402 for engaging the holding portion 401 on the edge, etc. of the vegetable chamber box 4c. It is thus, possible to install the camera device 300 in the upper side of the vegetable chamber 4 and in the door 4a side to allow an image of the vegetable chamber to be captured without being covered by vegetables, etc. Because the holding portion 401 is engaged by the engagement portion 402, the holding portion 401 can be readily removed when not needed.

Because the magnet 405 is also provided on the refrigerator holder 400, the camera device 300 is allowed to judge where it has been installed as described above. The effects of the home appliance network system 500 and the in-fridge image displaying program are the same as those of the first embodiment.

### Other Embodiments

The present invention is not limited to the embodiments exemplified above but may be modified or expanded as follows. Some or all of the modified and expanded examples given below may be combined as required.

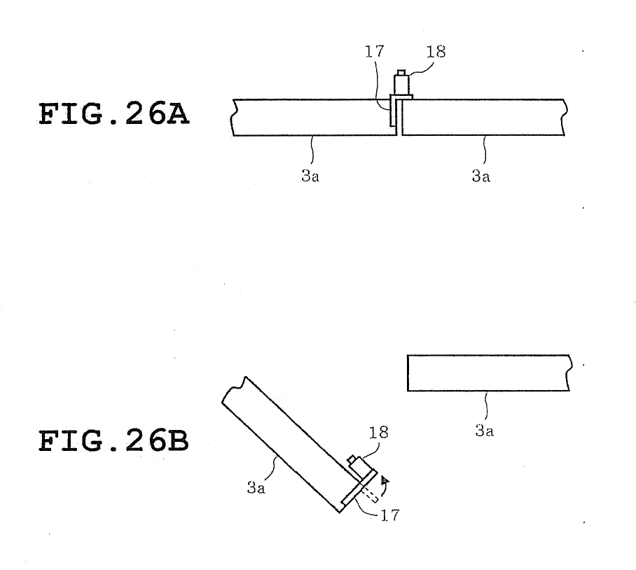

In the example discussed in the first embodiment, the image capturing camera is provided on the right-side door 3b. Alternatively, the image capturing camera 18 may be provided on the vertical partition 17 provided on the left-side door 3a. The vertical partition 17 rotates depending upon the opened/closed status of the left-side door 3a. When the left-side door 3a is closed as illustrated in FIG. 26A, the image capturing camera 18 faces the fridge interior and thus, is capable of capturing an image of the fridge interior. When the left-side door 3a is opened as illustrated in FIG. 26B, the image capturing camera 18 faces the inner plate side and thus, the lens surface will not be contaminated since the user will not come in contact with the image capturing camera 18.

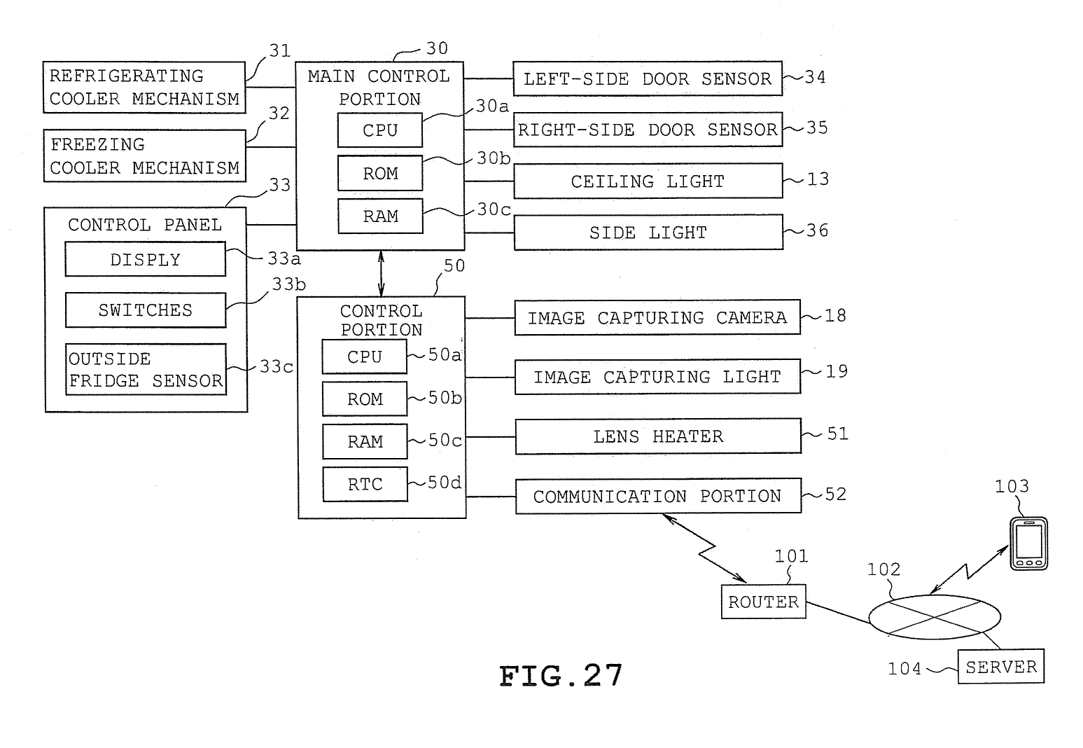

A single image capturing camera 18 and a single image capturing light 19 was provided in the example given in the first embodiment. Alternatively, multiple image capturing units (an upper image capturing camera 60, a lower image capturing camera 62, a door image capturing camera 64) and multiple lighting units (an upper image capturing light 61, a lower image capturing light 63) may be provided as illustrated as illustrated in FIG. 27. In such case, an image of the upper side of the fridge interior may be captured by the upper image capturing camera 60 and an image of the lower side of the fridge interior may be captured by the lower image capturing camera 62. That is, multiple image capturing units may be provided for capturing images of a specific location in the fridge interior. In such case, a single image of the fridge interior such as the image illustrated in FIG. 7 for example may be obtained by combining each of the images.

It is possible to capture an image of the entire range of the fridge interior without using a wide-angle lens since only images of specific locations in the upper side or the lower side of the fridge interior, etc. need to be captured. It is possible to reduce the size of the views of the upper image capturing camera 60 and the lower image capturing camera 62 compared to the view required for wide-angle image capturing using a single image capturing camera 18. Stated differently, the possibility of the view being blocked will be smaller compared to the first embodiment even if the notch 9b1 is not provided in the door pocket 9b. It is thus, possible to capture an image of the fridge interior while maintaining the original storage capacity of the door pocket.

Further, the image capturing environment may be controlled by illuminating the appropriate lighting unit depending upon the targeted location of image capturing. For example, upper image capturing light 61 may be illuminated when images are captured using the upper image capturing camera 60 and lower image capturing light 63 may be illuminated when images are captured using the lower image capturing camera 62. An image capturing unit may be provided for each shelf 11 for example in addition to the upper side portion and lower side portion.

Further, a single image of the fridge interior may be produced by combining multiple images by, for example, reducing the illuminance of the ceiling light 13 when capturing an image of the upper side of the fridge interior and controlling the illuminance of the ceiling light 13 to a normal level when capturing an image of the lower side of the fridge interior. That is, it is not necessarily required to provide lighting dedicated for image capturing such as the image capturing light 19.

In the first embodiment, the image capturing environment is controlled by illuminating the image capturing light 19. Alternatively, the image capturing environment may be controlled for example to weaken the back light against the image capturing camera 18 by reducing the illuminance of the ceiling light 13, the side light 36, etc.

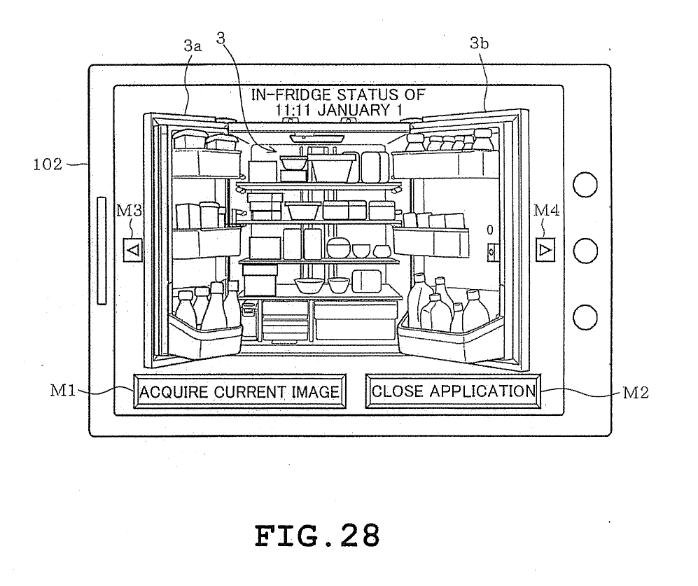

An image of the door pocket side may be captured using the door image capturing camera 64 which may be combined with and image of the fridge interior as illustrated in FIG. 28 to produce a synthetic image depicting the door of the refrigerator 1 being opened. The synthetic image may be displayed on the communication terminal 103. In such case, an image of the door pocket side may be captured by providing the door image capturing camera 64 in the fridge interior. Alternatively, the door image capturing camera 64 may be provided on each of the inner plates 14 of the doors. The door image capturing camera 64 may capture an image of the door pocket of the other door after the doors have been opened and an image may be captured after the doors have been closed. The images may be combined to obtain a single image of the fridge interior.

In the examples given in each of the embodiments, the captured images are stored in the server 104. However, the captured images may be transmitted directly to the communication terminal 103.

In each of the embodiments, the captured images are transmitted as they are. Alternatively, the images may be transmitted to the server 104 after correcting the image distortions caused by the use of the wide-angle lens. The image distortions may be corrected at the server 104.

In the examples given in each of the embodiments, an image of the fridge interior is captured at the timing when instructions to capture an image of the fridge interior from the communication terminal 103 has been received. However, an image of the fridge interior need not be captured upon receiving the instructions if an image has been captured after the elapse of the delayed image capturing time to serve as the latest image. That is, the image captured after the elapse of the delayed image capturing time is the latest image after the door of the refrigerator 1 has been closed. Thus, the state in which the image has been captured after the lapse of the delayed image capturing time may be deemed as the state in which the door has not been opened (the state in which the storage status has not changed) after the image has been captured. Hence, if the image captured after the elapse of the delayed image capturing time is the latest image, unnecessary power consumption can be prevented by refraining from further image capturing. When the communication terminal 103 acquires an image from the server 104, a notice may be issued indicating that the acquired image is the latest image.

In the first embodiment, the control portion 50 is provided independent of the main control portion 30. However, the main control portion 30 may be configured to control the image capturing camera 18, etc. It is thus, possible to reduce the number of components and cost. In such case, the captured images can be transmitted as they are to the server 104 as exemplified in the embodiment. This will eliminate the burdensome image processing and allow the control to be undertaken by the main control portion 30 alone.

In the first embodiment, a communication unit is provided in the image capturing camera 18 side. However, a communication unit may be provided in the refrigerator 1 side as was the case in the second embodiment so that the image capturing camera 18 side may communicate with the communication unit of the refrigerator 1 side. In such case, the communication unit provided in the refrigerator 1 side may be provided in the main control portion 30 of the refrigerator 1 or may be configured as a detachably attached component (an optional component) like the communication device 501 of the second embodiment illustrated in FIG. 25.

In the first embodiment, the refrigeration chamber 3 was given as an example of a storage chamber. Alternatively, images of other storage chambers such as the vegetable chamber 4 may be captured instead as was the case in the second embodiment.

In the first embodiment, the image capturing camera 18 is preinstalled in the refrigerator 1. Alternatively, the image capturing camera 18 may be configured to be detachably attached to the refrigerator 1. More specifically, the user may be allowed to attach the image capturing camera 18 after purchasing the refrigerator 1. That is, the image capturing camera 18 may be configured as detachably attached camera unit like the camera device 300 of the second embodiment.

The image capturing camera 18 and image capturing light 19 may be stored in one inside a unit case configured to be detachably attached to the refrigerator 1. The control portion 50 and the communication portion 52 may be provided integrally with the camera device. The lens heater 51 may also be provided integrally with the camera device along with the foregoing components. The control portion 50 and the communication portion 52 may be preinstalled to the refrigerator 1 and a separate communication unit for communicating with the control portion 50 and the communication portion 52, etc. may be provided in the camera device side. That is, any configuration may be employed to the camera device as long as it is at least provided with the image capturing camera 18.

The camera device and the refrigerator 1 may establish a wire communication or a wireless communication. Power may be supplied wirelessly to the camera device.

When the camera device is configured as detachably attachable device, a receiving portion may be provided on door pockets 8 to 10, the inner plate 14, the vertical partition 17, or the shelves, etc. of the refrigerator 1. A mounting portion to be mounted on the receiving portion may be provided on the camera device to allow the detachable attachment. More specifically, the mounting portion and the receiving portion may be engaged with one another. Alternatively, a clip may be provided on the camera device configured to clamp the door pockets which may come in different thicknesses (that is, a configuration in which the image capturing unit can be mounted on any location).

When employing a wireless method, a recess 600 may be provided on the inner plate 14 of the door of the refrigerator 1 for example as illustrated in FIGS. 29A-29B. The recess 600 serves as a marking indicating the location where the camera device 300 is to be mounted. A magnet 601 may be provided on the camera device 300 side for mounting purposes. This is because the doors such as the right-side door 3b contains an iron plate 602 made of metal and the camera device 300 may be attached to the doors by magnetic force. The recess 600 may be provided with a mounting structure other than the magnet (a holding structure or an engagement structure for example). Further, a detection magnet 603 like the magnet 206 of the second embodiment may be provided alternatively. A magnet may be provided on the door side and a metal portion may be provided on the camera device 300 side.

If it is possible to attach the camera device to any given location, markings may be provided to indicate locations where appropriate images of the fridge interior may be captured such as locations where the camera view is less likely to be blocked by shelves, door pockets, or the like. Markings may be provided even if the location where the camera device is to be mounted is predetermined to provide guidance to the user.

A dedicated spot for storing the camera device may be formed in the door pocket and the camera device may be stored in such spot.

A detecting unit such as an IC chip, etc. configured to detect the presence and absence of the camera device maybe provided in specific locations inside the refrigerator 1. The operation of the communication portion 52 for example may be permitted depending upon the presence/absence of the camera device. The specific locations include at least the interior of the refrigerator 1. An input may be made from the control panel 33 indicating that the camera device has been mounted.

An identifying unit may be provided in the refrigerator 1 for identifying the camera device. The operation of the camera device (including the operation of the communication device 52, etc.) may be permitted only when a specific camera device has been identified. As a result, it is possible to permit operation of only a reliable camera device (a camera device made by the manufacturer of the refrigerator or a compatible camera device). The preexisting in-fridge lighting may be used as a notifying unit for notifying the timing of image capturing to eliminate the need for additional components and thereby achieve cost reduction.

A detection unit may be provided in the camera device side for detecting whether or not the refrigerator 1 is eligible for operation of the camera device. A detection subject unit may be provided in the refrigerator 1 side which is configured to be detected by the detection unit. The detection unit and the detection subject unit may be implemented physically for example as connectors having mating shapes or for example as components exchanging identification information.

Alternatively, the refrigerator 1 may communicate with the camera device 300 for example to identify whether or not the camera device 300 is eligible for operation with the refrigerator 1. In such case, the communication device 501 of the refrigerator 1 serves as an identification unit and the communication module 306 serves as an identification subject unit which is identified by the refrigerator 1 for judging that the camera device 300 is eligible for operation with the refrigerator 1.

Further, the identification unit and the identification subject unit may also serve as the detection unit and the detection subject unit. That is, if the camera device 300 can be stored in the holding portion 202, the camera device 300 can be identified as to be eligible for use with the refrigerator 1. The polarity of the magnet 206 provided at the holding portion 202 may be detected by the camera device 300 and the result of detection may be notified to the refrigerator side 1 to judge whether the camera device 300 has been stored in the holding portion 202. Alternatively, the in-fridge lighting may be flickered by the refrigerator 1 side and the camera device 300 side may be configured to issue some kind of response, etc. to enable identification.

A pocket mounting portion for mounting a door pocket may be provided on the inner plate 14 of the refrigerator 1 so that door pocket 9b (the same is applicable to the door pocket 200 of the second embodiment) itself is detachably attached. That is, when the camera device is detachably attached, users who do not wish to use the camera device may increase storage capacity by attaching wide door pockets such as the door pocket 8, whereas users who wish to use the camera device may capture images of the fridge interior without the view of the camera device being blocked by attaching the door pocket 9b (or the door pocket 200) which is relatively narrower.

As illustrated in FIG. 3, a wide (i.e. substantially as wide as the width of the right-side door 3b) door pocket covering the spot where the image capturing camera 18 is mounted (or a door pocket shaped so as to make up for the notch 9b1 of the door pocket 9b) may be mounted on the pocket mounting portion. When the camera device is not in use, the mounting portion of the camera device may be covered by the door pocket so that the user is inhibited from inadvertently touching the mounting portion, etc.

The control of the timing of image capturing by the control portion 309 in the second embodiment may be carried out by judging image capturing conditions 1 to 4, etc. as was the case in the first embodiment by acquiring the opened/closed status of the door through communication with the refrigerator 1. In such case, both or either of the timing detection by the illuminance sensor 313 and image capturing conditions 1 to 4 may be employed. More specifically, image was not captured when the user has opened the door in the second embodiment. The moment when the in-fridge lighting has been continuously illuminated may be judged as the moment when the door has been opened and the moment when the in-fridge lighting has been thereafter turned off may be judged as the moment when the door has been closed. Image capturing condition 1 will be met by capturing the image of at the moment when the in-fridge lighting has been turned off. By using the communication module 306 to acquire the opened/closed status of the door through communication with the main-control portion 30 of the refrigerator 1, it is possible to employ image capturing conditions 1 to 4.

The removing unit for removing dew condensate may be provided to the camera device 300 of the second embodiment.

The predetermined time period mentioned in the second embodiment may be specified to a time period in which the dew condensate is removed based on temperature and humidity (or at least a time period equal to or greater than such time period). It goes without saying that a fixed time period such as 2 hours may be specified.

The camera device 300 of the second embodiment may be configured so as not to be provided with the image capturing lamp 302. For example, the refrigeration chamber 3 is provided with a ceiling light 13, etc. and thus, image capturing may be carried out using such in-fridge lighting. In such case, instructions to illuminate the in-fridge lighting may be transmitted to the refrigerator 1 side through the communication module, etc. Both the image capturing lamp 302 and the in-fridge lighting may be used during image capturing.

In the examples given in the above described embodiments, images of the fridge interior are captured. Images of closed spaces provided in the fridge interior (such as an egg container room which is closed or encapsulated by a cover or drawer configuration, a special purpose room 12 of the chiller chamber, and a low pressure preservation chamber placed in a sealed state) for example may be captured by forming a window in a portion of such closed space structure using a transparent material and capturing images of the interior of the closed space through the window.

Power may be supplied to the camera device 300 from the refrigerator 1 side by wired or wireless feed. As a result, it is possible to eliminate battery shortages and thereby improve usability. Because a continuous supply of power is given to the refrigerator 1, it will not affect the operation of the refrigerator 1 even if a power supplying circuit, etc. for supplying power to the camera device 300 is provided. By configuring the power supplying circuit to be detachably attached to the refrigerator 1 like the camera device 300, it is possible to inhibit unnecessary supply of power.

In the second embodiment, the magnets are disposed at holding portions provided in two different locations so that polarity of one side of the magnet facing the camera device 300 differs between the two magnets. However, the magnets may be disposed so that relative positioning with respect to the detecting portion 307 differ. In such case, the output of the detection sensor will increase if disposed closer to the magnet, whereas the output will decrease if disposed farther from the magnet (however, the positive and negative nature of the magnetic field will not change). It is thus, possible to provide three or more holding portions.

The temperature sensor 310, the magnetic sensor 311, the acceleration sensor 312, and the illuminance sensor 313 may be provided as required and thus, some may be absent. For example, if the orientation of the camera is detected by the magnetic sensor 311, the acceleration sensor 312 is not necessarily required.

### Third Embodiment

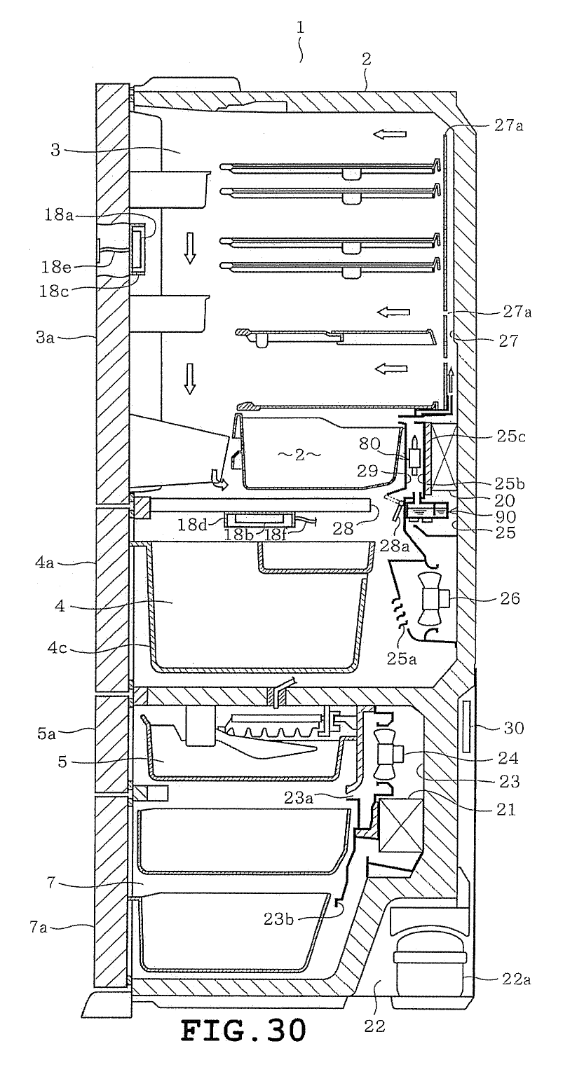

Next, a description will be given on a third embodiment with references FIGS. 30 to 37.

There has been a configuration of supplying mist into the refrigerator for providing moisture into the fridge interior. A refrigerator employing such configuration is provided with a mist generator configured to generate and supply mist. The mist generator generates mist by applying ultrasonic waves to stored water, discharges mist by electrostatic atomization. In a refrigerator provided with both an image capturing unit for capturing an image of the fridge interior and a mist generator, the image capturing unit may be inhibited from operating properly by failing to capture clear images by the mist fed from the mist generator or the high voltage, etc. produced at the mist generator.

It is thus, one object of the present embodiment to prevent the proper operation of the image capturing unit from being inhibited by the mist generator in a refrigerator provided with both the image capturing unit for capturing an image of the fridge interior and the mist generator.

Means for overcoming the problems of the present embodiment will be described hereinafter. The refrigerator of the present embodiment is provided with an image capturing unit configured to capture an image of the fridge interior, a mist generator configured to spray mist, a spray port for feeding the mist sprayed by the mist generator into the fridge interior. The image capturing unit is provided in a location which does not confront the spray port.

In the present embodiment, the refrigerator 1 is provided with a refrigerating cooler 20 and a freezing cooler 21 as illustrated in FIG. 30. The refrigerating cooler 20 produces cool air for cooling the refrigeration chamber 3 and the vegetable chamber 4. The freezing cooler 21 produces cool air for cooling the ice maker chamber 5, an upper freezer chamber, and a lower freezer chamber 7 not illustrated. A machine chamber 22 is provided in the rear surface side of the bottom end portion of the refrigerator 1. The machine chamber 22 is provided with a compressor 22a, the main-control portion 30, etc. that serve as a refrigeration cycle.

The refrigerator 1 is provided with a freezing cooler chamber 23 and a freezer blower fan 24. The freezing cooler chamber 23 is provided behind the lower freezer chamber 7 located inside the refrigerator 1. The freezing cooler chamber 23 is provided with cool air outlets 23a and a return port 23b. The cool air outlets 23a are provided on the front surface of the freezing cooler chamber 23. The return port 23b is provided in the lower portion at the lower portion of freezer cooler chamber 23. The freezing cooler 21 and the freezing blower fan 24 are provided in the freezing cooler chamber 23. The freezing blower fan 24, configured to feed air, feeds cool air produced by the freezing cooler 21 into the ice maker chamber 5, the upper freezer chamber, and the lower freezer chamber 7 and circulates the cool air back into the freezing cooler chamber 23 from the cool air outlet 23a.

The refrigerator 1 is provided with a refrigerating cooler chamber 25 and a refrigerating blower fan 26. The refrigerating cooler chamber 25 is provided behind the refrigeration chamber 3 and the vegetable chamber 4. The refrigerating cooler chamber 25 is provided with a return port 25a. The return port 25a is provided at the lower front surface of the refrigerating cooler chamber 25. The refrigerating blower fan 26 is provided in the refrigerating cooler chamber 25.

The refrigerator 1 is provided with a cool-air feed duct 27. The cool air feed duct 27 extends upward from the upper portion of the refrigerating cooler chamber 25. The cool-air feed duct 27 is provided with multiple cool air feed ports 27a. The cool-air feed ports 27a are disposed ate the front portion of the cool-air feed duct 27 and are opened toward the refrigeration chamber 3. The front wall 25b of the refrigerating cooler chamber 25 projects forward relative to the cool-air feed duct 27. The refrigerating cooler chamber 25 is provided with a thermal insulation material 25c. The thermal insulation material 25 is provided on the backside of the front wall 25b. The refrigeration chamber 3 and the vegetable chamber 4 communicate through a connection port 28. The connection port 28 is provided in the rear side of the lower portion of refrigeration chamber 3.

The refrigerating blower fan 26, configured to feed air, feeds cool air produced by the refrigerating cooler 20 including into the refrigeration chamber 3 a special purpose chamber 12 from the cool-air feed portion 27a by way of the cool-air feed duct 27 as indicated by the white arrow of FIG. 30. The cool air is thereafter fed to the vegetable chamber 4 through the connection port 28 and sucked into the refrigerating cooler chamber 25 through the return port 25a. Thus, the cool air produced by the refrigerating cooler 20 is circulated through the refrigeration chamber 3 and vegetable chamber 4.

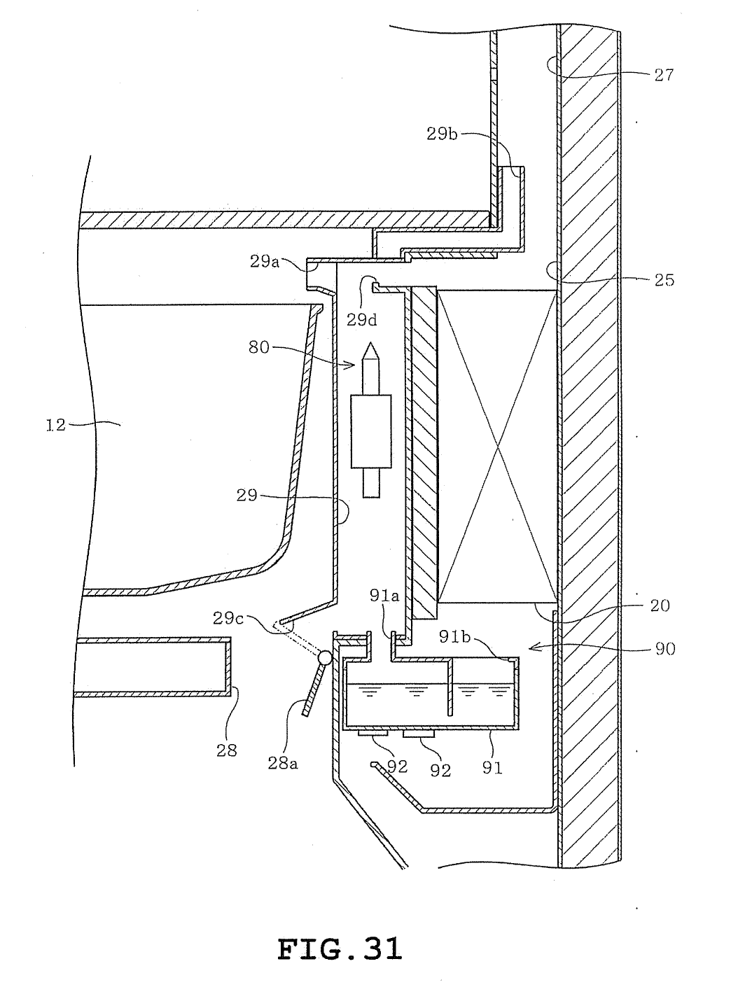

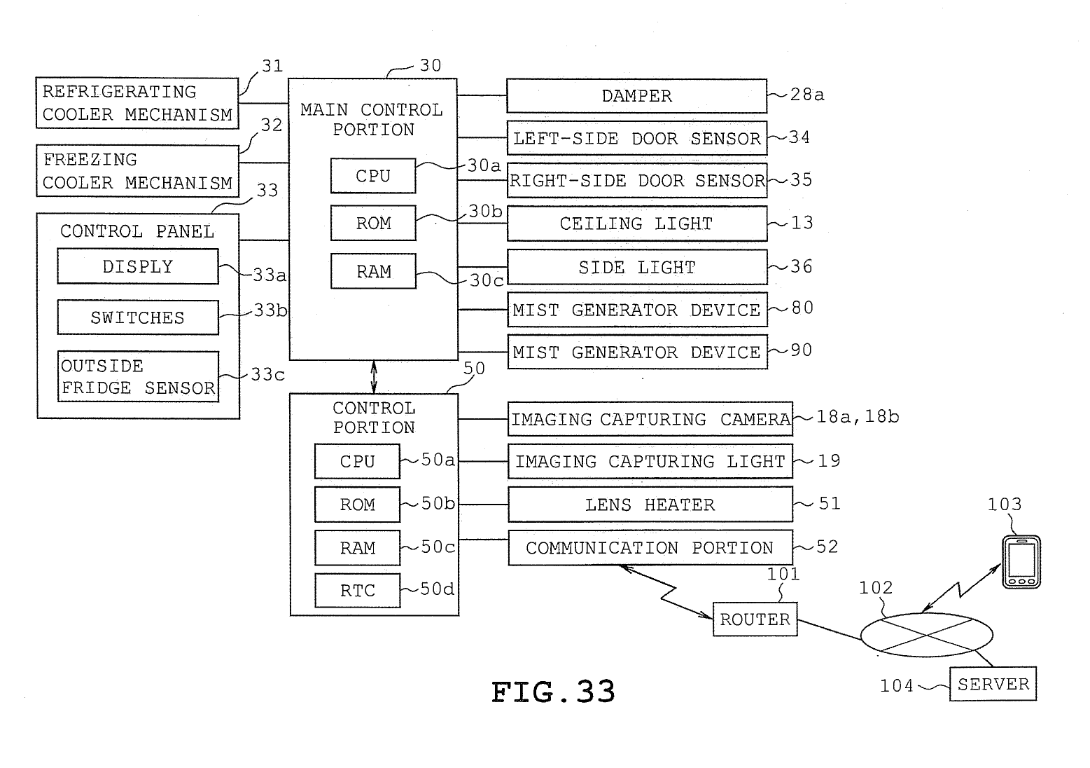

As illustrated in FIG. 31, the refrigerator 1 is provided with a mist generator 80 and a humidifier device 90. The mist generator device 80 and the humidifier device 90 serve as a mist generator for generating mist to be fed into the chambers of the refrigerator. The humidifier device 90 also serves as a water feeder for feeding water for generating mist to the mist generator device 80 (electrostatic atomizer). The mist generator device 80 and the humidifier device 90 are connected to the main-control portion 30 as illustrated in FIG. 33.

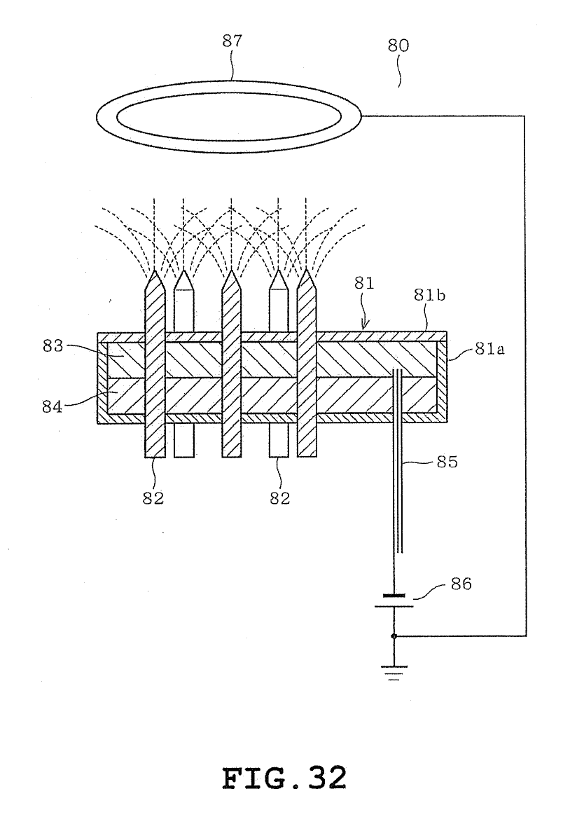

The mist generator device 80 is provided with a case 81, multiple discharge electrode members 82, a holding member 83, an electrically conductive member 84, an electrically conductive rod 85, a high-voltage power supply 86, and a counter electrode 87 as illustrated in FIG. 32. The case 81 is formed of an electrically insulative resin material for example and is configured by a body 81a and a lid 81b. The case 81a is bottomed and thus, shaped like a box. The lid 81b covers the opening of the body 81a.

The discharge electrode member 82 is formed of a porous material exhibiting moisture absorbing and moisture retaining properties and is formed like a pin having sharp pointed tip. In this example, the tip of the discharge electrode formed of a monolithic member serves as a mist discharging portion. The portion of discharge electrode member 82 excluding the tip portion serves as a water feed portion. That is, the discharge electrode member 82 is wholly made of the same material. The mist discharging portion in the tip side of the discharge electrode member 82 and the water feed portion in the base end side of the discharge electrode are formed monolithically without any seams. The tip portion of the discharge electrode member 82, that is, the mist discharge portion is exposed to the exterior of the case 81. The base-end portion discharge electrode member 82, that is, the end portion of the water feed portion located in the opposite side of the mist discharge portion is exposed to the exterior of the case 81. The porous material forming the discharge electrode member 82 may be made of a felt material, etc. such as polyester fiber.

The discharge electrode member 82 is formed of a porous material having moisture absorbing and moisture retaining properties being impregnated with a material exhibiting spontaneous moisture absorbing properties that absorbs moisture from air. As a result, the discharge electrode material 82 exerts spontaneous moisture absorbing properties of spontaneously absorbing moisture in the air when the temperature of the ambient becomes equal to or greater than a predetermined value. Examples of materials having such spontaneous water absorbing properties may be deliquescent materials that spontaneously absorb moisture in the air without supply of energy from the outside and dissolving into the absorbed moisture. In the present embodiment, the discharge electrode material 82 is impregnated with poly potassium phosphate being a macromolecular phosphate serving as one example of such deliquescent materials. As a result, the discharge electrode member 82 as a whole including the mist discharge portion and the water feed portion exhibits spontaneous moisture absorbing properties that absorbs moisture from the air.

The discharge electrode member 82 being impregnated with poly potassium phosphate as the deliquescent material starts to absorb moisture from the surrounding air when the temperature of the ambient reaches 5 degrees Celsius and humidity exceeds 40% for example. It is possible to stably sustain moisture absorption of the discharge electrode member 82 by maintaining the humidity of the ambient to 40 to 50%. It is possible to control the conditions in which moisture absorption begins in the discharge electrode member 82 through adjustment of temperature and humidity of the surrounding ambient depending upon the properties of the materials used in impregnating the discharge electrode material 82 and also stabilize moisture absorbing action of the discharge electrode member 82.

The holding member 83 is provided inside the case 81. The holding portion 83 is formed of an insulating material. Examples of insulating materials forming the holding member 83 include resin materials such as a polypropylene. The electrically conductive member 84 is provided inside the case 81. The electrically conductive material 84 contains electrically conductive materials such as carbon. The discharge electrode member 82 extends through the holding member 83 and the electrically conductive member 84 and is secured by the holding member 83 and the electrically conductive member 84.

The electrically conductive rod 85 is inserted into the electrically conductive material 84 from the exterior of the case 81. The base end portion of the electrically conductive rod 85 is connected to the negative pole of the high-voltage power supply 86 of a power supply circuit. Thus, a negative high voltage from the high voltage power supply 86 is applied to the discharge electrode member 82 through the electrically conductive rod 85 and the electrically conductive material 84 to negatively charge the discharge electrode member 82.

The counter electrode 87 is disposed outside the case 81

so as to confront the tip portion of the discharge electrode member 84, that is, the mist discharge portion. The counter electrode 87 is connected to the positive pole of the high voltage power supply 86. The counter electrode 87 being circularly annular in this example is made of an electrically conductive material such as metal. The shape of the counter electrode 87 may be elliptically annular or polygonally annular for example instead of the circularly annular shape. The counter electrode 87 need not be annular but may be shaped like a plate or a sphere.

The discharge electrode member 82 of the mist generator device 80 spontaneously absorbs moisture in the air without requiring external supply of energy. The moisture absorbed by the discharge electrode member 82 thereafter permeates into the discharge electrode member 82 and is supplied to the mist discharge portion located at the tip portion thereof. High voltage is applied to the discharge electrode member 82 from the high voltage power supply 66 by way of the electrically conductive rod 85 and the electrically conductive member 84. As a result, charge concentrates at the tip portion of the discharge electrode member 82, that is, at the mist discharge portion and is given energy surpassing the surface tension of water contained in the mist discharge portion. As a result, water contained in the mist discharge portion of the discharge electrode member 82 is discharged as mist through Rayleigh breakup, in other words, electrostatically atomized.

The water particles discharged as mist from the tip portion of the discharge electrode member 82 is negatively charged. The high voltage power supply 86 serves as a high voltage generator unit configured to generate high voltage for charging mist.

As illustrated in FIG. 31, the refrigerator 1 is provided with humidifying duct 29. The humidifying duct 29 is provided in the special purpose chamber 12 which belongs in a different compartment from the refrigeration chamber 3 and the vegetable chamber 4. That is, the humidifying duct 29 is provided behind the special purpose chamber 12 and in front of the refrigerating cooler chamber 25. The mist generator device 80 is provided in the humidifying duct 29. The ultrasonic humidifier device 90 is provided below the humidifying duct 29. The ultrasonic humidifier device 90 is provided with a water reservoir 91 and an ultrasonic oscillator 92. The water reservoir 91 is shaped like a rectangular container.

The water reservoir 91 is provided with a humidifying port 91a and an opening 91b. The humidifier port 91a is provided on the upper surface of the water reservoir 91 and communicates the interior of the water reservoir 91 with the humidifying duct 29. The opening 91b is located below the refrigerating cooler 20. The defrost water produced as the result of defrosting of the refrigerating cooler 20 drips from the refrigerating cooler 20 and is stored in the water reservoir 91 through the opening 91b.

The ultrasonic oscillator 92 is disposed on the undersurface of the water reservoir 91 so as to be located below the humidifying port 91a. When the ultrasonic oscillator 92 is oscillated, the water inside the water reservoir 91 is atomized and discharged as mist into the humidifying duct 29 from the humidifying port 91a. When the ultrasonic humidifier device 90 is provided with multiple ultrasonic oscillators 92, the oscillation frequencies of the ultrasonic oscillators 92 may be specified to different values. For example, the oscillation frequency of one of the ultrasonic oscillators 92 may be specified to a frequency being suitable for producing hydrogen peroxide water from water, whereas the oscillation frequency of the other of the ultrasonic oscillators 92 may be specified to a frequency being suitable for atomizing water. Ultrasonic oscillation occurring at a predetermined frequency causes cavitation in water and charges the mist. The voltage applied to the ultrasonic generator element serves as a high voltage generator.

The humidifying duct 29 is provided with a first spray port 29a, a second spray port 29b, and a third spray port 29c. The first spray port 29a, the second spray port 29b, and the third spray port 29c are spray ports for feeding the mist generated by the mist generator device 80 and the ultrasonic humidifier device 90 into the chamber interior. The first spray port 29a, the second spray port 29b, and the third spray port 29c are each opened toward compartments different from the refrigeration chamber 3 and the vegetable chamber 4.

For example, the first spray port 29a is provided in the upper front side of the humidifying duct 29 and communicates with the special purpose chamber 12 which belongs to a different compartment from the refrigeration chamber 3 and the vegetable chamber 4. The second spray port 29b is provided so as to extend rearward from the upper portion of the humidifying duct 29 and communicates with the cool-air feed duct 27 which belongs to a different compartment from the refrigeration chamber 3 and the vegetable chamber 4. The third spray port 29c is provided on a lower front surface of the humidifying duct 29 and communicates with the special purpose chamber 12 belonging to a different compartment from the refrigeration chamber 3 and the vegetable chamber 4. The refrigerator 1 is further provided with a damper 28a. The damper 28a is connected to the main-control portion 30 as illustrated in FIG. 33. The damper 28a is configured to open and close the third spray port 29c by being controlled by the main-control portion 30.

The humidifying duct 29 is provided with a communication opening 29d. The communication opening 29d is provided in the upper rear side of the cool-air feed duct 27 and communicates the portion of the cool-air feed duct 27 located immediately above the refrigerating cooler 20 with the humidifying duct 29. Some of the mist generated by the mist generator device 80 or the ultrasonic humidifier device 90 is fed into the special purpose chamber 12 along with the cool air produced by the refrigerating cooler 20 through the first spray port 29a. Some of the mist generated by the mist generator device 80 or the ultrasonic humidifier device 90 is fed to the cool-air feed duct 27 through the second spray port 29b and thereafter fed into the refrigeration chamber 3 along with the cool air produced by the refrigerating cooler 20 through the cool-air outlet 23a. Some of the mist generated by the mist generator device 80 or the ultrasonic humidifier device 90 is fed into the vegetable chamber 4 from the third spray port 29c through the connection port 28.

As illustrated in FIG. 30, the refrigerator 1 is provided with multiple image capturing cameras for example serving as an image capturing unit for capturing an image of the fridge interior. In this example, an image capturing camera 18a of the refrigeration chamber side and an image capturing camera 18b in the vegetable chamber side are provided. The image capturing camera 18a in the refrigeration chamber side is provided for example at the right-side door 3b of the refrigeration chamber 3 and captures an image inside the refrigeration chamber 3. The image capturing camera 18b in the vegetable chamber side is provided on the surface of the ceiling of the vegetable chamber 4 and captures an image inside the vegetable chamber 4.

Both the image capturing camera 18a of the refrigeration chamber side and the image capturing camera 18b of the vegetable chamber side are provided at locations that do not confront either of the first spray port 29a, the second spray port 29b, and the third spray port 29c. Each of the image capturing cameras 18a and 18b and the spray ports 29a, 29b, and 29c are provided in different compartments. For example, the image capturing camera 18a is disposed airflow upstream of the spray port 29a being configured to feed the mist into the special purpose chamber 12.

The mist being discharged from a location that does not confront the image capturing camera 18a is circulated so as to moisturize the chamber interior without being sprayed directly onto the camera surface.

The structures of the image capturing cameras 18a and 18b are substantially identical to those of the first embodiment. The image capturing camera 18 may be mounted on the receiving portion (described as the holding portion 202 of the door pocket 200 or the holding portion 401 of the refrigerator holder 400, etc. in the embodiments) configured to allow the mounting of the image capturing camera 18 or on the storing portion of the cavity 600 which is one example of a recess provided on the wall of the door, etc. illustrated in FIGS. 29A-29B. The camera may be stored entirely within the recess 600, in which case, a coating cover may be provided over the recess 600. The cover may be fully transparent, or may have a hole provided on a portion facing the lens, or only the portion facing the lens may be transparent. A transparent protection cover covering the lens may be provided in front of the lens of the camera device. When using the camera device 300 illustrated in FIG. 16, a transparent film may be provided forward relative to the lens 301 to serve as the protection cover. The coating cover as well as the protection cover are hereinafter referred to as a cover, etc. (cover unit). Further, the lens and the cover, etc. taken together may be referred to as lens, etc.

Some portions of the lens, the coating cover, and the protection cover (lens, etc.) are exposed to the environment of the interior of the storage chambers.

The image capturing camera is disposed in a special environment inside the storage chambers of the refrigerator which requires supply of moisture for preserving the freshness of vegetables, etc. When images of such environment are captured using the image capturing camera in which the lens and the cover, etc. are exposed to such environment, it was not possible to capture clear images and thus, not possible for the image capturing camera to operate properly depending upon the state of the lens and the cover or depending upon the environment of the interior of the storage chambers.

Examples of the specific problems encountered include the surfaces of the lens and the cover, etc. being susceptible to develop dew condensate by the supplied mist in which case the lens and the cover, etc. become fogged to prevent capturing of clear images. Further, generation of mist causes the interior of the storage chamber to be filled with the mist and thereby fogged to prevent capturing of clear images with the camera.

Further, when the mist is discharged by applying high voltages, the mist may become charged and produce noise when the charged mist contacts the camera in which case it may not be possible to capture good images.

Thus, attempts are made to overcome such specific problems originating from the provision of the camera to the refrigerator which include adjustment in the location of the mist generator unit and the environment of capturing images of the storage chamber interior so that mist does not contact the camera as much as possible and enabling good image capturing even when the mist does contact the camera.

Direct contact between the mist and the camera is avoided by placing the camera at a location that does not confront the outlet of the mist.

Exterior cases 18c and 18d that serve as the outer shells of the cameras 18a and 18b are formed of an electrically conductive material such as electrically conductive resin or metal material. That is, the image capturing cameras 18a and 18b are installed in the exterior cases 18c and 18d serving as storage containers made of an electrically conductive material. The exterior case 18c of the image capturing camera 18a is grounded to an exterior plate of the right-side door 3b through an earth line 18e, whereas the exterior case 18d of the image capturing camera 18b is grounded to the outer plate of the right-side door 3b and the exterior housing of the refrigerator 1. The outer plate of the right-side door 3b and the exterior housing of the refrigerator 1 are formed of an electrically conductive metal. Thus, it is possible to prevent image capturing cameras 18a and 18b from being charged by the charged mist sprayed from the mist generator device 80.

The main-control portion 30 is configured to drive the mist generator device 80 as well as the humidifier device 90 intermittently and is further configured to drive the image capturing cameras 18a and 18b intermittently to capture images of the fridge interior. The main-control portion 30 controls the drive of the mist generator device 80 and the humidifier device 90 in synchronism with the image capturing performed by the image capturing cameras 18a and 18b. Synchronizing the drive of the mist generator device 80 and the humidifier device 90 with the image capturing performed by the image capturing cameras 18a and 18b denotes that an adjustment is made in the timing in which the mist generator device 80 and the humidifier device 90 are driven and the timing in which the images are captured by the image capturing cameras 18a and 18b by the main-control portion. In this example, the main-control portion 30 makes an adjustment so that the driving of the mist generator device 80 and the humidifier device 90 and the image capturing by the image capturing cameras 18a and 18b are not performed at the same time.

The interval of image capturing by the image capturing cameras 18a and 18b is relatively long. For example, the main-control portion 30 drives the image capturing cameras 18a and 18b several times a day to capture images of the fridge interior. On the other hand, the interval of mist feeding by the mist generator device 80 and the humidifier device 90 is relatively short. For example, mist is fed to the chamber interior by driving the mist generator device 80 and the humidifier device 90 several times an hour.

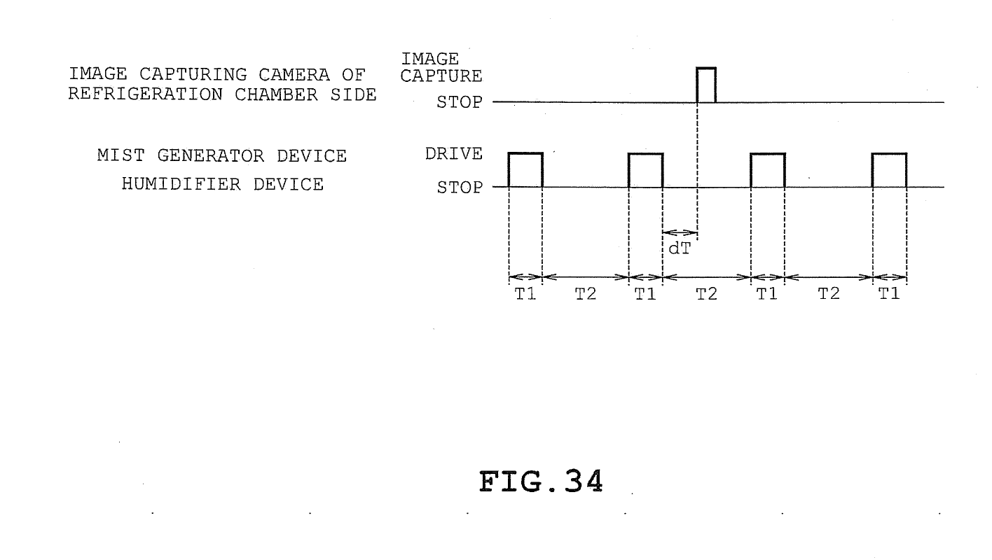

More specifically, the main-control portion 30 generates mist intermittently from the mist generator device 80. That is, the main-control portion 30 drives the mist generator device 80 and the humidifier device 90 during period T1 as illustrated in FIG. 34 to feed mist into the chamber interior. Then, feeding of mist is stopped during period T2 to standby whereafter the mist generator device 80 and the humidifier device 90 are driven again during period T1 to feed mist into the chamber interior. That is, the main-control portion 30 is basically configured to repeat period T1 in which the mist generator device 80 and the humidifier device 90 are driven and period T2 in which the mist generator device 80 and the humidifier device 90 are stopped.

The main-control portion 30 is configured to capture an image of the interior of the refrigeration chamber 3 by the image capturing camera 18a of the refrigeration chamber side during period T2 when the mist generator device 80 and the humidifier device 90 are stopped. That is, the main-control portion 30 is configured to capture an image of the interior of the refrigeration chamber 3 by the image capturing camera 18a of the refrigeration chamber side during a period which does not overlap with the period in which the mist generator device 80 and the humidifier device 90 are driven. The main-control portion 30 captures an image of the interior of the refrigeration chamber 3 by the image capturing camera 18a of the refrigeration chamber side during period T2 in which the mist generator device 80 and the humidifier device 90 are stopped after a predetermined period dT has elapsed after the mist generator device 80 and the humidifier device 90 have been stopped.

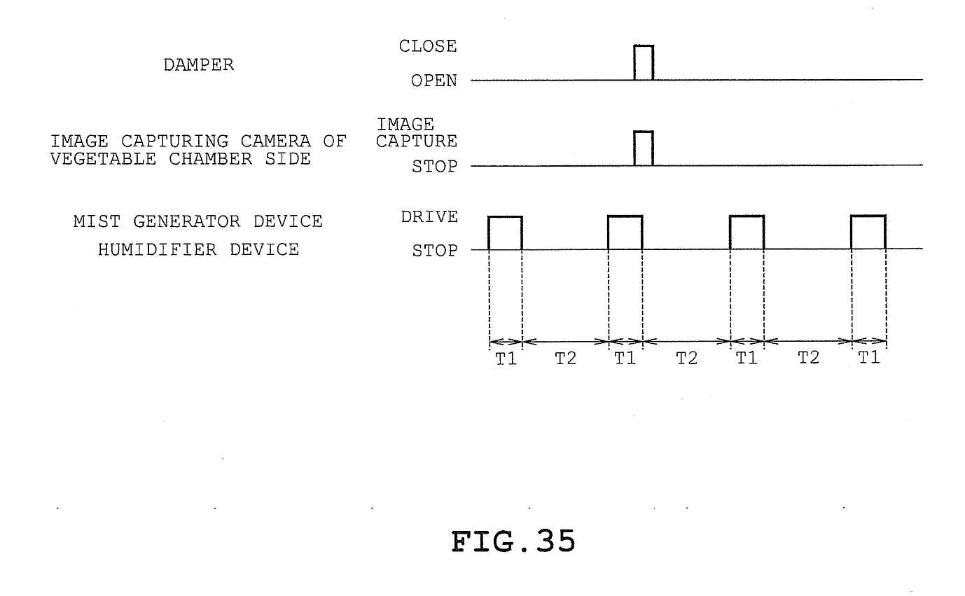

As illustrated in FIGS. 31 and 35, the main-control portion 30 is further configured to close the third spray port 29c by driving damper 28a when performing image capturing using the image capturing camera 18b of the vegetable chamber side. Thus, mist is prevented from being fed into the vegetable chamber 4 side from the third spray port 29c while an image of the vegetable chamber 4 is being captured by the image capturing camera 18b of the vegetable chamber side. The main-control portion 30 opens the third spray port 29c by driving the damper 28a again when completing the image capturing by the image capturing camera 18b of the vegetable chamber side. Feeding of mist into the vegetable chamber 4 through third spray port 29c is thus, enabled.

In the present embodiment, the image capturing camera 18a of the refrigeration chamber 3 and the image capturing camera 18b of the vegetable chamber 4 are provided at locations that do not confront either of the first spray port 29a, the second spray port 29b, and the third spray port 29c. It is thus, possible to reduce the possibility of attachment of mist to the image capturing cameras 18a and 18b since the mist sprayed from the spray ports 29a, 29b, and 29c are not sprayed directly toward the cameras. It is thus, possible to suppress development of dew condensate on the lenses of the cameras and on the covers, etc to allow capturing of clear images. Is further possible to eliminate instances where clear images of the chamber interior cannot be captured by the presence of a fog in front of the camera developed by the mist of fine water particles sprayed from the feed outlets.

Further, the coating cover, etc. described above is sometimes also used as a cover for the in-fridge lighting. Thus, projection and retractions are often formed on the lighting cover in order to diffuse light. Water accumulates on the projections and retractions when placed in direct contact with the mist. This causes water to accumulate on the portions confronting the cameras to possibly prevent capturing of clear images. Such risks can be eliminated by not allowing the feed outlets to confront the cameras.

It is further possible to resolve the problems originating from dew condensate and thick fog by circulating the mist through the cool air duct since the concentration of the mist can be reduced.

It further possible to reduce the possibility of charged mist produced by the high voltage generator from being attached to the image capturing cameras 18a and 18b. As a result, proper operation of the image capturing cameras 18a and 18b are not easily inhibited by the mist generator device 80.

The image capturing cameras 18a and 18b and the spray ports 29a, 29b, and 29c are provided in different compartments. This also resolves the problem of clear image capturing being inhibited by dew condensate and foggy haze and reduces the possibility of the mist sprayed from the spray ports 29a, 29b, and 29c from being attached to the image capturing cameras 18a and 18b becoming charged. It is thus, possible to reduce the influence of the charged mist attached to the image capturing cameras 18a and 18b. As a result, it is possible to suppress malfunctioning of the image capturing cameras 18a and 18b by the mist generator device 80.

The main-control portion 30 is configured to drive the mist generator device 80 as well as the humidifier device 90 intermittently and is further configured to drive the image capturing cameras 18a and 18b intermittently in capturing images of the fridge interior. By controlling the amount of mist in order to prepare a suitable environment for image capturing, it is possible to make adjustments in the amount of dew condensate and fog and consequently reduce their influence on the quality of image capturing while also allowing the negative impact on the image capturing cameras 18a and 18b caused by consecutive generation of high voltage by the mist generator device 80 to be reduced.

The main-control portion 30 executes a control to synchronize the drive of the mist generator device 80 and the humidifier device 90 with the image capturing performed by the image capturing cameras 18a and 18b. That is, the main-control portion 30 synchronizes the timing in which the mist generator device 80 and the humidifier device 90 are driven with the timing in which image capturing is performed by the image capturing cameras 18a and 18b so that they do not occur at the same time. For example, the main-control portion 30 stops the mist generator device 80 and the humidifier device 90 while image capturing by the image capturing cameras 18a and 18b is ongoing so that mist is not fed from the spray ports 29a, 29b, and 29c. Since images are not captured especially at the moment when a foggy mist is generated, it is possible to prepare a suitable environment for capturing an image of the interior of the storage chamber and facilitate image capturing. Thus, mist generated by the mist generator device 80 and the humidifier device 90 is prevented from being attached to the image capturing cameras 18a and 18b while image capturing by the image capturing cameras 18a and 18b are ongoing. As result, it is possible to prevent development of dew condensate and water droplets covering the camera lens and the covers, etc. by increased moisture while image capturing is ongoing. It is further possible to reduce the influence of noise caused by attachment of mist charged to high voltages on the image capturing cameras 18a and 18b while image capturing by the image capturing cameras 18a and 18b is ongoing.

The main-control portion 30 closes the third spray port 29c by driving the damper 28a while image capturing by the image capturing camera 18b in the vegetable chamber side is ongoing so that mist is not fed into the vegetable chamber 4 from the third spray port 29c. Similar effect can be achieved by this arrangement as well.

The image capturing cameras 18a and 18b installed in the exterior cases 18c and 18d formed of an electrically conductive material. The exterior cases 18c and 18d are further grounded to the exterior housing, etc. of the body 2 by earth lines 18e and 18f. As a result, it is possible to neutralize the charged mist even when the mist charged to high voltages is attached to the image capturing cameras 18a and 18b. It is thus, possible to reduce the influence of charged mist.

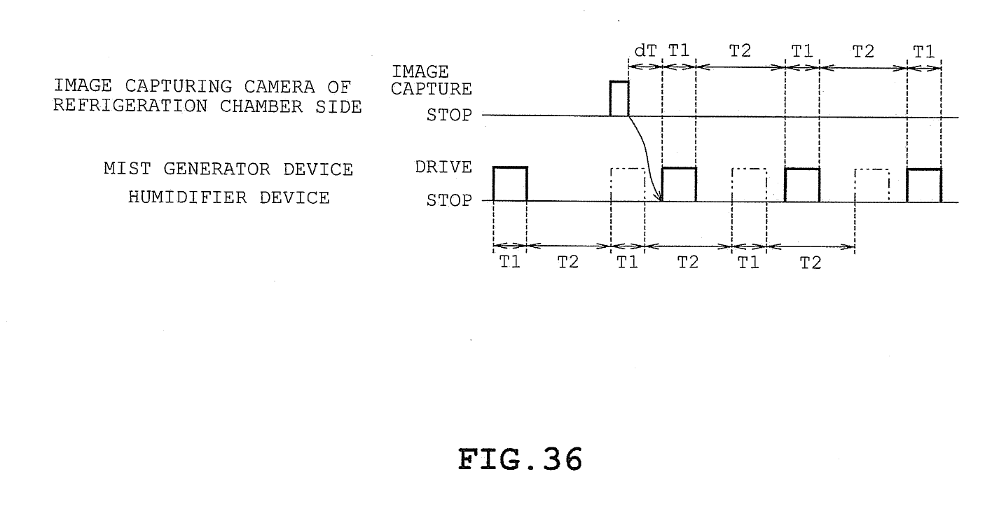

The following controls may be executed when the main-control portion 30 is configured to drive the image capturing camera 18a in the refrigeration chamber side based on signals provided from external components. For example, when receiving a signal triggering the execution of image capturing by the image capturing camera 18a of the refrigeration chamber side from an external component at a timing overlapping with the timing in which the mist generator device 80 and the humidifier device 90 are to be driven as illustrated in FIG. 36, the main-control portion 30 is configured to prioritize the execution of image capturing by the image capturing camera 18a of the refrigeration chamber side and delays the driving of the mist generator device 80 and the humidifier device 90. In such case, the main-control portion 30

drives the mist generator device 80 and the humidifier device 90 after a predetermined time dT has elapsed after image capturing has been executed by the image capturing camera 18a of the refrigeration chamber side. The above described arrangement also achieves the operation and effect similar to those of the third embodiment described above.

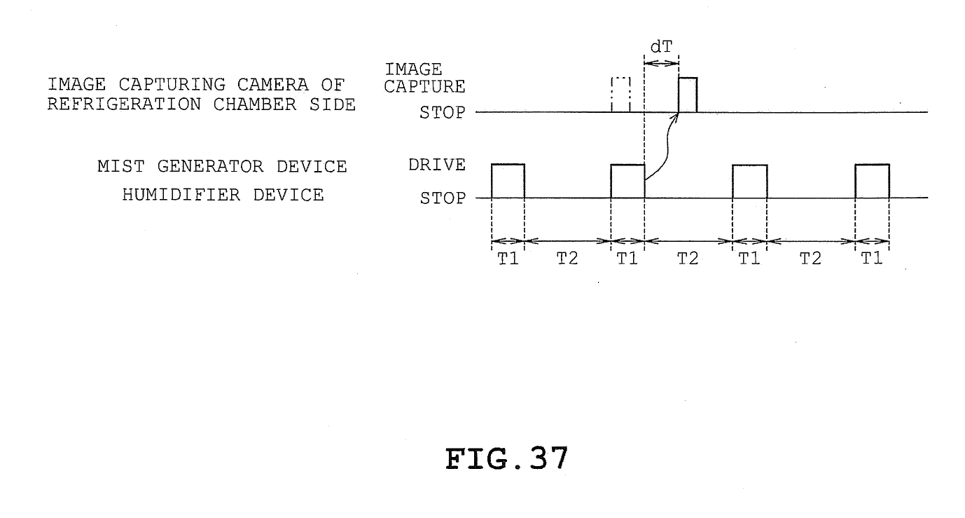

The following controls may be executed when the main-control portion 30 is configured to drive the image capturing camera 18a in the refrigeration chamber side based on signals provided from external components. For example, when receiving a signal triggering the execution of image capturing by the image capturing camera 18a of the refrigeration chamber side from an external component at a timing overlapping with the timing in which the mist generator device 80 and the humidifier device 90 are to be driven as illustrated in FIG. 37, the main-control portion 30 is configured to prioritize the driving of the mist generator device 80 and the humidifier device 90 and delays the execution of image capturing by the image capturing camera 18a of the refrigeration chamber side. In such case, the main-control portion 30 executes image capturing by the image capturing camera 18a of the refrigeration chamber side after a predetermined time dT has elapsed after driving the mist generator device 80 and the humidifier device 90. The above described arrangement also achieves the operation and effect similar to those of the third embodiment described above.

Mist is not discharged directly into the storage chambers since the mist generator unit is provided in the duct 29. It is thus, possible to reduce the concentration of the mist inside the storage chamber and prepare an environment that facilitates execution of image capturing. Further, multiple outlets are provided at the duct 29. It is thus, possible to reduce the concentration of the mist by discharging the mist through different outlets. A cover providing a cover over the mist generator unit will suffice as the duct 29.

The outlets are disposed so as not to be located in front of the camera. The outlets may be disposed so as to be displaced in the left and right direction or the up and down direction with respect to a forward projection of the camera projected on the wall located in the front side of the camera. The outlet is preferably not disposed on the wall on which the camera is installed and not on the wall located in front of the camera, but on the wall located adjacent to the wall on which the camera is installed. In this example, the camera is installed on the wall of the door. Thus, the outlet of the mist generator device is preferably not provided on the rear wall located in the front side of the camera but on the left and right sidewalls or the up and down sidewalls located adjacent to the door. As a result, it is difficult for the mist sprayed from the outlet to contact the camera.

Even when the outlet is disposed on the wall located adjacent to the door, it is further preferable to dispose the outlet at a location in which the mist does not travel across the line of extension of the direction in which the camera is oriented. For example, when the mist exists in the direction of image capturing by the camera, the camera will be able to capture an image of a location in front of the mist but not of a location behind the mist.

It is thus, preferable to dispose the outlet so that the region located on the line of extension of the direction in which the camera is oriented does not cross over or overlap with the region located on the line of extension of the direction in which the outlet is oriented so as to be disposed in the left and right or the up and down direction even when the outlet of the mist is disposed on the wall that is different from the wall on which the camera is disposed. As a result, it is possible to reduce the possibility of the image captured by the camera to be poor in visibility by the mist being captured into the image and allow capturing of an image which is clearly visible to the far side of the chamber interior.

The line of extension of the center of the camera lens or the orientation of the CMOS sensor preferably does not overlap with the region located on the extension of the direction in which the outlet of the mist is oriented.

It is further preferable for the region of the opening of the mist outlet projected in the up and down direction to not overlap with the region existing on the line of extension of the direction in which the camera is oriented. In FIGS. 30 and 31 for example, mist is discharged from the opening of the mist outlet 29a. The mist is prone to spread in the upward direction because of its light weight or in the downward direction by gravity. For example, when the mist rises upward and the uprising mist overlaps with the projected surface of the image capturing camera 18a as viewed from the front side of the door, the location behind the upward and downward projection of the opening will not be visible by the mist. Thus, the mist outlet 29a is preferably disposed so that the region obtained by projecting the opening of the mist outlet 29a, taken along the lateral lengthwise direction, in the up and down direction does not overlap with, and therefore avoids, the range of projected surface of the image capturing camera 18a as viewed from the front side of the door. It thus, possible to capture clear images.

It is further preferable for the feed port 27a of the duct 27 for circulating cool air to be disposed in a location which does not confront the camera. It is thus, possible to reduce possibility of even a small amount of mist from contacting the camera.

The mist generator unit may be an ion generator device configured to generate charged mist of H+(H20)m being a positive ion and O2-(H2O)n being a negative ion (m, n are positive integers) for example.

Further, when the door is closed after once being opened, dew condensate may develop on the camera lens and the cover, etc. Thus, a means for drying the lens, etc. may be provided in which dew condensate is blown away by turning ON the fan 26 serving as a dew condensate removing unit when closing of the door has been detected. In such case, another fan in addition to the blower fan 26 may be provided in the duct 27. The two fans may be driven at the same time and execute a control to increase the amount of airflow or increase the total count of rotations of the two fans and thereby allow dew condensate to be removed more effectively as compared to a configuration in which only a single fan is provided.

The fan 26, etc. may be driven in rotation while image capturing is ongoing. As a result, a foggy mist blocking the view of the image capturing unit can be blown away to provide a clean view and thereby enabling capturing of clear images. Two fans may be driven at the same time in such case as well.

The fan provided at the duct 27 will work more effectively when provided near the ceiling located above the duct 27. When the camera is mounted on the door for example, the cool air discharged from the upper portion of the duct 27 will be urged forward by the fan to hit the upper portion of the door. Because the cool air hitting off the upper portion of the door flows downward, it is possible to create an airflow capable of blowing off the dew condensate developed on the camera. As a result, it is possible to resolve the fogging of the lens and cover, etc. to allow capturing of clear images.

By operating the mist generator unit intermittently and rotating the fan while the mist generator unit is turned OFF, a cool dry air is generated through the evaporator of the cooler. It is possible to clear the fog on the lens by impinging the dry air on the lens.

It is preferable to provide a door opening detector unit and turn OFF the mist generator unit while the door is opened. When the door is opened, warm humid air is introduced into the storage chamber and increases the humidity of the storage chamber interior when combined with the humidity attributable to the mist and may lead to development of dew condensate. It is thus, possible to prevent image capturing from being inhibited by dew condensate covering the lens, etc. of the camera by turning OFF the mist generator unit when the door is opened.

When moisturous storage items such as vegetables are stored, the mist may provide excessive moisture. Thus, the following control may be executed when employing a configuration in which image capturing is performed when a change in the storage amount has been detected by a storage amount detection unit such as a weight sensor provided on a shelf or a storage container for placing food for example. That is, the performance of the mist generator unit may be reduced or stopped when it has been detected that the storage amount has been increased. It is thus, possible to reduce the amount of mist being discharged from the mist discharging unit while maintaining moisture of the fridge interior. As a result, it is possible to prevent development of dew condensate on the lens, etc. of the camera.

### Fourth Embodiment

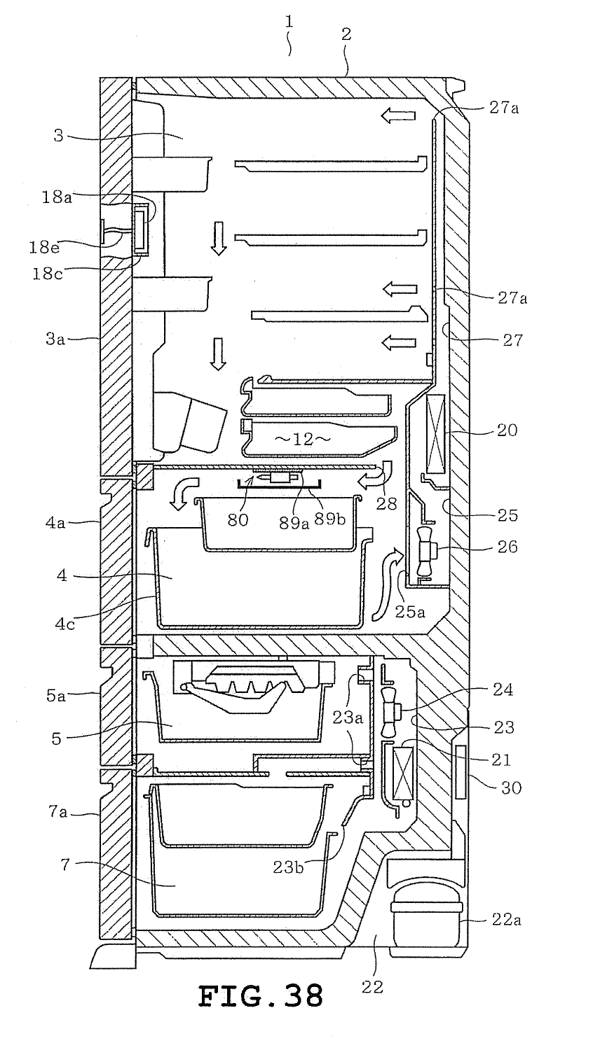

Next, a description will be given on a fourth embodiment with reference to FIG. 38. In the fourth embodiment, the mist generator device 80 is provided at the ceiling portion of the vegetable chamber 4. The mist generator device 80 is provided in the midway of the path of airflow indicated by the white arrow. The mist generator device 80 is provided above a high-voltage generator substrate 89a. The high-voltage generator substrate 89a is provided with a circuit configured to generate high voltage for charging the mist to high voltages. The mist generator device 80 and the high-voltage generator substrate 89a are covered by a cover 89b. The airflow upstream side and the airflow downstream side of the cover 89b are opened. Some of the air flowing through the airflow path indicated by the white arrow pass through the inner side of the cover 89b. The mist generated by the mist generator device 80 is fed into the vegetable chamber 4 by being carried by the airflow passing through the inner side of the cover 89b.

The image capturing camera 18a serving as the image capturing unit is provided in a location inside the refrigeration chamber 3 that is displaced from the airflow path indicated by the white arrow. Further, the image capturing camera 18a serving as the image capturing unit is neither provided on the airflow path indicated by the white arrow inside the vegetable chamber 4 nor on the high-voltage generator substrate 89a inside the vegetable chamber 4. The image capturing camera 18a is provided airflow upstream of the mist generator device 80.

Thus, the image capturing camera 18a serving as the image capturing unit is neither provided on the airflow path in which the mist charged to high voltage is fed nor on the high-voltage generator substrate 89a. Thus, it is possible to dispose the image capturing camera 18 at a location distanced from a location where highly concentrated mist is generated. As a result, it is possible to prevent image capturing failures due to fog and haze originating from development of dew condensate on the surface of the cover, etc. while further preventing the image capturing camera 18a from being charged by mist or the high-voltage generator substrate 89a. Further, because the image capturing camera 18a is provided on the airflow upstream of the mist generator device 80, it is possible to prevent the mist discharged from the mist generator device 80 from being carried onto the image capturing camera 18a by the airflow.

### Fifth Embodiment

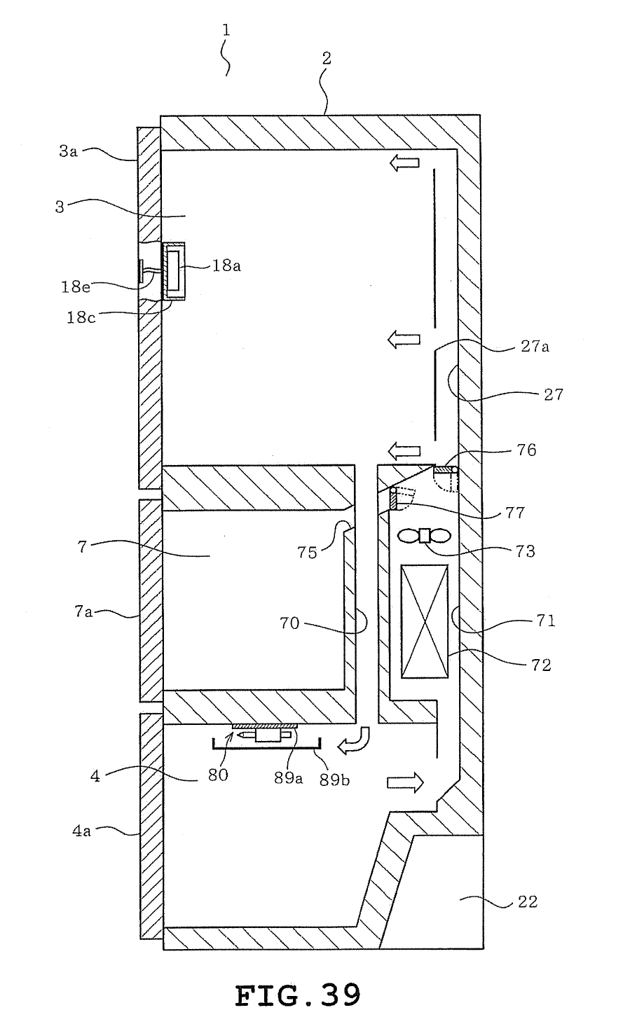

Next, a description will be given on a fifth embodiment with reference to FIG. 39.

In each of the foregoing embodiments, the refrigerator 1 is configured to cool the storage chambers in the refrigeration temperature zone and the storage chambers in the freezing temperature zone by two coolers, namely the cooler 20 and the cooler 21. In contrast, the refrigerator 1 of the fifth embodiment is configured to cool the storage chambers in the refrigeration temperature zone and the storage chambers in the freezing temperature zone by a single cooler.

In the refrigerator 1 of the fifth embodiment, the refrigeration chamber 3, being a storage chamber belonging to the refrigerating temperature zone, is provided in the uppermost portion of the body 2. The vegetable chamber 4, being a storage chamber belonging to the refrigerating temperature zone, is provided in the lowermost portion of the body 2. The freezer chamber 7, being a storage chamber belonging to the freezing temperature zone, is provided between the refrigeration chamber 3 and the vegetable chamber 4. The refrigeration chamber 3 and the vegetable chamber 4 are connected by the connection duct 70. The connection duct 70 is provided in the rearward portion of the refrigeration chamber 3 and the vegetable chamber 4 so as to bypass the freezer chamber 7. The cool air inside the refrigeration chamber 3 is fed into the vegetable chamber 4 through the connection duct 70.

The cooler chamber 71 is provided behind the freezer chamber 7. A cooler 72 and a blower fan 73 are provided in the cooler chamber 71. The cooler chamber 71 is connected to the interior of the refrigeration chamber 3 through the cool-air feed duct 27 and to the freezer chamber 7 through a freezing cool-air duct 75. A refrigerating damper 76 and a freezing damper 77 are provided in the cooler chamber 71.

The refrigerating damper 76 is provided at the connecting portion of the cooler chamber 71 and the cool-air feed duct 27 and is configured to open and close the connecting portion. The freezing damper 77 is provided at the connecting portion of the cooler chamber 71 and the freezing cool-air duct 75. The dampers 76 and 77 are both connected to the main-control portion 30. The main-control portion 30 is configured to control the destination and the amount of the cool air produced by the cooler 72 by opening and closing the dampers 76 and 77. It is thus, possible to cool the refrigeration chamber 3, the freezer chamber 7, and the vegetable chamber 4 to appropriate temperatures.

The refrigerator 1 is further provided with the image capturing camera 18a of the refrigeration chamber side and the mist generator device 80. As was the case in the third embodiment, the image capturing camera 18a of the refrigeration chamber side is provided on a door 3a of the refrigeration chamber 3 and is configured to capture an image of the interior of the refrigeration chamber 3. The mist generator device 80 is provided on the ceiling portion of the vegetable chamber 4.

Accordingly, the cool air produced by the cooler 72 is fed to the refrigeration chamber 3 through the cool-air duct 27 and to the freezer chamber 7 through the refrigerating cool air duct 75 by the blower fan 73 configured to feed air. The cool air fed to the refrigeration chamber 3 is fed to the vegetable chamber 4 through the connection duct 70. The mist discharged by the mist generator device 80 is sucked into the cooler chamber 71 after being circulated through the interior of the vegetable chamber 4. The mist is thereafter fed to the refrigeration chamber 3 through the cool-air feed duct 27.

The main-control portion 30 stops the drive of the blower fan 73 when capturing an image of the interior of the vegetable chamber 4 by the image capturing camera 18a. The feeding of mist into the refrigeration chamber 3 is thus, stopped when image capturing is executed by the image capturing camera 18a. It is thus, possible to prevent the image capturing camera 18a from being charged by the charged mist when image capturing is executed by the image capturing camera 18a.

The mist generator unit is disposed in the storage chamber (vegetable chamber 4) different from the storage chamber (refrigeration chamber 3) in which the camera device is provided. Mist is fed to the storage chamber in which the camera is installed through a duct which bypasses another storage chamber (freezer chamber 7). It is thus, possible to distance the camera from the mist generating unit and prevent the mist from directly contacting the camera even more effectively. The foggy mist is reduced in concentration as it travels over long distance, thereby allowing the entirety of the storage chamber in which the camera device is installed to be captured clearly. The particle diameter of the mist becomes smaller or becomes dissipated as the mist travels over long distance.

Thus, the mist turns into the so-called water vapor by the time it is fed to the storage chamber provided with the camera and hence, is not visible. It is thus, possible to overcome the poor visibility caused by foggy mist and thereby allowing capturing of clear images.

The mist need not be passed through the cooler chamber 71 when being fed to the refrigeration chamber 3. A dedicated duct may be provided which communicates the vegetable chamber 4 with the refrigeration chamber and the mist may fed through the dedicated duct.

Further, a damper may be provided in a duct extending from the vegetable chamber to other storage chambers which is configured to open and close the duct to enable control of mist transfer. Failure in capturing clear image with the camera by poor visibility caused by the foggy mist may also be resolved by reducing the size of particle diameters of the mist.

For example, the mist can be reduced to charged fine particles being on the order of nanometers in size by controlling the voltage level of the electrostatic atomizer device. As a result, the mist becomes invisible and provides good view since a haze of foggy mist no longer exists. It is thus, possible to capture clear images since the camera is now capable of capturing an image of the entirety of the storage chamber.

For example, a charged fine particle generator unit may be configured by an electrostatic atomizer device having a discharge electrode made of a metal material and terminating into a sharp needle-like tip. A voltage of approximately −6 kV may be applied between the discharge electrode and the counter electrode and the metal material used in the discharge electrode is cooled to obtain a dew condensate of moisture contained in the air. Charged fine particle water having particle diameters sized on the order of nanometers can be obtained by electrostatically atomizing the dew condensate.

The distribution of particle diameter preferably ranges approximately from 3 to 50 nm preferably peaking at approximately 20 nm. Other examples of the charged fine particle generator unit for generating charged fine particles sized on the order of nanometers may include: an ion generator device configured to generate charged fine particle water of H+(H20)m being a positive ion and O2-(H2O)n being a negative ion (m, n are positive integers) in the ambient for example; a corona discharge device configured to produce clusters of charged fine particle water

by emitting bluish white light through air dielectric breakdown and reacting with moisture in the atmosphere. The above described types of devices generate smaller mist compared to an ultrasonic mist generator device. It thus, preferable to use one of the above described devices alone and not in combination with the ultrasonic device as was the case in the third embodiment.

Invisible mist (that is, mist which is sized (in particle diameter) so as not to be visible in the image captured by the camera device) can be generated by increasing the distribution of charged fine particle water sized in nanometers compared to charged fine particle water sized in micrometers. The charged fine particle water is preferably controlled to be sized in nanometers and more preferably to be less than 400 nm which is the wavelength of blue light. When the mist is reduced to charged fine particle water sized in nanometers, it is possible to dispose the camera device near the charged fine particle water generator device (including for example providing on the same wall (including the door)) since the lens is not easily fogged.

Fogging of the lens and cover, etc. may also be resolved by applying a coating of visible-light-induced photocatalyst on the surface of a transparent coating cover covering the camera device or on the surface of a cover member covering the lens of the camera device or the main portion of a housing in which the camera is installed, etc. The visible-light-induced photocatalyst may be excited by in-fridge lighting, etc. for achieving deodorization and sterilization and thereby prevent accumulation of contaminants on the surfaces of the lens and the cover. A first light emitting unit such as a blue LED which is non-white may be used as the light irradiated on the visible-light-induced photocatalyst.

The visible-light-induced photocatalyst device configured by the visible-light-induced photocatalyst and the first light emitting unit may serve as a hydrophilicizer.

The lens of the camera or the cover may become fogged by dew condensate when exposed to the storage chamber and cause the captured image to be blurred. By irradiating the photocatalyst by the first light emitting unit the surface of the lens, cover, etc. are activated by moisture in the air and hydrophilicized by OH radical serving a hydrophilicizer (also serving as a contamination remover). As a result, dew condensate produced on the surfaces of the lens and the cover become susceptible to bond into a thin film of water. This makes it difficult for water droplets, producing undulations, to form and thereby allow diffused reflection of light to be inhibited and render the surfaces of the lens, cover, etc. difficult to fog. It is thus, possible to capture fogless clear images with the camera by producing a hydrophilicizer on or exposing the hydrophilicizer to the lens or the transparent cover located in the direction of image capturing of the camera device. Silver oxide and titanium oxide may be used as a photocatalyst. The blue region of a visible light having a wavelength of approximately 400 nm to 580 nm are used when employing silver oxide (including silver zirconium phosphate). A light emitting diode capable of irradiating light having a wavelength of 380 nm may be used as a light source when employing titanium oxide. The OH radical exhibits advantages of removing or facilitating the removal of contaminants. Thus, the visible-light-induced photocatalyst device also serves as a contamination remover device.

Active species such as OH radical may be employed in the charged fine particle water generator unit so that the active species are arranged to contact the lens and the cover of the camera. Some types of mist may, though not directly, contact the lens, etc. By causing the charged fine particle water containing active species to contact the lens, advantages similar to those of the hydrophilicizer of the visible-light-induced photocatalyst device may be achieved in which case clear images can be expected to be captured.

The mist generator unit may be configured to generate mist having different particle diameters by applying different voltage levels or by being used in combination with other mist generator units. As a result, it is possible to selectively use mist for providing moisture and mist for removing contamination of the lens. When using the mist for removing contamination comprising charged fine particle water sized in nanometers and containing contamination remover (OH radical), the fan, etc. located above the duct as described in the third embodiment may be turned ON to facilitate contact between the mist and the camera. Such manner of control may be referred to as a contamination removing mode.

A charged fine particle water generator unit may be used which generates the charged fine particle water and ozone at the same time or in an alternate fashion. Ozone is highly capable of decomposing contaminants and thus, removes contaminants from the lens, etc. more effectively. Ozone may be generated by causing air dielectric breakdown through corona discharge and thus, may be generated, though in small amounts, by an electrostatic atomizer provided with a counter electrode. Bluish white light may sometimes be emitted from the tip of the discharge electrode when generating ozone.

Blue light (having a wavelength of 400 nm to 500 nm) which is one example of the first light emitting unit may be irradiated on the charged fine particle water containing active species generated by the charged fine particle water generator unit. This is expected to extend the life of the active species. The first light emitting unit is preferably disposed in a location to provide irradiation between the camera device and the mist outlet since such location facilitates the contact between the active species and the lens, etc. The charged fine particle water generator unit also serves as a hydrophilicizer.

The following control may be executed when employing a configuration in which image capturing is performed when a change in the storage amount has been detected by a storage amount detection unit such as a weight sensor provided on a shelf or a storage container for placing food for example. When detecting that the storage amount has been reduced or when the user has operated the go-out switch, the count of rotation of the fan may be reduced to operate in a power save mode. It is further preferable to increase the amount of charged fine particle water generated by the charged fine particle water generator unit to generate greater amount of contamination remover. This is because contaminants such as microbes may grow when operating under the power save mode which may facilitate contamination of the lens, etc. It will be possible to remove the contaminants more effectively by increasing the amount of contamination remover.

Further, when the fan is turned ON after the closing of the door has been detected by the door opening detection unit, it is preferable to: turn ON the first light emitting unit and turn ON the charged fine particle water generator unit to drive the contamination remover device; and turn ON the image capturing by the camera after the contaminant remover has been generated. Storage items are frequently taken in and out of the storage chamber when the door is opened/closed and thus, contamination may occur when the storage items are placed in contact with the lens, etc. of the camera. However, by discharging the contamination remover every time the door is opened/closed, it is possible to facilitate contamination removal and further facilitate manual cleaning of the lens, etc. by the user.

### Sixth Embodiment

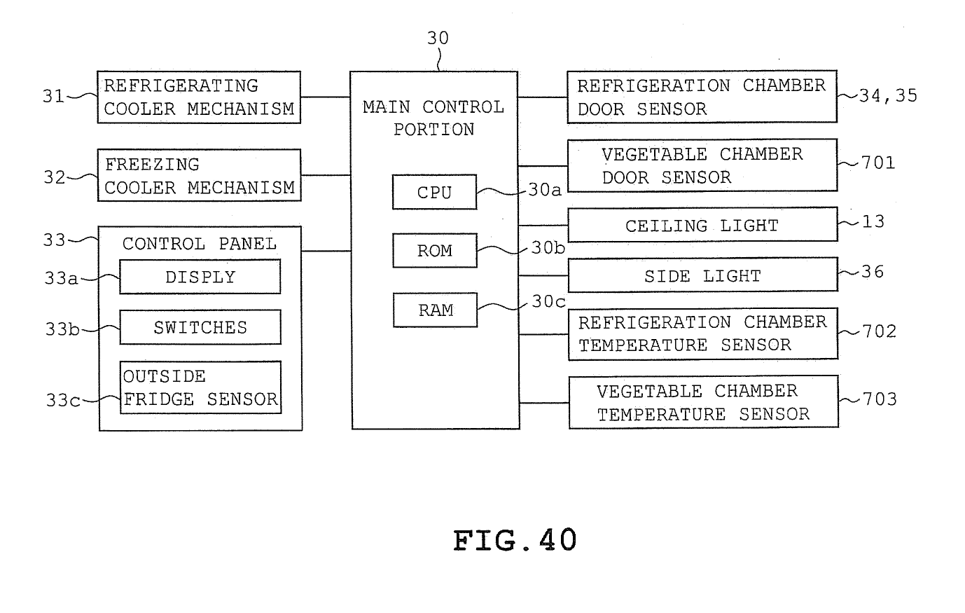

Next, a description will be given on a sixth embodiment with reference to FIGS. 40 to 42.

When the refrigerator 1 is provided with both the image capturing unit (image capturing cameras 18a and 18b) capturing an image of the fridge interior and a mist generating unit (mist generator device 80 and humidifier device 90) for feeding mist into the chamber interior, the mist generated by the mist generator units 80 and 90 may interfere with image capturing executed by the image capturing cameras 18a and 18b. That is, the image capturing executed by the image capturing cameras 18a and 18b is preferably carried out when there is change in the status of use, that is, change in the storage items stored in the fridge interior. The mist fed by the mist generator device 80 and the humidifier device 90 is preferably increased/decreased depending upon the amount of storage items stored in the refrigerator. However, when image capturing is executed by image capturing cameras 18a and 18b while mist is being fed by the mist generator device 80 and the humidifier device 90, the mist may develop into a haze for example and prevent capturing of clear images.

Thus, in the sixth embodiment, the refrigerator 1 of the third embodiment illustrated in FIG. 30 is provided with a usage level detection unit configured to detect the status of use of fridge interior. The main-control portion 30 serving as the control unit is configured to execute generation of mist using the mist generator device 80 and humidifier device 90 serving as the mist generator unit and image capturing using image capturing cameras 18a and 18b serving as the image capturing unit based on the result of detection of the usage level detection unit. The main-control portion 30 executes appropriate control of the mist generator device 80 and humidifier device 90 serving as the mist generator unit and the image capturing cameras 18a and 18b serving as the image capturing unit based on the result of detection of the usage level detection unit to feed the mist in an appropriate manner and to enable capturing of clear images.

The status of use of the fridge interior indicates for example the storage status of storage items inside the targeted storage chambers such as the refrigeration chamber 3 and the vegetable chamber 4. It is possible to estimate the status of use of the fridge interior by for example the status of opening and closing of the door. Taking the example of detecting the refrigeration chamber 3, it can be expected that a storage item has been taken in or out of the refrigeration chamber 3 as the result of opening and closing of doors 3a, 3b of the refrigeration chamber 3.

Further, the status of use of fridge interior can also be estimated by the amount of energy required in cooling the targeted storage chamber to the specified temperature and maintaining such temperature, that is, the workload of the compressor 22a of the refrigeration cycle which may be further rephrased as the change in the load for cooling the targeted storage chamber. For example, the load for cooling the refrigeration chamber 3 will decrease when a storage item is taken out of the refrigeration chamber 3 and the amount of storage items in the refrigeration chamber is reduced. Thus, it is presumed that the amount of storage items in the refrigeration chamber 3 is small and hence, the usage level is low when the load for cooling the refrigeration chamber 3 is low. In contrast, the load for cooling the refrigeration chamber 3 will increase when a storage item is taken into the refrigeration chamber 3 and the amount of storage items in the refrigeration chamber is increased. Thus, it is presumed that the amount of storage items in the refrigeration chamber 3 is large and hence, the usage level is high when the load for cooling the refrigeration chamber 3 is high.

Examples of usage level detecting unit may include: the left-side door sensor 34 and the right-side door sensor 35 (hereinafter referred to as refrigeration chamber door sensors 34 and 35); a vegetable chamber door sensor 701; or a refrigeration chamber temperature sensor 702 and vegetable chamber temperature sensor 703 as illustrated in FIG. 40. The refrigeration chamber door sensor 34 and 35 detects the opened/closed status of the left-side door 3a and the right-side door 3b of the refrigeration chamber 3 belonging to the compartment provided with spray ports 29a and 29b. The vegetable chamber door sensor 701 detects the opened/closed status of the door 4a of the vegetable chamber 4 belonging to the compartment provided with spray port 29c.

The refrigeration chamber temperature sensor 702 detects the temperature of the interior of the refrigeration chamber 3 belonging to the compartment provided with the spray ports 29a and 29b. The vegetable chamber temperature sensor 703 detects the temperature of the interior of the vegetable chamber 4 belonging to the compartment provided with the spray port 29c.

The refrigeration chamber door sensors 34 and 35, the vegetable chamber door sensor 701, the refrigeration chamber temperature sensor 702, and the vegetable chamber temperature sensor 703 are each connected to the main-control portion 30 as illustrated in FIG. 40. The result of detection of the refrigeration chamber door sensors 34 and 35, the vegetable chamber door sensor 701, the refrigeration chamber temperature sensor 702, and the vegetable chamber temperature sensor 703 are each transmitted to the main-control portion 30.

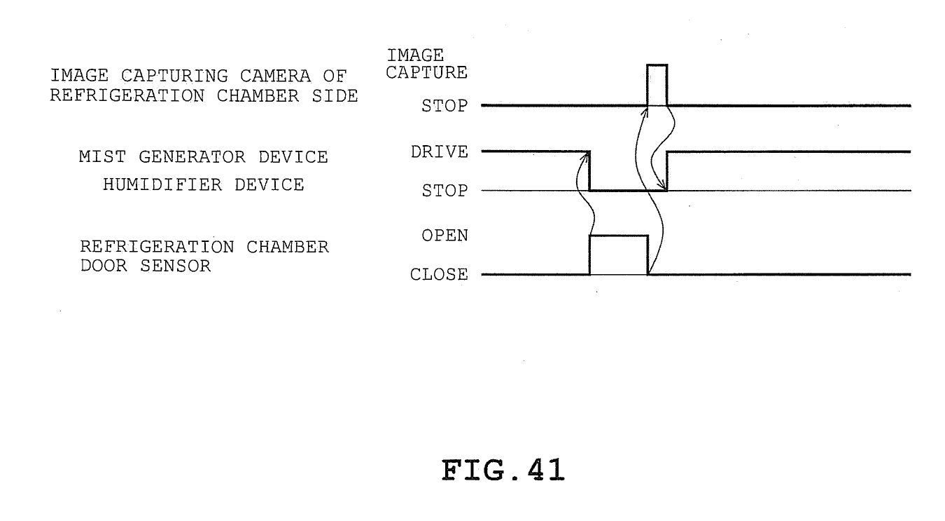

A description will be given with reference to FIG. 41 based on an example in which the refrigeration chamber door sensors 34 and 35 are used as the usage level detection unit of the refrigeration chamber 3. The main-control portion 30 makes a judgment that the usage status of the refrigeration chamber 3 has changed when detecting that the left-side door 3a and the right-side door 3b of the refrigeration chamber 3 has been opened based on the output of the refrigeration chamber door sensor 34 and 35. Then, the main-control portion 30 stops the drive of the mist generator device 80 and humidifier device 90 serving as the mist generating unit. As a result, generation of mist by the mist generator device 80 and humidifier device 90 is stopped to consequently stop the feeding of the mist to the refrigeration chamber 3. The main-control portion 30 need not necessarily stop the mist generator device 80 and humidifier device 90 completely. The main-control portion 30 may for example drive the mist generating device 80 and the humidifier device 90 intermittently to reduce the amount of generated mist to be less than the amount generated during normal operation.

Then, the main-control portion 30 captures an image of the interior of the refrigeration chamber 3 by the image capturing camera 18a of the refrigeration chamber side when detecting that the left-side door 3a and the right-side door 3b of the refrigeration chamber 3 have been closed based on the output of the refrigeration chamber door sensors 34 and 35. The main-control portion 30 thereafter restarts the drive of the mist generating device 80 and the humidifier device 90 to consequently restart the feeding of mist into the interior of the refrigeration chamber 3.

As a result, when it is presumed that the usage status of the refrigeration chamber 3 interior has changed by opening/closing of the doors 3a and 3b, the main-control portion 30 captures an image of the interior of the refrigeration chamber 3 by the image capturing camera 18a. Thus, the user who has viewed the image capturing result will be able to reliably grasp the storage items preserved inside the refrigeration chamber 3. Further, the main-control portion 30 stops the drive of the mist generating device 80 and the humidifier device 90 to stop the feeding of mist into the refrigeration chamber 3 when capturing images with the image capturing camera 18a. Thus, the mist fed from the mist generating device 80 and the humidifier device 90 will not interfere with image capturing. As a result, it is possible to capture clear images.

### Seventh Embodiment

Next, a description will be given on a seventh embodiment with reference to FIGS. 40 to 42.

The seventh embodiment is discussed taking the refrigeration chamber 3 as an example as was the case in the sixth embodiment and the refrigeration chamber temperature sensor 702 is used as the usage level detection unit. When detecting that storage items are not stored in the refrigeration chamber 3 by the refrigeration chamber temperature sensor 702 serving as the usage level detection unit, the main-control portion 30 stops or reduces generation of mist by the mist generator device 80 and the humidifier device 90 and executes image capturing by the image capturing camera 18a and 18b. On the other hand, when detecting that storage items are stored in the refrigeration chamber 3 by the refrigeration chamber temperature sensor 702, the main-control portion 30 generates mist using the mist generator device 80 and the humidifier device 90 in the normal amount and does not execute image capturing by the image capturing camera 18a and 18b.

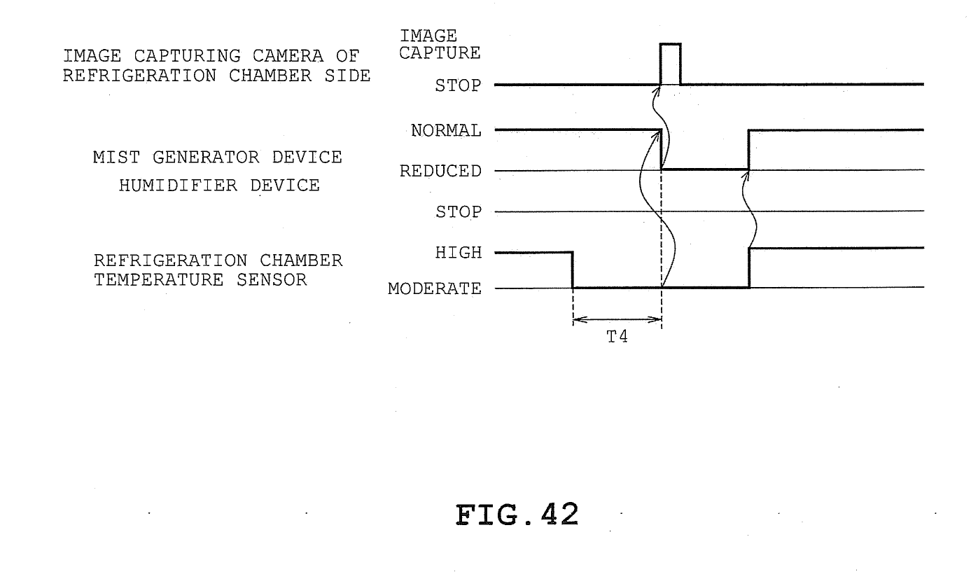

For example, when the temperature in the refrigeration chamber 3 is elevated by the storing of storage items in the refrigeration chamber 3, the refrigeration chamber temperature sensor 702 detects the temperature to be high as indicated by the “high” for “temperature sensor” field in FIG. 42. As a result, the main-control portion 30 executes a cooling operation to cool the interior of the refrigeration chamber 3. Then, when the refrigeration chamber 3 is cooled to the specified temperature, the refrigeration chamber temperature sensor 702 detects that the specified temperature has been reached as indicated by “moderate” temperature for “temperature sensor” field in FIG. 42.

Then, when a predetermined period T4 has elapsed with the measurement of the refrigeration chamber temperature sensor 702 maintaining the “moderate” temperature, the main-control portion 30 makes a judgment that storage items are not stored in the refrigeration chamber 3 during the predetermined period T4 and reduces the amount of mist generated by the mist generator device 80 and the humidifier device 90 compared to the amount generated during normal operation. The main-control portion 30 need not necessarily reduce the amount of mist generated by the mist generator device 80 and the humidifier device 90. For example, the drive of the mist generator device 80 and the humidifier device 90 may be stopped instead. In such case, the main-control portion 30 is configured to capture an image of the interior of the refrigeration chamber 3 by the image capturing camera 18a in the refrigeration chamber side. Then, the main-control portion 30 restarts the drive of the mist generator device 80 and the humidifier device 90 and restarts feeding of mist into the refrigeration chamber 3.

When the refrigeration chamber temperature sensor 702 does not maintain the “moderate” temperature status during the predetermined period T4, the main-control portion 30 makes a judgment that storage items have been stored in the refrigeration chamber 3 during the predetermined period T4 and drives the mist generator device 80 and the humidifier device 90 to generate normal amount mist. In such case, the main-control portion 30 is configured not to capture an image of the interior of the refrigeration chamber 3 by the image capturing camera 18a in the refrigeration chamber side.

As described above, the main-control portion 30 is configured to stops the drive of the mist generator device 80 and the humidifier device 90 when executing image capturing by the image capturing camera 18a in the refrigeration chamber side to stop feeding of mist into the interior of refrigeration chamber 3. As a result, it is possible to capture clear images since the mist fed by the mist generator device 80 and the humidifier device 90 does not interfere with image capturing.

### Eighth Embodiment

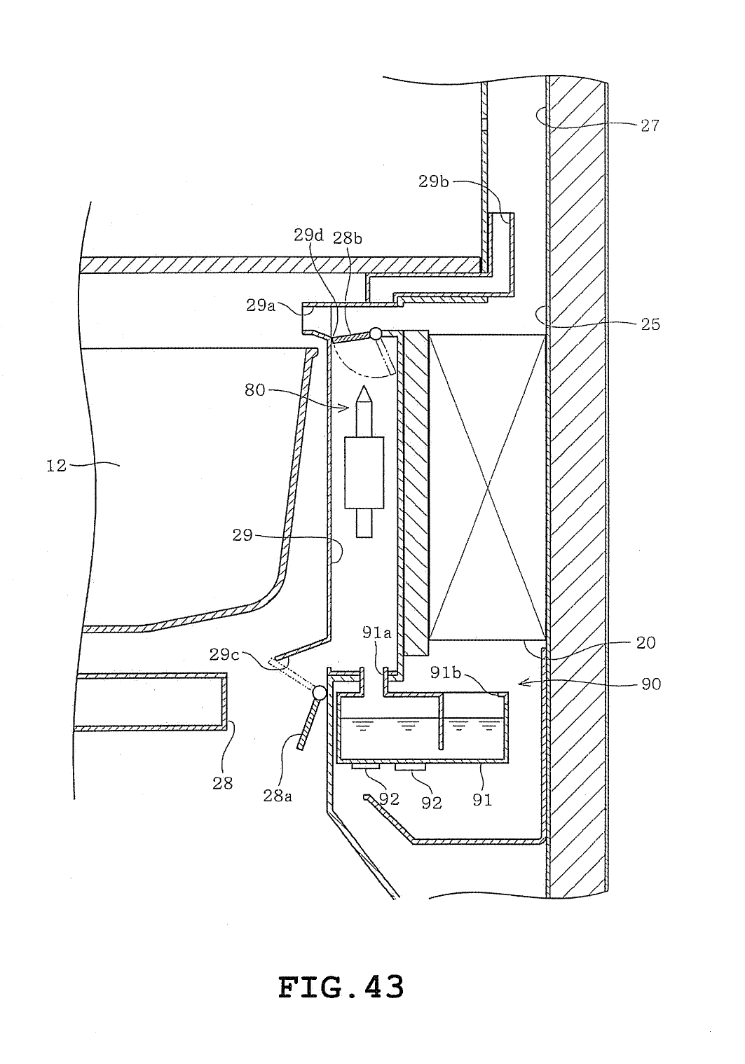

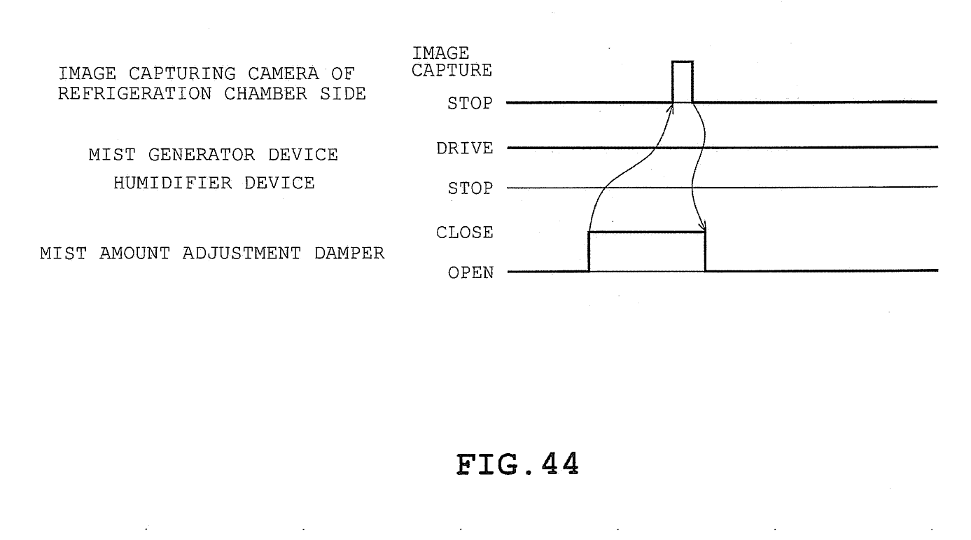

Next, a description will be given on an eighth embodiment with reference to FIGS. 43 and 44.

In the eighth embodiment, the refrigerator 1 is further provided with a mist amount adjustment unit to the refrigerator 1 of the third embodiment illustrated in FIG. 30. The mist amount adjustment unit is configured to reduce the amount of mist generated by the mist generator unit (the mist generator device 80 and the humidifier device 90). The main-control portion 30 is configured to execute image capturing by the image capturing unit (image capturing cameras 18a and 18b) when the amount of mist is being reduced by activating the mist amount adjustment unit.

That is, in the eighth embodiment, the refrigerator 1 is provided with a mist amount adjustment damper 28b serving as the mist amount adjustment unit as illustrated in FIG. 43. The mist amount adjustment damper 28b is provided so as to be capable of opening and closing the communication port 29d of the humidifying duct 29. The mist amount adjustment damper 28b opens and closes the communication port 29d under the control of the main-control portion 30. The mist amount adjustment damper 28b is configured by providing multiplicity of fine through holes on a metal plate, etc. though not illustrated in detail.

The mist generator device 80 and the humidifier device 90 form the mist under different principles and thus the particle diameters of the generated mist also differs. For example, the mist generated by the ultrasonic humidifier device 90 configured to generate mist by ultrasonic oscillation has particle diameters on the order of micrometers and thus, is relatively large. In contrast, the mist generated by electrostatic atomizer device 80 configured to generate mist by electrostatic atomization caused by application of high voltages has particle diameters on the order of nanometers and thus, is relatively small. Thus, the diameter of the multiplicity of holes provided on the mist amount adjustment damper 28b is configured for example to be on the order of nanometers so as to be greater than the diameters of mist generated by the electrostatic atomizer device 80 and smaller than the particle diameters of mist generated by the ultrasonic humidifier device 90. As a result, when the communication port 29d is closed by the closing the mist amount adjustment damper 28b, the mist generated by the electrostatic atomizer device 80 will pass through the mist amount adjustment damper 28b but the mist generated by the ultrasonic humidifier device 90 will not pass through the mist amount adjustment damper 28b. It is thus, possible to adjust the amount of mist being fed to the refrigeration chamber 3 by opening/closing the mist amount adjustment damper 28b.

When the refrigeration chamber 3 is the target of image capturing for example, the main-control portion 30 executes capturing by the image capturing camera 18a when the communication port 29d is closed by activating the mist amount adjustment damper 28b as illustrated in FIG. 44. As a result, the amount of mist having large particle diameters fed into the refrigeration chamber 3 is reduced and thus, does not become an impediment for image capturing. It is thus, possible to capture clear images.

It is also possible to configure the mist amount adjustment damper 28b to be free of through holes and adjust the amount of mist passing through the mist amount adjustment damper 28b by controlling the amount in which the communication port 29d is opened.

### Ninth Embodiment

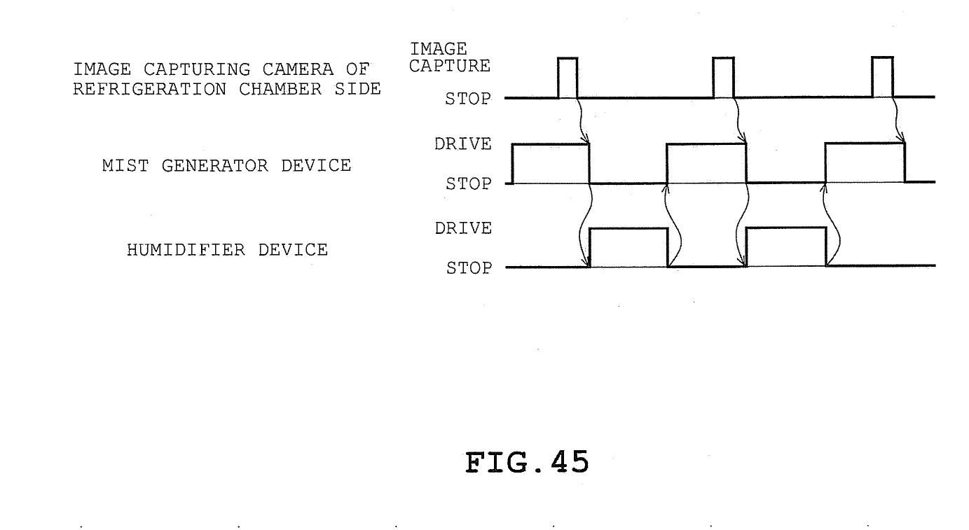

Next, a description will be given on a ninth embodiment with reference to FIG. 45.

The ninth embodiment differs from the third embodiment in how the mist generator device 80, the humidifier device 90, and the image capturing cameras 18a and 18b are controlled.

That is, in the ninth embodiment, the mist generator device 80 configured to generate mist by electrostatic atomization caused by application of high voltages serves as a first mist generator unit configured to generate mist charged to high voltages. The humidifier device 90 configured to generate mist by ultrasonic oscillation serves as a second mist generator unit configured to generate mist that is charged to voltages lower than the voltages of the mist generated by the mist generator device 80 or mist that is not charged at all. As described above the particle diameters of mist produced by the mist generator device 80 and the humidifier device 90 are different. That is, the particle diameters of the mist generated by mist generator device 80 is smaller than the particle diameters of mist generated by humidifier device 90.

The main-control portion 30 is configured to capture images using the image capturing cameras 18a and 18b when: the mist generator device 80 is activated, mist having small particle diameters charged to high voltages are generated, and the humidifier device 90 is not activated as illustrated in FIG. 45. Thus, the mist having large particle diameters fed from the humidifier device 90 is prevented from staying in the periphery of the image capturing cameras 18a and 18b when capturing images with the image capturing cameras 18a and 18b. It is thus, possible to reduce haze produced by mist having large particle diameters. As a result, it is possible to capture clear images as compared to the case in which mist is fed from both the mist generator device 80 and the humidifier device 90.

### Tenth Embodiment

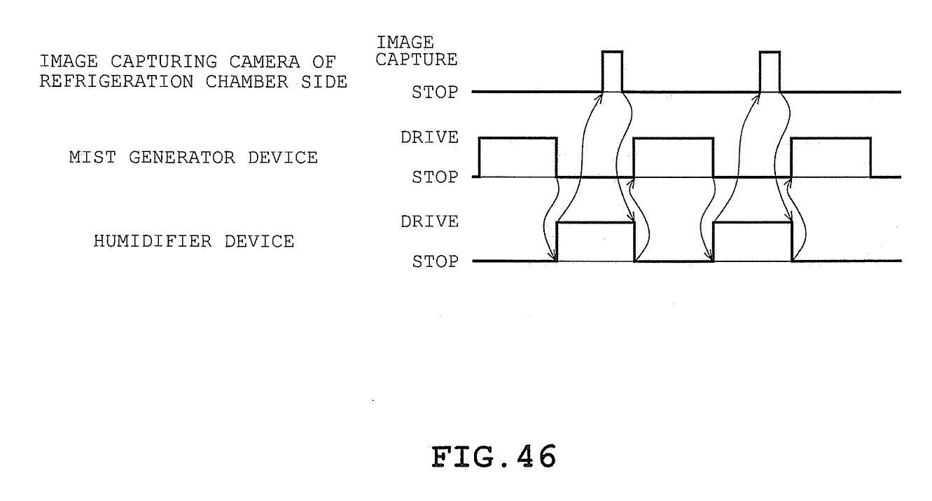

Next, a description will be given on a tenth embodiment with reference to FIG. 46.

The tenth embodiment differs from the ninth embodiment in how the mist generator device 80, the humidifier device 90, and the image capturing cameras 18a and 18b are controlled.

That is, in the tenth embodiment, the main-control portion 30 is configured to capture images using the image capturing cameras 18a and 18b when: the humidifier device 90 is activated, mist having large particle diameters charged to low voltages or not charged at all are generated, and the mist generator device 80 is not activated as illustrated in FIG. 46. Thus, the mist charged to high voltages fed from the mist generator device 80 is prevented from staying in the periphery of the image capturing cameras 18a and 18b when capturing images with the image capturing cameras 18a and 18b. It is thus, possible to reduce the influence of noise imparted by mist charged to high voltages on the image capturing cameras 18a and 18b. As a result, it is possible to capture clear images as compared to the case in which mist is fed from both the mist generator device 80 and the humidifier device 90.

### Eleventh Embodiment

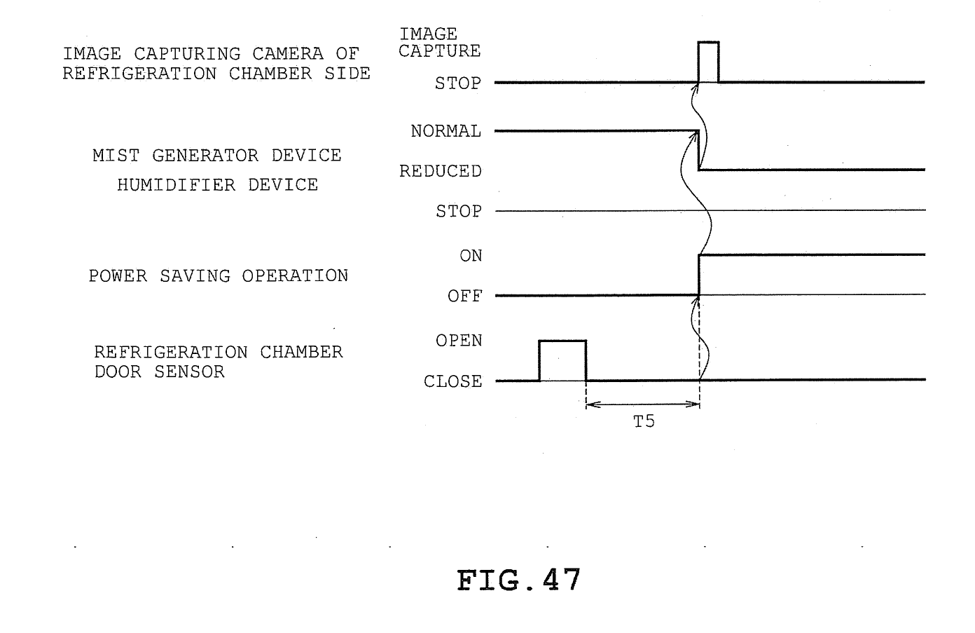

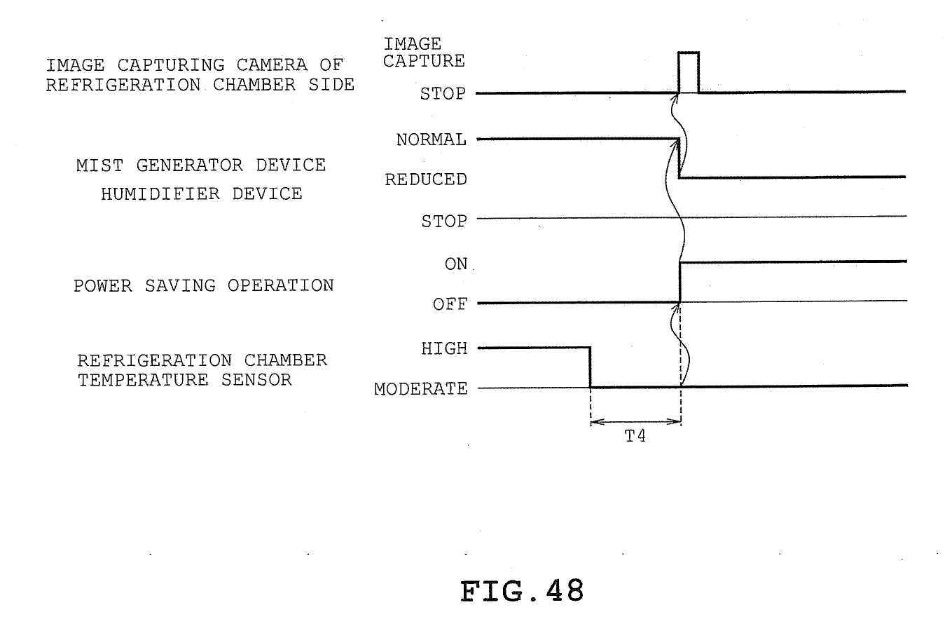

Next, a description will be given on an eleventh embodiment with reference to FIGS. 47 and 48.

The eleventh embodiment differs from the third embodiment in that, the refrigerator 1 is provided with a power save operation mode. The power save operation limits or stops the drive of electrical components consuming electric power, i.e. electrical load components based on the control executed by the main-control portion 30. Examples of electrical load components include the compressor 22a configuring the refrigeration cycle, the blower fans 24 and 26, the mist generator device 80, and the humidifier device 90. It is possible to reduce the overall power consumption, that is, save power of the refrigerator 1 compared to normal operation when running in the power save operation.

In the eleventh embodiment, the refrigerator 1 is provided with the refrigeration chamber door sensors 34 and 35, the vegetable chamber door sensor 701; the refrigeration chamber temperature sensor 702; and the vegetable chamber temperature sensor 703, etc. as the usage level detection unit configured to detect the status of use of the fridge interior as was the case in the sixth embodiment. The main-control portion 30 executes power save operation based on the detection results of the refrigeration chamber door sensors 34 and 35, the vegetable chamber door sensor 701; the refrigeration chamber temperature sensor 702; and the vegetable chamber temperature sensor 703, etc. During the power save operation, the main-control portion 30 stops the generation of mist or reduces the generation of mist by the mist generator device 80 and the humidifier device 90 and also executes image capturing by the image capturing cameras 18a and 18b.

The main-control portion 30 executes the following control when the refrigeration chamber door sensors 34 and 35 of the refrigeration chamber 3 are used as the usage level detection unit. After the refrigeration chamber door sensors 34 and 35 detect the opening/closing of the doors when a predetermined period T5 has elapsed without the opening/closing being re-detected by the refrigeration chamber door sensors 34 and 35, the main-control portion 30 makes a judgment that the usage level of the refrigeration chamber 3 is low. Then, the main-control portion 30 proceeds to execute the power save operation and reduces the amount of mist generated by the mist generator device 80 and the humidifier device 90. Alternatively, the mist generator device 80 and the humidifier device 90 may be stopped. The main-control portion 30 thereafter executes image capturing by the image capturing camera 18a while the power save operation is ongoing.

Further, the main-control portion 30 executes the following control for example when the refrigeration chamber temperature sensor 702 of the refrigeration chamber 3 serves as the usage level detection unit. For example, when the temperature in the refrigeration chamber 3 is elevated by the storing of storage items in the refrigeration chamber 3 and the refrigeration chamber temperature sensor 702 detects the temperature elevation, the main-control portion 30 executes the cooling operation to cool the interior of the refrigeration chamber 3. Then, when the refrigeration chamber 3 is cooled to the specified temperature, the refrigeration chamber temperature sensor 702 detects that the specified temperature has been reached as indicated by “moderate” temperature for “temperature sensor” field in FIG. 48.

Then, when a predetermined period T4 has elapsed with the measurement of the refrigeration chamber temperature sensor 702 maintaining the “moderate” temperature, the main-control portion 30 makes a judgment that storage items are not stored in the refrigeration chamber 3 during the predetermined period T4 and that the usage level of the refrigeration chamber 3 is low. Then, the main-control portion 30 proceeds to execute the power save operation and reduces the amount of mist generated by the mist generator device 80 and the humidifier device 90. Alternatively, the mist generator device 80 and the humidifier device 90 may be stopped in this case as well. The main-control portion 30 thereafter executes image capturing by the image capturing camera 18a while the power save operation is ongoing.

Accordingly, it is possible to capture of the interior of the refrigeration chamber 3 while the amount of mist fed from the mist generator device 80 and the humidifier device 90 is relatively small. Thus, the mist fed from the mist generating device 80 and the humidifier device 90 will not interfere with image capturing. As a result, it is possible to capture clear images.

### Twelfth Embodiment

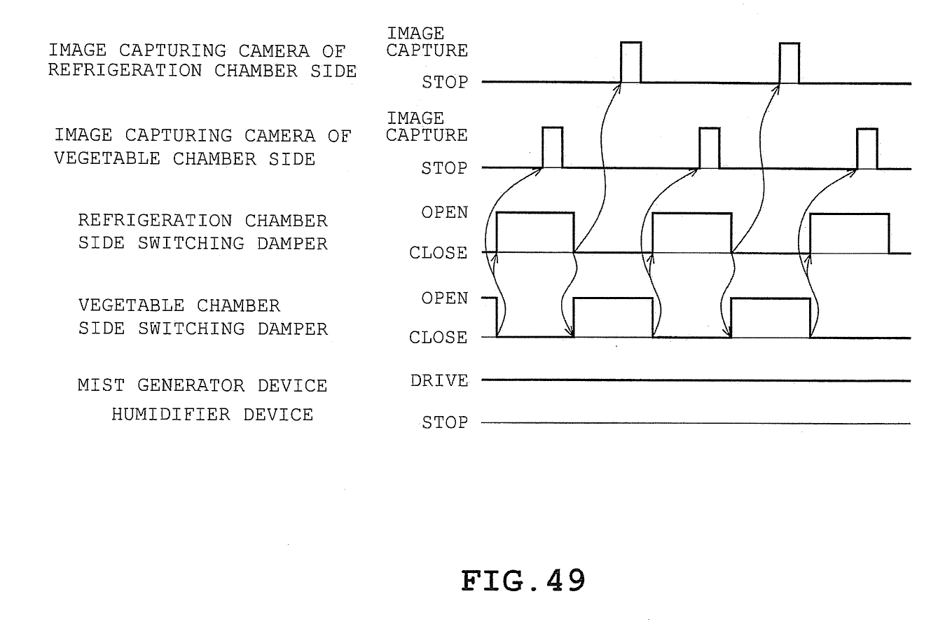

Next, a description will be given on a twelfth embodiment with reference to FIGS. 43 and 49.

The twelfth embodiment differs from the foregoing embodiments in how the mist generator device 80, the humidifier device 90, the image capturing cameras 18a and 18b and dampers 28a and 28b are controlled. In the present embodiment, the damper 28a is referred to as a vegetable chamber side switching damper 28a and the damper 28b is referred to as a refrigeration chamber side switching damper 28b. Dampers 28a and 28b without fine through holes are expected for use in this example. However, the dampers 28a and 28b may be provided with fine through holes as was the case in the mist amount adjustment damper 28b discussed in the eighth embodiment. The dampers 28a and 28b serve as a switching unit configured to switch the feeding of mist to the refrigeration chamber 3 and vegetable chamber 4 generated by the mist generator device 80 and the humidifier device 90.

In the twelfth embodiment, the main-control portion 30 drives the image capturing camera 18a in the refrigeration chamber side and the image capturing camera 18b in the vegetable chamber side, being provided in multiple separate compartments, in an asynchronous manner. In this example, being driven in an asynchronous manner means that image capturing is not executed at the same time for the image capturing camera 18a in the refrigeration chamber side and image capturing camera 18b in the vegetable chamber side. In contrast, being driven in a synchronous manner means that image capturing is executed at the same time for the image capturing camera 18a in the refrigeration chamber side and image capturing camera 18b in the vegetable chamber side.

The main-control portion 30 opens the switching damper 28b in the refrigeration chamber side and closes the switching damper 28a in the vegetable chamber side while image capturing is executed by the image capturing camera 18b in the vegetable chamber side as illustrated in FIG. 49. Thus, the main-control portion 30 does not feed mist to the vegetable chamber 4 belonging to the compartment in which the image capturing camera 18b of the vegetable chamber side is provided while image capturing is executed by the image capturing camera 18b of the vegetable chamber side. On the other hand, the main-control portion 30 opens the switching damper 28a in the vegetable chamber side and closes the switching damper 28b in the refrigeration chamber side while image capturing is executed by the image capturing camera 18a in the refrigeration chamber side. Thus, the main-control portion 30 does not feed mist to the refrigeration chamber 3 belonging to the compartment in which the image capturing camera 18a of the refrigeration chamber side is provided while image capturing is executed by the image capturing camera 18a of the refrigeration chamber side.

Accordingly, it is possible to execute image capturing while the amount of mist fed in to the storage chambers 3 and 4 by the mist generator device 80 and the humidifier device 90 is relatively small even when the image capturing cameras 18a and 18b are provided to multiple storage chambers, for example the refrigeration chamber 3 and the vegetable chamber 4, respectively. Thus, the mist fed from the mist generating device 80 and the humidifier device 90 will 18 interfere with image capturing. As a result, it is possible to capture clear images.

In some embodiments of the invention the compartments include at least a refrigeration chamber and a vegetable chamber, and the image capturing unit is provided on a door configured to open and close the refrigeration chamber and the spray port is provided at the vegetable chamber.

In some embodiments of the invention the image capturing unit is provided in an airflow upstream of the spray port.

In some embodiments of the invention the control unit is configured not to feed the mist from the spray port while image capturing by the image capturing unit is ongoing.

In some embodiments of the invention the control unit is configured control a damper to open and close the spray port, wherein the control unit closes the damper to stop feeding of mist to the interior of the refrigerator while image capturing by the image capturing unit is ongoing.

In some embodiments of the invention the image capturing unit is installed inside a storage container made of an electrically conductive material.

In some embodiments of the invention a water feeder unit is configured to feed water for generating the mist to the mist generator unit.

In some embodiments of the invention a communication unit is configured to transmit image information of the interior of the refrigerator captured by the image capturing unit to an external device.

In some embodiments of the invention a receiving portion is provided for mounting the image capturing unit, wherein the communication unit is configured to transmit image information of the interior of the refrigerator captured by the image capturing unit mounted on the receiving portion to an external device.

In some embodiments of the invention a control unit is configured to control a timing for capturing an image of the interior of the refrigerator by the image capturing unit.

In some embodiments of the invention the control unit is configured to capture an image of the interior of the refrigerator by the image capturing unit at a timing after a door has been closed.

In some embodiments of the invention a control portion is configured to capture an image of the interior of the refrigerator by the image capturing unit at a timing after a predetermined time period has elapsed after a door has been closed.

In some embodiments of the invention a removing unit is configured to remove dew condensate from a lens surface of the image capturing unit, wherein the control portion is configured to capture an image of the interior of the refrigerator by the image capturing unit at a timing after the dew condensate has been removed from the lens surface.

In some embodiments of the invention the communication unit is configured to be capable of receiving instructions for capturing an image of the interior of the refrigerator from an external device, and wherein the control unit is configured to capture an image of the interior of the refrigerator at a timing based on the instructions given from the external device.

In some embodiments of the invention the image capturing unit is a camera device detachably attachable to the refrigerator, wherein the communication unit is provided at the refrigerator and is configured by a refrigerator-side communication unit configured to receive instructions for capturing an image of the interior of the refrigerator from an external device, and a camera-side communication unit provided at the camera device and being configured to transmit image information to an external device, and wherein the camera device is configured to capture an image of the interior of the refrigerator when image capturing instructions have been notified from the refrigerator having received instructions for capturing an image of the interior of the refrigerator and transmit the captured image information to an external device from the camera-side communication unit.

In some embodiments of the invention the control unit is configured to capture an image of the interior of the refrigerator when a go-out switch for changing an operational status of the refrigerator to a power save mode is operated at a remote location.

In some embodiments of the invention the control unit is further configured to prepare an image capturing environment when capturing an image of the interior of the refrigerator by the image capturing unit.

In some embodiments of the invention the control unit is configured to prepare the image capturing environment by illuminating a lighting unit when capturing an image of the interior of the refrigerator by the image capturing unit.

In some embodiments of the invention the receiving portion is provided on a door and the image capturing unit is mounted on the door.

In some embodiments of the invention the image capturing unit is provided at a vertical partition provided on a door.

In some embodiments of the invention the image capturing unit is provided at an inner plate of a door.

In some embodiments of the invention the image capturing unit is provided adjacent to a door pocket provided at a door, the door pocket located adjacent to the image capturing unit being shaped so as to extend along an outer edge of a view of the image capturing unit configured to capture an image of the interior of the refrigerator or disposed outside the view of the image capturing unit.

In some embodiments of the invention a front surface of a door is made of nonmetallic material.

In some embodiments of the invention a camera-side lighting unit is configured to illuminate the interior of the refrigerator, the camera-side lighting unit being illuminated when capturing an image of the interior of the refrigerator by the image capturing unit.

In some embodiments of the invention a mounting portion is configured for attachment to a receiving portion provided at the refrigerator to mount the image capturing unit to the refrigerator.

In some embodiments of the invention the communication unit is configured to communicate with the communication unit provided at the refrigerator by wireless communication.

In some embodiments of the invention the usage level detection unit is configured to detect opening and closing of the a door associated with a compartment provided with the spray port, and wherein the control unit is configured to: stop or reduce generation of mist by the mist generator unit and execute image capturing by the image capturing unit when the opening and closing of the door has not been detected by the usage level detection unit for a predetermined period or more, and generate mist by the mist generator unit and execute image capturing by the image capturing unit when the opening and closing of the door has been detected by the usage level detection unit.

In some embodiments of the invention the control unit is configured to stop or reduce generation of mist by the mist generator unit and execute image capturing by the image capturing unit when detecting that storage items are not stored in the interior of the refrigerator by the usage level detection unit.

In some embodiments of the invention the control unit is configured to stop or reduce generation of mist by the mist generator unit and refrain from executing image capturing by the image capturing unit when detecting that storage items are stored in the interior of the refrigerator by the usage level detection unit.

In some embodiments of the invention a mist amount adjustment unit is configured to be capable of reducing amount of mist generated by the mist generator unit, wherein the control unit is configured to execute image capturing by the image capturing unit when the amount of mist has been reduced by activating the mist generator unit.

In some embodiments of the invention the mist generator unit includes a first mist generator unit configured to generate mist being charged to high voltages and a second mist generator unit configured to generate mist having a particle diameter different from a particle diameter of mist generated by the first mist generator unit and being charged to low voltages lower than mist generated by the first mist generator unit or not charged at all, and wherein the control unit is configured to execute image capturing by the image capturing unit when the first mist generator unit is activated and the second mist generator unit is not activated.

In some embodiments of the invention the mist generator unit includes a first mist generator unit configured to generate mist being charged to high voltages and a second mist generator unit configured to generate mist having a particle diameter different from a particle diameter of mist generated by the first mist generator unit and being charged to low voltages lower than mist generated by the first mist generator unit or not charged at all, and wherein the control unit is configured to execute image capturing by the image capturing unit when the second mist generator unit is activated and the first mist generator unit is not activated.

In some embodiments of the invention the control unit is configured to: execute a power save operation to limit or stop drive of an electrical load component when judging that usage level of the interior of the refrigerator is low based on the detection result of the usage level detection unit, and reduce amount of mist generated by the mist generating unit while the power save operation is ongoing.

In some embodiments of the invention the refrigerator is provided with multiple compartments, at least two of the image capturing units being disposed in different compartments, wherein the control unit is configured to asynchronously drive the image capturing units.

In some embodiments of the invention the spray port is provided in plural so as to feed mist to plural compartments in which the image capturing unit is disposed, the refrigerator further comprising a switching unit configured to switch feeding of mist generated by the mist generator unit to each of the plural compartments, wherein the switch unit is driven so that while image capturing is being executed by one of the plural image capturing units, mist is not fed to the compartment in which said one of the plural image capturing units is disposed.

In some embodiments of the invention the switch unit is a damper configured to open and close the spray port.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A refrigerator comprising:
an image capturing unit configured to capture an image of an interior of the refrigerator;
a mist generator unit configured to generate mist to be fed to the interior of the refrigerator;
a spray port configured to feed the mist generated by the mist generator unit to the interior of the refrigerator;
wherein the image capturing unit is provided at a location not confronting the spray port.

2. The refrigerator according to claim 1, wherein the interior of the refrigerator is divided into multiple compartments and the spray port and the image capturing unit are disposed in different compartments.

3. (canceled)

4. (canceled)

5. The refrigerator according to claim 1, further comprising a control unit configured to control the mist generator unit, wherein the control unit controls the image capturing unit to capture an image of the interior of the refrigerator when the mist is generated in reduced amount from the mist generator unit or when mist is not generated from the mist generator unit.

6. The refrigerator according to claim 1, further comprising a control unit configured to control the image capturing unit and the mist generator unit wherein the control unit operates the mist generator unit and the image capturing unit in synchronism.

7-10. (canceled)

11. The refrigerator according to claim 1, wherein the mist generator unit is provided with a high-voltage generator unit configured to charge the mist.

12. The refrigerator according to claim 11, wherein the high-voltage generator unit is provided on a substrate and the image capturing unit is not provided on the substrate.

13. The refrigerator according to claim 1, wherein an airflow path is defined in the interior of the refrigerator for allowing flow of cool air, wherein the image capturing unit is disposed so as to be displaced from the airflow path.

14. The refrigerator according to claim 1, wherein the mist is sized in nanometers.

15. The refrigerator according to claim 1, wherein a hydrophilicizer configured to inhibit fogging is applied to a lens provided at the image capturing unit or a cover covering the lens or the image capturing unit.

16-31. (canceled)

32. A camera device for capturing an image of an interior of the refrigerator comprising:
an image capturing unit configured to capture an image of the interior of the refrigerator;
a camera-side communication unit configured to communicate with an external device; and
a control unit configured to be capable of operating in synchronism with a mist generator unit being provided at the refrigerator and being configured to generate mist to be fed to the interior of the refrigerator.

33-35. (canceled)

36. A refrigerator door pocket provided at a door of a refrigerator comprising:
a receiving portion configured for mounting an image capturing unit configured to capture an image of an interior of the refrigerator, the receiving portion configured to receive the image capturing unit so that the image capturing unit is disposed in a location not confronting a spray port for feeding mist to the interior of the refrigeration chamber.

37. A refrigerator holder provided in an interior of the refrigerator comprising:
a holding portion configured to hold an image capturing unit configured to capture an image of an interior of the refrigerator, the holding portion configured to hold the image capturing unit so that the image capturing unit is disposed in a location not confronting spray port for feeding mist to the interior of the refrigeration chamber.

38. The refrigerator according to claim 5, further comprising a usage level detection unit configured to detect a level of use of the interior of the refrigerator, wherein the control portion is configured to execute generation of mist by the mist generator unit and execute image capturing by the image capturing unit based on a detection result of the usage level detection unit.

39-48. (canceled)
